(19) United States
(12) Patent Application Publication
(10) Pub. No.: US 2007/0071528 A1
(43) Pub. Date: Mar. 29, 2007

(54) Image recording apparatus

(75) Inventors: Takayuki Iida, Kanagawa (JP); Haruhiko Arai, Kanagawa (JP); Hiroshi Sakabe, Mie (JP)

Correspondence Address: BIRCH STEWART KOLASCH & BIRCH, PO BOX 747, FALLS CHURCH, VA, 22040-0747, US

(73) Assignee: FUJI PHOTO FILM CO., LTD., Minami-ashigara-shi (JP)

(21) Appl. No.: 11/485,371

(22) Filed: Jul. 13, 2006

(30) Foreign Application Priority Data
Jul. 15, 2005 (JP) 2005-206879
Sep. 2, 2005 (JP) 2005-254469
Sep. 5, 2005 (JP) 2005-256491

(51) Int. Cl. G03G 15/00

(52) U.S. Cl. 399/384

(57) ABSTRACT

The image recording apparatus includes an image allocating section allocating the plural images with respect to each recording medium, an image recording section recording the plural images on each recording medium, a cutting section cutting the one recording medium on which the plural images are recorded into the plural prints, a arranging section unifying the plural prints in a single line, a sort transporting section accumulating the plural prints, a discharge control section acquiring at least status information of the arranging section, and controls operations of the cutting section, the arranging section, and the sort transporting section, and an entire control section performing adjustment of allocating operations, or controls the operation of the arranging section, based upon at least one of an appointed delivery date of the plural prints and the status information.

### BACKGROUND OF THE INVENTION

The present invention relates to an image recording apparatus capable of producing a plurality of prints from one sheet of a recording medium on which a plurality of images have been recorded based upon a plurality of image data in accordance with a predetermined image forming sequence by means of an electrophotographic recording system, a silver halide photographic system, an ink jet recording system, a thermal recording system, or the like more specifically, the present invention relates to an image recording apparatus capable of producing prints in accordance with appointed delivery dates or priorities without deteriorating the productivity of the image recording apparatus.

In recent years, an image recording apparatus has been practically used whereby images recorded on photographic films are photoelectrically read, read images are converted into digital signals, and thereafter, the digital signals are subjected to various sorts of image processing to obtain printing image data, and photosensitive materials are scanned/exposed by optical beams modulated in accordance with the printing image data to record the images on the photosensitive materials, and then, those recorded images are developed and outputted as prints (i.e. photographs).

Such image recording apparatus essentially comprises an input machine and an output machine. The input machine comprises a scanner (i.e., image reading apparatus), an image processor, and a media drive (i.e., image data reading/writing apparatus). The output machine comprises a printer (i.e., image recording apparatus) and a processor (i.e., developing machine).

In the scanner, projection light of images photographed on a photographic film is photoelectrically read by an image sensor such as a CCD sensor, and the photoelectrically read images are transmitted as image data (image data signals) of the photographic film to the image processor. The image processor performs an image processing to the image data transmitted from the scanner or the media drive, and then, the processed image data is transmitted as image data (i.e., exposure condition) for recording images to the printer and/or the media drive.

In the media drive, image data is read out from various sorts of media (e.g., image data recording media) into which the image data have been written in various formats so as to transmit the read image data to the image processor, and the printing image data that has been subjected to a predetermined image processing in the image processor is written into the media drives. The media drives are connected to the image processor, and have functions as the input machine and the output machine.

In the printer, when it is of a type that uses optical beam scan/exposure, a predetermined length of sheet photosensitive material drawn and cut from a long length of rolled photosensitive material is transported to an exposing position. Subsequently, an optical beam modulated according to supplied image data is deflected in a main scanning direction, while the above-mentioned sheet photosensitive material is scanned/transported in a sub-scanning direction perpendicular to the main scanning direction, so that the photosensitive material is scanned/exposed by the optical beam so as to form an image on the photosensitive material as a latent image. In the processor, the exposed photosensitive material is subjected to development and the like so as to accomplish processed prints (hereinafter referred to also as “prints”) on which images recorded on a photographic film or images written in a media drive as image data are reproduced.

Using such a digital photograph printer, photosensitive materials must be scanned/exposed and then developed within a short period of time in order to output a large amount of prints efficiently. To this end, the efficiency of development whose processing speed is low compared with the image forming process by the scan/exposure in the printer must be increased, so that development is performed with the photosensitive materials transported in more than one line at a time. Thus, sorting apparatus for sorting and transporting the photosensitive materials in several lines are employed.

On the other hand, in the processor, the photosensitive materials transported in lines are developed and dried, lines of prints are arranged back into a single line, and then prints are accumulated on a tray by order, for example, for each roll of photographic film. Photograph processors equipped with sorters that accumulate prints on trays by order have been proposed (refer to JP 2000-75463 A (hereinafter referred to as “Patent Document 1”), etc.).

The Patent Document 1 describes a photograph processor capable of developing photosensitive materials with different widths in a continuous manner, This photograph processor is provided with a first transporting apparatus, a second transporting apparatus, and a guide plate. The first transporting apparatus transports a print dried and ejected by a dryer unit in a direction (hereinafter referred to as “perpendicular direction”) perpendicular to an ejection direction. The second transporting apparatus, which is provided in the vicinity of a transport-side edge portion of the first transporting apparatus stacks thereon the prints transported from the first transporting apparatus and transports the stacked prints in the ejection direction. The guide plate is provided opposite to the transport-side edge portion of the first transporting apparatus, and separated by the second transporting apparatus.

The second transporting apparatus is a belt conveyer on which prints are rearranged into a single line and accumulated by order. The belt transporting unit of the second transporting apparatus functions as a tray which receives prints transported in the perpendicular direction by the first transporting apparatus, and also transports the prints stacked on the tray in the ejection direction in an intermittent manner. The distance between the guide plate and the transport-side edge portion of the first transporting apparatus can be changed, depending upon the dimensions of prints.

Alternatively, in the photograph processor of the Patent Document 1, the first transporting apparatus may be adapted to be extendable in the transporting direction so that prints may be accumulated in two lines along a width direction of the belt transporting unit of the second transporting apparatus, Thus, in the case where a length of the belt transporting unit is restricted, a total number of accumulated prints per order is increased by also utilizing the width of the belt transporting unit.

### SUMMARY OF THE INVENTION

As previously explained, in the photograph processor of the Patent Document 1, both the first transporting apparatus and the guide plate are moved so that the prints can be accumulated over two lines. However, in cases where prints for an order with an earlier delivery date are mixed among prints for one normal order, it is necessary to change ejection positions of the prints in accordance with the appointed delivery dates. As a result, every time a print whose appointed delivery date or whose priority is different from that of a preceding print is ejected, both the first transporting apparatus and the guide plate are required to be moved, which makes control operations cumbersome and complicated. Accordingly, there is a problem that it is difficult to increase productivity of the photograph processor.

Also, there is another problem that when an operation failure occurs in either the first transporting apparatus or the guide plate, prints whose appointed delivery dates are different from those of the other prints cannot be separated from among the prints for the same order.

A first object of the present invention is to solve the problems with the above-mentioned conventional techniques, and therefore, is to provide an image recording apparatus capable of properly handling orders having different appointed delivery dates without lowering productivity, and further, capable of operating properly even when malfunction or the like occurs.

A second object of the present invention is to solve the problems with the above conventional techniques, and therefore, is to provide an image recording apparatus capable of properly handling orders whose priorities are different from each other, without lowering the productivity.

In order to achieve the above-mentioned first object, a first aspect of the present invention provides an image recording apparatus capable of producing prints from at least one sheet of recording medium having images recorded per one sheet thereof, including:

an image allocating section which allocates the images to be recorded on each sheet of the recording medium based upon image data in accordance with a predetermined image forming sequence;

an image recording section which records the images on the each sheet of the recording medium based upon the image data as to the images allocated by the image allocating section;

a cutting section which cuts the one sheet of the recording medium on which the images are recorded by the image recording section into prints each bearing their respective images to obtain prints;

an arranging section which arranges the obtained prints into a single line;

a sort transporting section which accumulates the prints in a single line or a plurality of lines;

a discharge control section which acquires at least state information of the arranging section, and controls operations of the cutting section, the arranging section, and the sort transporting section; and

an entire control section which performs adjustment of allocating operations of the images to the one sheet of the recording medium by the image allocating section, or controls the operation of the arranging section by the discharge control section, based upon at least one of an appointed delivery date of the prints formed based on the image data and the state information of the arranging section acquired by the discharge control section.

Preferably, in case that the images are allocated based upon the image data by the image allocating section, when a priority print which is to be formed with a high priority is contained in the image data, the entire control section performs at least one of the adjustment of allocating operations of the images based upon the image data by the image allocating section and an adjustment of the operation of the arranging section by the discharge control section, in such a way that the priority print and other prints are discharged to different lines by the sort transporting section.

Further, preferably, in case that the discharge control section acquires state information indicating that the shifter section is abnormal, the entire control section causes the image allocating section to allocate images based upon image data of images for one order, in such a way that prints for the one order are divided so as to be discharged to different lines by the sort transporting section, and the prints for the one order discharged to the different lines are arranged in a sequence of the image data of the images for the one order.

Further, preferably, the discharge control section further acquires accumulation information as to the number of accumulated orders in the sort transporting section and, in case that the number of an accumulable orders in the sort transporting section is small based upon the accumulation information, the entire control section causes the image allocating section to allocate the images based upon image data of images for the one order, in such a way that the prints for the one order are divided to be discharged to different lines by the sort transporting section, and the prints discharged to the different lines are arranged in a sequence of the image data of the images for the one order.

In order to achieve the above-mentioned second object, a second aspect of the present invention provides an image recording apparatus capable of producing prints from at least one sheet of recording medium having images recorded per one sheet thereof, including;

an image allocating section which allocates the images to be recorded on each sheet of the recording medium based upon image data in accordance with a predetermined image forming sequence;

an image recording section which records the images on each sheet of recording median based upon the image data as to the images allocated by the image allocating section;

a cutting section which cuts the one sheet of the recording medium on which the images are recorded by the image recording section into prints each bearing their respective images to obtain the plural prints;

a sort transporting section which has at least two accumulation areas and accumulates for each order the prints obtained by the cutting section;

an accumulation position selecting section which accumulates the prints in respective accumulation areas for each order;

a discharge control section which controls operations of the cutting section and the accumulation position selecting section; and

an entire control section which performs both adjustment of allocating operations of the images based upon the image data by the image allocating section and adjustment of the operation of the accumulation position selecting section by the discharge control section, in such a way that, when a priority order to be printed with a priority higher than the remainder of the orders is contained in the orders, a print forming sequence of the priority order is moved up and one or more prints of the priority order and other prints are discharged to the different accumulation areas.

Preferably, the entire control section includes a first mode in which, when the priority order is present, the image allocating section allocates one or more images of the priority order in such a way that one or more images of an order immediately before the priority order and the one or more images of the priority order are partially mixed with each other, and a second mode in which the image allocating section allocates all of the one or more images of the priority order in such a way that all of the one or more images of the priority order are inserted between the one or more images of the order immediately before the priority order, and the entire control section further includes a mode selecting section for selecting one of the first mode and the second mode.

In order to achieve the above-mentioned second object, a third aspect of the present invention provides the image recording apparatus of the second aspect of the present invention, wherein: the sort transporting section comprises a standby area where a print stack in which accumulation of the prints for the one order is not yet accomplished stands by, in addition to the at least two accumulation areas where the prints obtained by the cutting section are accumulated for each order, and further includes a moving unit which moves the print stack between the accumulation area and the standby area; and

when the priority order is contained in the orders, the entire control section causes the image allocating section to allocate the one or more images of the priority order in such a way that the print forming sequence of the priority order is moved up, and all of the one or more images of the priority order are inserted between images of an order immediately before the priority order, and adjusts the operation of the accumulation position selecting section by the discharge control section in such a way that the one or more prints of the priority order and one or more prints of other orders are discharged to the different accumulation areas.

In accordance with the first aspect of the present invention, the image allocation can be optimized in accordance with appointed delivery dates of prints, and based on the respective state information as to the cutting section, the shifter section, and the sort transporting section of the image recording apparatus. Thus, it is possible to easily obtain the prints whose appointed delivery date is earlier than those of other prints. In addition, since the image allocation can be optimized in accordance with the states of the respective devices, the image recording apparatus according to the first aspect of the present invention can properly operate even in cases where a device has a malfunction, and the prints must be produced by employing operable devices. As explained above, the image recording apparatus according to the first aspect of the invention can properly handle the orders whose appointed delivery dates are different from each other without lowering the productivity, and further can properly operate even when a failure or the like occurs.

Also, in accordance with the second aspect of the present invention, the image allocation and the operation of the accumulation position selecting unit can be optimized in accordance with the appointed delivery dates of the prints. Accordingly, the prints with a higher priority can be readily obtained. Thus, the image recording apparatus according to the second aspect of the present invention can properly handle the orders whose priority orders are different from each other without lowering the productivity.

Further, in accordance with the third aspect of the present invention, the image allocation and the operation of the accumulation position selecting unit can be optimized in accordance with the priorities of the prints. Accordingly, the prints with a higher priority can be readily obtained. Thus, the image recording apparatus according to the third aspect of the invention can properly handle orders with the different priorities without lowering the productivity.

### BRIEF DESCRIPTION OF THE DRAWINGS

FIG. 1 is a schematic diagram showing an image recording apparatus according to an embodiment of the present invention;

FIG. 2 is a schematic block diagram representing an embodiment of a control unit of the image recording apparatus shown in FIG. 1;

FIGS. 3A and 3B are schematic diagrams showing one example of a 4-image allocation and a 1-image allocation among image recording operations by an image recording section of the image recording apparatus shown in FIG. 1;

FIG. 4 is a side view for schematically indicating a structure according to an embodiment of a shifter section of the image recording apparatus shown in FIG. 1;

FIG. 5 is a plan view for schematically indicating the shifter section represented in FIG. 4;

FIG. 6 is a plan view for schematically showing a structure of an embodiment of a sort transporting section of the image recording apparatus shown in FIG. 1;

FIG. 7 is a plan view for schematically indicating the shifter section that shows one example of transporting steps of a print by the image recording apparatus shown in FIG. 1 in the step sequence;

FIG. 8 is a partial plan view for schematically indicating the shifter section that represents one example of a next step of the print transporting steps indicated in FIG. 7;

FIG. 9 is a partial plan view for schematically indicating the shifter section that represents one example of a next step of the print transporting steps indicated in FIG. 8;

FIGS. 10A to 10D are schematic diagrams for showing one example of transporting steps of prints according to the image recording apparatus of the present invention in the step sequence;

FIG. 11 is a partial plan view for schematically indicating the shifter section that indicates a transporting method of a large sized print by the image recording apparatus shown in FIG. 1;

FIG. 12A is a schematic diagram for indicating one example of a first image recording mode by the image recording apparatus of the present invention, and FIG. 12B is a schematic diagram showing one example of bundles of accumulated prints obtained in the first image recording mode represented in FIG. 12A;

FIG. 13A is a schematic diagram for indicating one example of a second image recording mode by the image recording apparatus of the present invention, and FIG. 13B is a schematic diagram showing one example of bundles of accumulated prints obtained in the second image recording mode represented in FIG. 13B;

FIG. 14A is a schematic diagram for indicating one example of a third image recording mode by the image recording apparatus of the present invention, and FIG. 14B is a schematic diagram showing one example of bundles of accumulated prints obtained in the third image recording mode represented in FIG. 14A;

FIG. 15A is a schematic diagram for indicating one example of a fourth image recording mode by the image recording apparatus of the present invention, and FIG. 15B is a schematic diagram showing one example of bundles of accumulated prints obtained in the fourth image recording mode represented in FIG. 15A;

FIG. 16 is a schematic diagram showing another embodiment of the image recording apparatus according to the present invention;

FIG. 17 is a schematic block diagram showing one embodiment of a control unit of the image recording apparatus shown in FIG. 16;

FIG. 18 is a schematic diagram showing one example of a major portion of the control unit of the image recording apparatus shown in FIG. 17;

FIG. 19 is a schematic diagram showing one example of normal printing image data created by an image allocating unit of the control unit shown in FIG. 17;

FIG. 20A is a schematic diagram representing one example of printing image data of a mode 1r which is created by the image allocating unit of the control unit indicated in FIG. 17, and FIG. 20B is a schematic diagram showing one example of a structure of the printing image data in the mode 1 of FIG. 20A;

FIG. 21A is a schematic diagram representing one example of printing image data of a mode 2, which is created by the image allocating unit of the control unit indicated in FIG. 17, and FIG. 21B is a schematic diagram showing one example of a structure of the printing image data in the mode 2 of FIG. 21A;

FIG. 22 is a schematic plan view for indicating a structure of one embodiment of the sifter unit of the image recording apparatus shown in FIG. 16;

FIG. 23 is a perspective diagram for schematically indicating a structure of the shifter section shown in FIG. 22;

FIG. 24 is a schematic plan view for showing one example of print transporting steps by the image recording apparatus indicated in FIG. 16 in the sequence of the transporting step;

FIG. 25 is a schematic plan view for showing one example of print transporting steps by the image recording apparatus indicated in FIG. 16 in the sequence of the transporting step, namely, showing a next step following that of FIG. 24;

FIG. 26 is a schematic plan view for showing one example of print transporting steps by the image recording apparatus indicated in FIG. 16 in the sequence of the transporting step, namely, indicating a next step following that of FIG. 25;

FIGS. 27A to 27D are schematic diagrams for indicating one example of print transporting steps by the image recording apparatus shown in FIG. 16 by way of arrangements of prints in the step sequence;

FIG. 28 is a schematic plan view for explaining an example of a transporting method of a large-sized print by the image recording apparatus shown in FIG. 16;

FIG. 29A is a schematic diagram for indicating one example of an image recording mode in the normal printing process performed by the image recording apparatus shown in FIG. 16, and FIG. 29B is a schematic diagram representing one example of a bundle of accumulated prints obtained in the normal print process represented in FIG. 29A;

FIG. 30A is a schematic diagram for indicating one example of an image recording mode in a mode 1 performed by the image recording apparatus shown in FIG. 16, and FIG. 30B is a schematic diagram representing one example of a bundle of accumulated prints obtained in the image recording mode of the mode 1 represented in FIG. 30A:

FIG. 31A is a timing chart for showing one example of an accumulated condition obtained in the normal process in the mode 1 shown in FIG. 30A, and FIG. 31B is a timing chart for representing one example of an accumulated condition obtained in a print process operation having a high priority;

FIG. 32A is a schematic diagram for indicating one example of an image recording mode in a mode 2 performed by the image recording apparatus shown in FIG. 16, and FIG. 32B is a schematic diagram representing one example of bundles of accumulated prints obtained in the mode 1 represented in FIG. 32A;

FIG. 33A is a timing chart for showing one example of an accumulated condition obtained in the normal process in the mode 2 shown in FIG. 32A, and FIG. 33B is a timing chart for representing one example of an accumulated condition obtained in a print process operation having a high priority;

FIG. 34 is a schematic diagram for indicating one example of printing image data for 3 orders in the mode 2, which are created by the image allocating unit of the control unit shown in FIG. 17;

FIG. 35A is a timing chart for showing one example of an accumulated condition obtained in the normal process in accordance with the printing image data shown in FIG. 34A, and FIG. 35B is a timing chart for representing one example of an accumulated condition obtained in a print process operation having a high priority;

FIG. 36 is a flow chart for indicating one example of selecting steps of either the mode 1 or the mode 2 in a case where the priority of an inputted order is high in the image recording apparatus shown in FIG. 16;

FIG. 37 is a schematic diagram showing another embodiment of the image recording apparatus according to the present invention;

FIG. 38 is a schematic block diagram showing one example of a control unit of the image recording apparatus shown in FIG. 37;

FIG. 39 is a schematic diagram showing one example of a major portion of the control unit of the image recording apparatus shown in FIG. 38;

FIG. 40 is a schematic diagram showing one example of normal printing image data created by an image allocating unit of the control unit shown in FIG. 38;

FIG. 41A is a schematic diagram representing one example of image allocation data of an image recording mode including a print process having a high priority, which is created by the image allocating unit of the control unit shown in FIG. 38, and FIG. 41B is a schematic diagram showing one example of a structure of image allocation data in the image recording mode including the print process having the high priority of FIG. 41A;

FIG. 42 is a perspective view for schematically indicating one embodiment of a structure of a shifter section of the image recording apparatus shown in FIG. 37;

FIG. 43A is a plan view for schematically indicating one embodiment of a sort transporting section of the image recording apparatus shown in FIG. 37, and FIG. 43B is a side view for schematically showing a structure of the sort transporting section indicated in FIG. 43A;

FIG. 44A is a schematic diagram for indicating one example of an image recording mode in the normal printing process performed by the image recording apparatus shown in FIG. 37, and FIG. 44B is a schematic diagram representing one example of a bundle of accumulated prints obtained in the normal print process represented in FIG. 44A;

FIG. 45A is a schematic diagram for indicating one example of an image recording mode including a print process having a high priority by the image recording apparatus represented in FIG. 37, and FIG. 45B is a schematic diagram for indicating one example of bundles of accumulated prints obtained in the image recording mode including the print processing operation having the high priority shown in FIG. 45A;

FIG. 46A and FIG. 46B are diagrams for schematically showing one example of a relationship between a control parameter and cut sheets to which images subjected to the normal process and images subjected to an urgent processing have been allocated, namely, 20 images in total have been allocated;

FIG. 47A is a schematic diagram representing one example of image allocation data for 3 orders in an image recording mode including a print process having a high priority, which is created by the image allocating unit of the control unit shown in FIG. 38, and FIG. 47B is a schematic diagram showing one example of the image recording mode including the print process having the high priority performed by the image recording apparatus indicated in FIG. 38; and

FIGS. 48A to 48E are schematic diagrams for indicating one example of operations of the sort transporting section shown in FIG. 43A in step sequence in a case where prints for 3 orders are accumulated.

### DETAILED DESCRIPTION OF THE PREFERRED EMBODIMENTS

An image recording apparatus according to the present invention will now be described in detail according to preferred embodiments shown in the attached drawings.

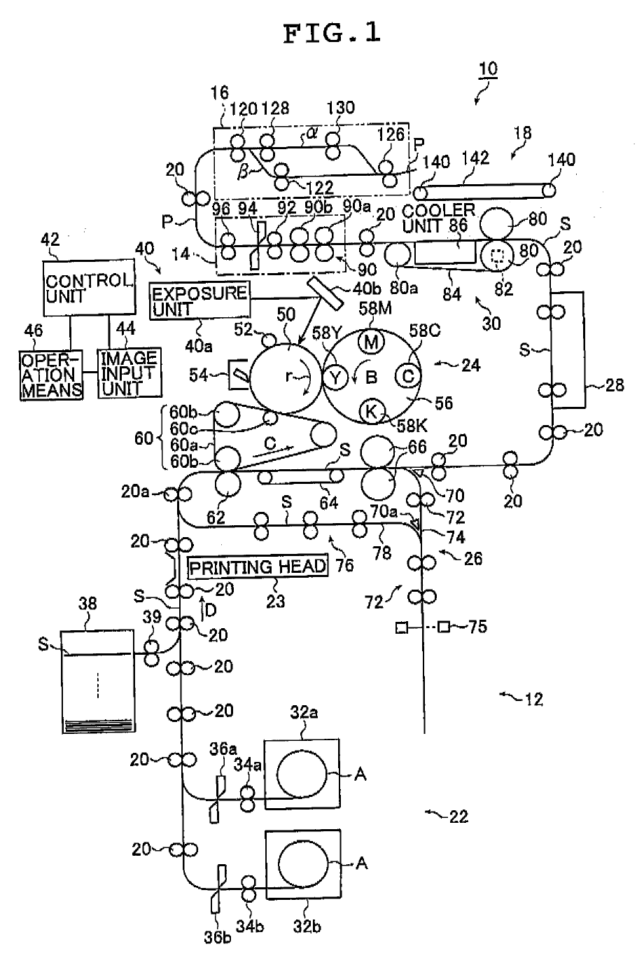

First, description will be made of an image recording apparatus according to a first aspect of the present invention with reference to FIG. 1 to FIG. 15B.

FIG. 1 is a schematic diagram for indicating one embodiment (hereinafter referred to as “first embodiment”) of the image recording apparatus according to the first aspect of the present invention.

As indicated in FIG. 1, an image recording apparatus 10 of the first embodiment comprises an image recording section 12, a cutting section 14, a shifter section 16 which functions as an arranging section, a sort transporting section 18, and transporting means comprising transporting rollers 20.

The image recording section 12 is connected to the cutting section 14, the cutting section 14 is connected to the shifter section 16, and the shifter section 16 is connected to the sort transporting section 18, by the transporting means comprising the transporting rollers 20. In other words, the respective structural elements of the image recording section 12, the cutting section 14, the shifter section 16, and the sort transporting section 18 comprise transporting means including the transporting rollers 20. Also, the respective structural elements are connected to each other by the transporting means comprising the transporting rollers 20.

The image recording section 12 includes a supplying subsection 22, a back printing subsection 23, an image forming subsection 24, a reverse transporting subsection 26, a position adjusting subsection 28, a surface gloss processing subsection 30, an exposure subsection 40, a control unit 42, and transporting means (which includes transporting rollers 20 and registration rollers 20a).

Also, in the image recording section 12, both an image input unit 44 and operation means 46 are connected to the control unit 42.

The image input unit 44 includes a scanner (not shown), a media drive (i.e., image data reading/writing apparatus; not shown), and an image processing unit (not shown).

The scanner (not shown) photoelectrically reads projected light of an image recorded on a photographic film by an image sensor such as a CCD sensor to acquire image data (i.e., image data signal) of the film.

The media drive can read and write image data of an object image that has been acquired by using a digital camera or the like and has been recorded in a compact recording medium.

The media drive reads out image data from various sorts of media (i.e., image data recording media) into which image data have been written in various formats, and then, outputs the read image data to the control unit 42. Printing image data to which predetermined image processing operations have been performed by an image processing unit is written in various sorts of media drives. Thus, the media drives have a function as an input machine and another function as an output machine. It should be noted that the media drives may also read and write image data stored in a portable terminal such as a portable telephone, or a personal digital assistant (PDA).

The image processing unit performs corrections including color corrections or white balance compensations and, where necessary, various image processings such as sharpness settings and red-eye reductions with respect to the image data read by the scanner (not shown) or the media drive. The image input unit 44 outputs the image data, to which corrections or image processings have been performed, to the control unit 42 as output image data.

The image recording section 12 is an electrophotographic image recording section for forming a color image containing plural-color fixed toner images formed on a recording medium in such a manner that, for instance, the plural-color toner images are transferred and fixed onto, for example, a long-length sheet-like or a band-shaped recording medium (i.e., paper) by employing plural-color toners, for instance, a cyan (C) color toner, an magenta (M) color toner, a yellow (Y) color toner, and a black (K) color toner (hereinafter also referred to simply as “CMYK” colors).

Next, the supplying subsection 22 of the image recording section 12 will be explained. The supplying subsection 22 supplies a cut sheet S (i.e., paper) to the image forming subsection 24.

Magazines 32a, 32b, and a sheet cassette 38 are provided in the supplying subsection 22. The magazines 32a and 32b each comprise a long-length roll paper A in a housing wound into a roll shape with the recording surface facing outwardly. The sheet cassette 38 contains a large number of cut sheets S.

In general, the magazines 32a and 32b contain different sorts of roll papers A, i.e., different in sizes (i.e., widths) and surface finishing (i.e., kinds of surface) such as silk or mat, or other specifications (thicknesses). Two magazines 32a and 32b are provided in the first embodiment, but the present invention is not specifically limited only to this number of magazines. Accordingly, in the present invention, one magazine may be employed or, alternatively, 3 or more magazines may be employed.

Drawing-out roller pairs 34a and 34b are provided at positions each spaced a predetermined distance from the exits of the magazines 32a and 32b. The drawing-out roller pairs 34a and 34b draw out the roll papers A contained inside the magazines 32a and 32b, and transport the withdrawn roll papers A.

Cutters 36a and 36b are provided at positions each spaced a predetermined distance from the exits of the magazines 32a and 32b on downstream sides of the drawing-out roller pair 34a and 34b. The roller papers A drawn out by the drawing-out roller pairs 34a and 34b are cut by predetermined lengths to provide cut sheets S.

The drawing-out roller pairs 34a and 34b draw out the roller papers A only by predetermined lengths according to the lengths of prints, and thereafter, stop the drawing-out operation thereof in order to produce cut sheets S that are cut to predetermined lengths by the cutters 36a and 36b.

The cutters 36a and 36b cut the roll papers A drawn out from the respective magazines 32a and 32b in response to a control signal from the control unit 42. The cut sheets S cut to predetermined lengths by the cutters 36a and 36b are further transported.

The cut sheets S which are cut from the roll papers A drawn out from the respective magazines 32a and 32b are transported through a transport path comprising transporting rollers 20 arranged at respective places within the image recording apparatus 10.

A large number of cut sheets S are contained in the sheet cassette 38.

According to the present invention, there is no specific limitation as to a total number of sheet cassettes. According to the present invention, only one sheet cassette may be employed or, alternatively, there may be provided more than one sheet cassette into which cut sheets S with, for example, different sizes or different sorts are stored.

Transporting rollers 39 are provided in the vicinity of a take-out port of the cut sheets S contained in the sheet cassette 38. The cut sheets S are transported to the downstream side in the transport path by the transporting rollers 39.

In the example shown in the drawing, the supplying subsection 22 comprises two magazines 32a and 32b, and one sheet cassette 38, but the present invention is not limited thereto. Alternatively, the supplying subsection 22 may comprise only the magazines 32a and 32b, or only sheet cassettes. In those alternative cases, there is no specific limitation as to a total number of magazines or a total number of sheet cassettes.

The back printing subsection 23 is provided on the downstream side of the supplying subsection 22 along a transporting direction “D” (hereinafter referred to simply as “downstream side”). The back printing subsection 23 is employed to print various sorts of print information.

The back printing subsection 23 records (i.e., back print) a so-called “back print” on a non-recording surface (namely, back surface) of the cut sheets S in response to a control signal from the control unit 42. The “back print” includes various sorts of information and various sorts of setting parameters which are set by an operator when an image is formed. The various sorts of information includes a photographing date, a recording date, a film frame number, a film ID number (i.e., code), an ID number of a camera used in photographing, and an ID number of a printer.

The back printing subsection 23 records the back print on the non-recording surface of the cut sheets S as they are transported upwardly by the rollers and the roller pairs. The back printing subsection 23 may be a known print head such as an ink jet head, a dot impact print head, or a thermal transfer print head.

The registration rollers 20a are provided on the downstream side of the back printing subsection 23. As will be explained later, the cut sheets S bearing the back print on their back surface recorded by the back printing subsection 23 are transported up to a secondary transfer roller 62 of the image forming subsection 24 in a timed sequence, and then, a color toner image which has already been formed on an intermediate transfer belt 60a is transferred onto the transported cut sheets S by the secondary transfer roller 62 and tension rollers 60b. The tension rollers 60b press the intermediate transfer belt 60a and the cut sheets S to the secondary transfer roller 62 to nip the cut sheets S.

The control unit 42 stores therein image data as to images to be printed out which have been ordered (hereinafter referred to also as “order data”), and manages a process sequence of the order data, namely, a printing process sequence executed in the image recording apparatus 10. Further, the control unit 42 controls operations of the devices provided in the image recording apparatus 10, and also manages states of the devices.

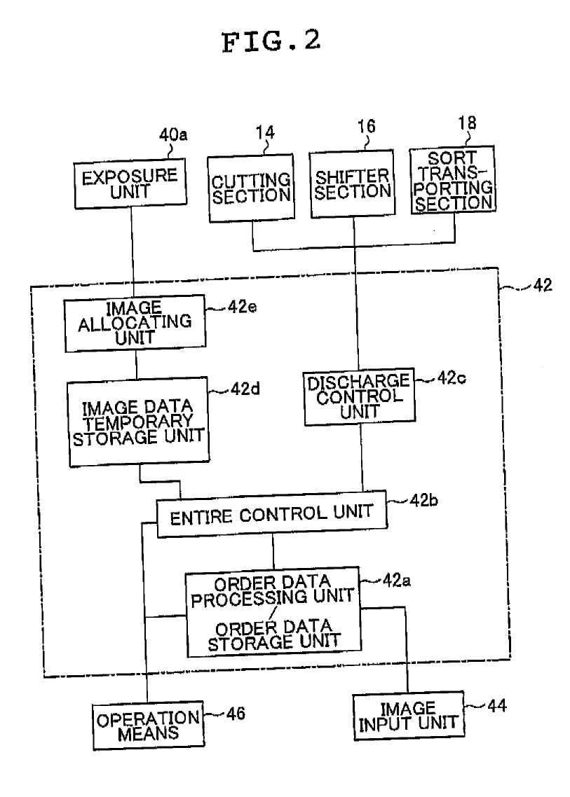

FIG. 2 is a block diagram for schematically indicating an example of a control system including the control unit 42 of the image recording apparatus 10 of the present invention indicated in FIG. 1.

The control unit 42 includes an order data processing unit/order data storage unit 42a, an entire control unit 42b, a discharge control unit 42c, an image data temporary storage unit 42d, and an image allocating unit 42e. The order data processing unit/order data storage unit 42a is connected to an image input unit 44. The order data processing unit/order data storage unit 42a and the entire control unit 42b are each connected to operation means 46.

The order data processing unit/order data storage unit 42a stores therein order data, and manages a processing sequence of order data, namely, a print processing sequence executed in the image recording apparatus 10. The order data processing unit/order data storage unit 42a includes an order table, and outputs stored order data to the entire control unit 42b in accordance with the order table.

The entire control unit 42b controls the order data processing unit/order data storage unit 42a, the discharge control unit 42c, the image data temporary storage unit 42d, and the image allocating unit 42e. The entire control unit 42b controls operations of the respective devices provided in the image recording apparatus 10 other than the order data processing unit/order data storage unit 42a, the discharge control unit 42c, the image data temporary storage unit 42d, and the image allocating unit 42e, and also manages the states of the devices.

In the first embodiment, the discharge control unit 42c acquires at least state information of the shifter section 16, and controls operations of the cutting section 14, the shifter section 16, and the sort transporting section 16. The discharge control unit 42c acquires respective state information of the cutting section 14, the shifter section 16, and the sort transporting section 18, and manages the states of the cutting section 14, the shifter section 16, and the sort transporting section 18. For instance, when the image recording apparatus 10 is initiated, the discharge control unit 42c outputs a command signal to the cutting section 14, the shifter section 16, and the sort transporting section 18, and receives a response signal to the command signal to acquire the respective state information of the cutting section 14, the shifter section 16, and the sort transporting section 18 as to, for example, whether or not the relevant device is operating normally.

The entire control unit 42b also outputs a command signal to the individual devices provided in the image recording apparatus 10 other than the cutting section 14, the shift unit 16, and the sort transporting section 18, and receives a response signal to the command signal in order to acquire state information related to those devices as to, for instance, whether or not the relevant devices are operating normally.

As will be explained, the number of orders for prints P that can be accumulated on the sort transporting section 18 is limited. Thus, the discharge control unit 42c counts the number of orders for prints placed on the sort transporting section 18 based, for instance, upon an amount of discharged prints in the shifter section 16 and a displacement of a belt 142, and manages the number of orders for the prints placed on the sort transporting section 18 as accumulation information. For instance, in the case where the number of prints that can be accumulated is small, the discharge control unit 42c may be adapted to issue a warning.

The image data temporary storage unit 42d temporarily stores therein order data which is outputted from the order data processing unit/order data storage unit 42a to the entire control unit 42b. The order data is outputted from the image data temporary storage unit 42d to the image allocating unit 42e.

The image allocating unit 42e allocates images which are recorded on 1 cut sheet S in accordance with dimensions of the images to be recorded, states of the devices, and appointed delivery dates of prints based upon order data (i.e., image data) inputted from the image input unit 44, and creates printing image data which is to be outputted to the exposure unit 40a. Thus, the images can be recorded such that they are allocated to 1 cut sheet S based upon the image data.

The entire control unit 42b controls image allocation by the image allocating unit 42e, and creates control information, and then outputs the created control information to the shifter section 16 via the discharge control unit 42c. The above-mentioned control information contains information as to a selection of a transport path of prints P acquired based upon the image allocation by the image allocating unit 42e, or information as to whether the shifter section 16 is to be operated, The entire control unit 42b controls the shifter section 16 in the above-mentioned manner. Thus, in the first embodiment, the entire control unit 42b controls the adjustment of the allocation of images to the cut sheet S by the image allocating unit 42e, or the operation of the shifter section 16 by the discharge control unit 42c based upon at least one of the appointed delivery dates of the prints P of the images recorded based on the image data, and the state information obtained by the discharge control unit 42c.

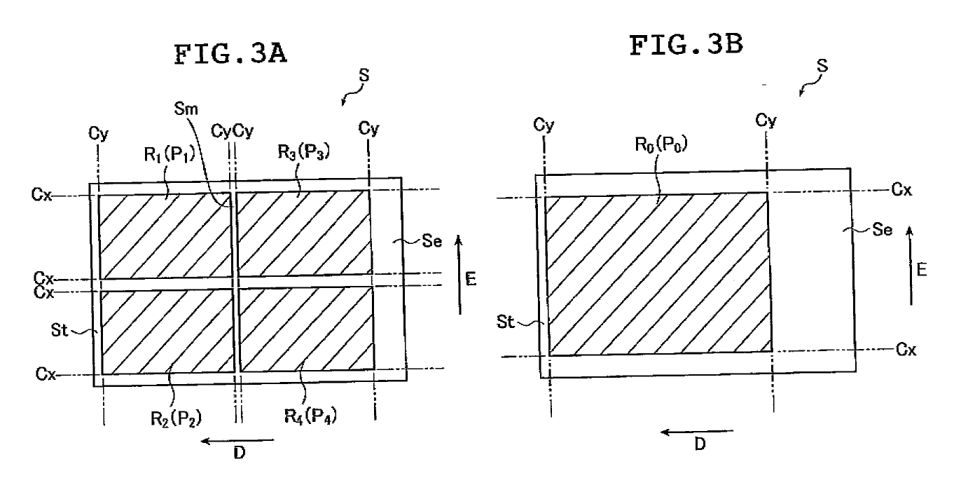

In one allocation mode of images to the cut sheets S by the image recording section 12a, 4-image allocation may be performed, for example, as represented in FIG. 3A, in which 4 image recording regions “R₁” to “R₄” are formed on 1 cut sheet S.

In the 4 image recording regions R₁ to R₄ indicated in FIG. 3A, the image recording region R₁ is provided on an upstream side in a transporting direction “D”, and the image recording region R₃ is provided on a downstream side of the image recording region R₁ in the transporting direction D. The image recording region R₂ is provided adjacent to the image recording region R₁ in a direction E (hereinafter referred to as “direction E”) which is perpendicular to the transporting direction D. Further, the image recording region R₄ is provided on the downstream side of the image recording region R₂ in the transporting direction D. The cut sheet S is cut into 4 image recording regions R₁ to R₄ by the cutting section 14, thereby obtaining 4 sheets of prints “P₁” to “P₄” each having a first width.

In the first embodiment, images in the cut sheet S are formed in a sequence of the image recording region R₁ to the image recording region R₄. More specifically, images are formed in such a sequence that the image recording regions R₂ and R₄ having even numbers and the image recording regions R₁ and R₃ having odd numbers are arranged in two lines in the direction E.

Also, in a mode of image allocation to the cut sheets S by the image recording section 12 according to the invention, a 1-image allocation may be performed as represented in FIG. 3B, in which one image recording region “R₀” is formed in 1 cut sheet S. The cut sheet S is cut into one image recording region R₀ to obtain 1 sheet of print “P₀” having a second width.

Further, a 2-image allocation may be alternatively performed in which image recording regions (not shown) having the same width as that of FIG. 3A, and a length approximately twice as long as that of FIG. 3A are formed.

It should be noted that an allocation of images is not limited only to the above-mentioned image allocations, but may be preferably determined by the control unit 42 (i.e., entire control unit 42b) in a proper manner based upon appointed delivery dates of orders, states of devices, and the like so that a wasted amount of cut sheets S is minimized.

As explained above, the image allocating unit 42e normally performs an order-wise image allocation for the cut sheet S according to the image data with which printing is to be formed. However, in the event that the operation means 46 is operated to cause the image input unit 44 to input image data as order data that additionally contains, for example, an instruction that that order be given priority (such image data being hereinafter referred to as “urgent data”), the entire control unit 42b interrupts the on-going image allocation and allows the urgent data to be inserted into one order data (image data), and adjusts the image allocation by the image allocating unit 42e in such a manner that the print processing on the urgent data is carried out earliest. In this case, as will be explained later, it is preferable that the prints are separated into prints made based upon the urgent data (hereinafter referred to as “urgent print”) and prints made by the normal print processing operation (hereinafter referred to also as “normal prints”) as they are transported to the sort transporting section 18 so that they are accumulated in different accumulation regions by the sort transporting section 18. The allocation of the images containing the above-mentioned urgent data will be explained later in detail.

In the case where the discharge control unit 42c acquires device information on malfunctioning of the shifter section 16, the malfunction device information is outputted from the discharge control unit 42c to the entire control unit 42b. Although images are normally allocated order-wise to a cut sheet S, in such a case, image data for two orders are temporarily stored in the image data temporary storage unit 42d, for example, and an image allocation is carried out by employing the image data for the two orders. Thus, prints can be accumulated in the sort transporting section 18 in two lines, each for their respective orders. Accordingly, for example, an adverse effect caused by a malfunction can be minimized.

When the operation means 46 is operated by an operator, the control unit 42 causes the image recording apparatus 10 to set or display various sorts of information according to the contents of this operation. The control unit 42 may control the scanner (not shown) and the media drive of the image input unit 44.

The image forming subsection 24 forms, for instance, a color toner image using 4 color toners (CMYK) and transfers the formed color toner image onto the cut sheet S (recording medium). The image forming subsection 24 includes an exposure subsection 40, an image carrier roller 50, a charge roller 52, a cleaner 54, a developing unit 56, an intermediate transferring unit 60, and the secondary transfer roller 62.

The exposure subsection 40 comprises an exposure unit 40a and scanning means 40b, and further comprises a collimator lens (not shown), and an fθ lens (not shown).

In the exposure unit 40a, a semiconductor laser, an LED, or the like is employed. This exposure unit 40a radiates an outgoing beam (i.e., optical beam) modulated by the control unit 42 (i.e., image allocating unit 42e) based on the inputted printing image data. The exposure subsection 40 may be of a type that modulates the outgoing beam from the exposure unit 40a by employing an optical modulator such as an AOM.

The scanning means 40b scans the outgoing beam (i.e., optical beam) radiated from the exposure unit 40a over the image carrier roller 50. As the scanning means 40b, for example, a polygon mirror is employed.

The image carrier roller 50 is a roller on whose surface an electrostatic latent image is formed, and is constructed of an electrophotographic photosensitive material. The image carrier roller 50 is supported such that it is rotatable in one direction (i.e., an r direction).

The charge roller 52 is in contact with the surface of the image carrier roller 50. The charge roller 52 uniformly charges the surface of the image carrier roller 50. The cleaner 54 is provided on the upstream side of the charge roller 52 (namely, opposite side in an r direction) in the rotation of the image carrier roller 50. The cleaner 54 is provided to remove residual toner which remains on the surface of the image carrier roller 50.

The surface of the image carrier roller 50 rotated in the r direction is uniformly charged by the charge roller 52. The uniformly charged surface of the image carrier roller 50 is scanned/exposed by exposure subsection 40 with laser beam that is modulated based upon one output image data of the respective images separated by color, namely, yellow (Y), magenta (M), cyan (C), and black (K) supplied from the image input apparatus. Thus, an electrostatic latent image of one image out of the Y, M, C, and K color images with predetermined surface potentials is formed on the surface of the image carrier roller 50.

The developing unit 56 is arranged with a fine gap between itself and the surface of the image carrier roller 50. The developing unit 56 is provided on the downstream side (in an r direction) of the charge roller 52 with respect to an exposure position.

The developing unit 56 comprises therein developing apparatus 58Y, 58M, 58C, and 58K for the respective colors, yellow (Y), magenta (M), cyan (C), and black (K) arranged at intervals of 90 degrees.

The developing apparatus 58Y, 58M, 58C, and 58K are of so-called (two-component) magnetic brush developing type. Two-component developer (not shown) containing toner and carriers is housed in the developing apparatus 58Y, 58M, 58C, and 58K.

The developing unit 56 is rotated in a B direction (namely, direction opposite to the r direction) at the increments of 90 degrees, thereby causing any one of the matching color developing apparatus 58Y, 58M, 58C, and 58K built in the developing unit 56 to oppose the image carrier roller 50 on which the latent image of the relevant color image has been formed, with a fine gap maintained in between.

Toner is provided by a matching color developing apparatus from among the color developing apparatus 58Y, 58M, 58C, and 58K, which is adjacent and opposite to the image carrier roller 50 on which the latent image of the predetermined color image has been formed, and electrostatically attached to the electrostatic latent image formed on the surface of the image carrier roller 50 due to the magnetic brush effect, thereby forming the corresponding color toner image on the surface of the image carrier roller 50. Thus the respective color toner images corresponding to the respective color developing apparatus 58Y, 58M, 58C, and 58K are formed. Accordingly, the latent images corresponding to the respective color images of Y, M, C, and K are sequentially formed on the image carrier roller 50, and then, the color toner images of Y, M, C, and K are sequentially formed by the respective developing apparatus 58Y, 58M, 58C, and 58K.

The intermediate transferring unit 60 has a portion thereof in contact with the image carrier roller 50 and the toner images of the respective colors, namely, 4 colors of YMCK, sequentially formed on the image carrier roller 50, are sequentially transferred to the intermediate transferring unit 60. The intermediate transferring unit 60 comprises the intermediate transfer belt 60a, three tension rollers 60b over which the belt is passed, and a primary transfer roller 60c. The primary transfer roller 60c causes the intermediate transfer belt 60a to contact the image carrier roller 50 to apply a transfer voltage to the intermediate transfer belt 60a. The intermediate transfer belt 60a is passed over the three tension rollers 60b, and is rotated in a C direction.

One among the three tension rollers 60b is arranged at a position opposite to the secondary transfer roller 62 with the intermediate transfer belt 60a between these two rollers, and the tension roller 60b nips and transports the intermediate transfer belt 60a and the cut sheet S by closely contacting the intermediate transfer belt 60a with the cut sheets S in such a manner that a toner image having a predetermined color formed on the intermediate transfer belt 60a may be properly transferred onto the cut sheet S.

The primary transfer roller 60c is arranged at the primary transfer position where the intermediate transfer belt 60a contacts the image carrier roller 50. The primary transfer roller 60c applies a transfer voltage to the intermediate transfer belt 60a.

The toner images with their respective colors which have been sequentially formed on the surface of the image carrier roller 50 by the respective developing apparatus 58Y, 58M, 58C, and 58K are sequentially transferred onto the intermediate transfer belt 60a as the primary transfer roller 60c applies the transfer voltage.

Next, description will be made of a method of forming a color image by the image recording section 12 of the first embodiment.

First, an electrostatic latent image for a yellow color image is formed on the surface of the image carrier roller 50 by the exposure subsection 40. Toner is electrostatically adsorbed onto the electrostatic latent image of the yellow image (i.e., data) from the yellow developing apparatus 58Y of the developing unit 56 so as to form a yellow toner image on the surface of the image carrier roller 50.

Then, the yellow toner image is transferred onto the intermediate transfer belt 60a.

Next, an electrostatic latent image for a magenta image (data) is formed by the exposure subsection 40 on the surface of the image carrier roller 50 from which the residual toner has been removed by the cleaner 54.

At this time, the developing unit 56 has previously been rotated by an angle of 90 degrees and the developing apparatus 58M for the magenta color is arranged opposite to the image carrier roller 50 with a fine gap as predetermined.

Toner is adsorbed onto the electrostatic latent image of the magenta image from the developing apparatus 58M, thereby forming a magenta toner image on the surface of the image carrier roller 50. The magenta toner image is transferred onto the intermediate transfer belt 60a so as to overlap the yellow toner image that has already been transferred.

Subsequently, similarly to the magenta toner image formation and the transferring of the magenta toner image onto the intermediate transfer belt 60a, the remaining cyan (C) toner image and black (K) toner image are sequentially transferred onto the intermediate transfer belt 60a so as to overlap the yellow toner image and the magenta toner image.

The tension roller 60b which moves the intermediate transfer belt 60a is controlled by the control unit 42 in such a manner that the toner images with the respective colors YMCK which are sequentially transferred correctly overlap each other.

The secondary transfer roller 62 is arranged to sandwich the intermediate transfer belt 60a with one at the above-mentioned tension rollers 60b.

The secondary transfer roller 62 is provided to transfer the toner images having the four colors of CMYK formed on the intermediate transfer belt 60a onto a cut sheet S which is transported from the supplying subsection 22. The secondary transfer roller 62 applies to the color toner images electric charges with opposite polarities to those of the respective color toners which constitute the color toner images to transfer the color toner image onto the cut sheet member S (recording medium). Thus, the toner images with the 4 colors of CMYK are formed on the surface of the cut sheet S.

As explained above, the intermediate transfer belt 60a is rotated 4 turns in the direction indicated by the arrow C to form the color toner images on the intermediate transfer belt 60a. Every time the intermediate transfer belt 60a is rotated by 1 turn, one color toner image is transferred onto the intermediate transfer belt 60a, thus forming the toner images with the 4 colors of CMYK.

In the first embodiment, to form color toner images on the cut sheet S, the cut sheet S is transported by the registration rollers 20a to the secondary transfer roller 62 at such a timing that the color toner images formed on the intermediate transfer belt 60a with all of the 4-color toner images transferred thereto are first located opposite to the secondary transfer roller 62. The control unit 42 controls the registration rollers 20a such that the registration rollers 20a transport the cut sheet S at such a timing.

A transport belt 64 is provided on the downstream side of the secondary transfer roller 62. Primary fixing units 66 are provided on the downstream side of the transport belt 64. The transport rollers 20 are provided on the downstream side of the primary fixing units 66.

The cut sheet S onto which the color toner image has been transferred in accordance with the above-mentioned sequential operation is transported to the primary fixing units 66 by the transfer belt 64 provided on the downstream side of the secondary transfer roller 62. The primary fixing units 66 comprising a pair of heating/pressurizing rollers heat and pressurize the cut sheet S.

The primary fixing units 66 perform the fixing processing, whereby the color toner image is fixed on the cut sheet S. In this case, an image obtained by fixing a color toner image by this primary fixing units 66 does not have such a high image quality as is required of a photographic image, but have an image quality equivalent to that of an image obtained in color copying machines, or the like.

The cut sheet S fixed by the primary fixing units 66 is transported to the position adjusting subsection 28 by the transport rollers 20. Then, the cut sheet S is transported from the position adjusting subsection 28 to the surface gloss processing subsection 30 by the transport rollers 20.

The position adjusting subsection 28 adjusts a position of the cut sheet S fixed by the primary fixing units 66 in a direction (hereinafter referred to as “width direction”) perpendicular to the transporting direction. This position adjusting subsection 28 may comprise, for instance, a plate provided in the width direction, such that the cut sheet S is allowed to abut against this plate so as to regulate the position of the cut sheet S, and adjust the position of the cut sheet S in the width direction. Alternatively, nip rollers may be provided by which the cut sheet S can be transported in the width direction to adjust the position of the cut sheet S in the width direction.

The reverse transporting subsection 26 flips the cut sheet S to which image has been fixed by the primary fixing units 66 in order to record images on both surfaces of the cut sheet S.

The reverse transporting subsection 26 comprises switching guides 70 and 70a, drawing-in rollers 72, a sensor 75, and drawing-out rollers 76. A drawing-in path 74 is formed by the drawing-in rollers 72 and a drawing-out path 78 is formed by the drawing-out rollers 76. The sensor 75 is provided at an end of the drawing-in path 74. The sensor 75 is, for example, an optical sensor for detecting whether or not an object is present by shielding light, and is constructed of a pair of a light emitting element and a light receiving element. Transportation into the drawing-in path 74 and the drawing-out path 78 is switched by the switching guide 70a.

The switching guide 70 guides the cut sheet S to which image has been fixed by the primary fixing units 66 to the drawing-in rollers 72. The switching guide 70 switches the transporting destination of the cut sheet S to which image has been fixed by the primary fixing units 66 to either the position adjusting subsection 28 or the reverse transporting subsection 26.

The drawing-in rollers 72 draw in the cut sheet S to which image has been fixed by the primary fixing units 66, and transport the cut sheet S in an opposite direction when the cut sheet S is detected by the sensor 75.

The drawing-out rollers 76 transport the cut sheet S to the registration rollers 20a.

In the reverse transporting subsection 26, after a cut sheet S with an image recorded on one surface thereof is subjected to the fixing process by the primary fixing units 66, the cut sheet S is drawn into the drawing-in path 74 by the drawing-in rollers 72. When the cut sheet S is detected by the sensor 75, the cut sheet S is transported to the drawing-out path 78. Thus, the cut sheet S is reversed.

Based on the detection result of the cut sheet S by the sensor 75, the switching guides 70 and 70a, the drawing-in rollers 72, and the drawing-out rollers 76 are controlled.

In the first embodiment, when a cut sheet S to be reversed is transported in order to record images on both front and back surfaces of the cut sheet S, the switching guide 70 guides the cut sheet S to the drawing-in rollers-72 so as to rotate a pair of the drawing-in rollers 72. When the cut sheet S is drawn into the drawing-in rollers 72 and is detected by the sensor 75, the drawing-in rollers 72 transport the cut sheet S in the opposite direction, and the switching guide 70a guides the cut sheet S to the drawing-out path 78. Thus, the drawing-out rollers 76 transport the cut sheet S to the registration rollers 20a, and this cut sheet S is turned over.

When the reverse transporting subsection 26 according to the first embodiment reverses the cut sheet S, the reverse transporting subsection 26 also reverses the images with respect to the transporting direction. Thus, when recording images on the cut sheet S turned over by the reverse transporting subsection 26, it is necessary to record the images that are reversed with respect to the transporting direction.

The surface gloss processing subsection 30 processes the surface of the cut sheet S to which color toner image has been fixed by the primary fixing units 66 and of which the widthwise position has been adjusted. In this surface processing, for example, the surface of the color toner image is further smoothened and provided with a gloss.

The surface gloss processing subsection 30 comprises a heating/pressurizing roller pair 80, a temperature sensor 82 for detecting the temperature of the heating/pressurizing roller pair 80, a secondary fixing belt 84 having a smooth gloss surface which circulates, and a cooler unit 86. The heating/pressurizing roller pair 80 heat and pressurize the cut sheet S on which the color toner image is fixed. The cooler unit 86 Cools the cut sheet S heated by the heating/pressurizing roller pair 80.

The secondary fixing belt 84 is passed over one roller of the heating/pressurizing roller pair 80, and a tension roller 80a.

While the surface gloss processing subsection 30 in this embodiment is described referring, by way of example, to a surface processing in which the surface of the color toner image is smoothened and the gloss is given to the smoothened surface, the present invention is not limited thereto. The surface gloss processing subsection 30 may alternatively perform a matting processing to provide a matte finish to the surface of a color toner image to give a viewer a visualization effect. In this case, the secondary fixing belt 84 in the surface gloss processing subsection 30 has coarse surface to provide a matte finish to the surface of the color toner image.

In the surface gloss processing unit 30, the color toner image fixed in the primary fixing units 66 is first heated and melted, and the surface of the melted color toner image is pressed against the smooth gloss surface of the secondary fixing belt 84 by the heating/pressurizing roller pair 80.

Next, the cut sheet S is transported to the downstream side as it is attached to the gloss surface of the secondary fixing belt 84, and further, the cut sheet S as attached to the gloss surface is cooled by the cooler unit 86 arranged on the downstream side of the heating/pressurizing roller pair 80. As a result, the melted color toner image on the cut sheet S is coagulated. After that, the cut sheet S is transported further down the stream, and then the cut sheet S is separated from the gloss surface of the secondary fixing belt 84 by the stiffness thereof as the secondary fixing belt 84 bends about the tension roller 80a.

Thus, a color image is formed on the cut sheet S in the image recording section 12. It should be noted that when an image is recorded on one surface of the cut sheet S, the image is recorded on the underside of the cut sheet S.

Next, as indicated in FIG. 1, the cut sheet S on which the image has been recorded is transported to the cutting section 14 by the transport rollers 20.

In the first embodiment, rollers such as a transport roller, for instance, may be formed of rubber rollers.

Roll paper and cut sheets S in the first embodiment may be, for example, paper generally used in electrophotographic printers.

Referring to FIG. 1, the cutting section 14 cuts the periphery off the recording regions R₁ to R₄ and R₀ (refer to FIGS. 3A and 3B) on which the images have been recorded by the image recording section 12 to obtain prints P₁ to P₄ and P₀.

As indicated in FIG. 1, the cutting section 14 comprises a first cutter 90, a second cutter 94, a scrap collection container (not shown), first transport roller pairs 92 and 96, and a movable guide (not shown).

The second cutter 94, the first transport roller pairs 92 and 96, and the movable guide are each connected to the control unit 42, which controls their respective operations.

The first cutter 90 cuts the cut sheet S in a direction parallel to the transporting direction D. The first cutter 90 cuts the cut sheet S along cut lines “Cx”, for instance, of the cut sheet S shown in FIGS. 3A and 3B.

The first cutter 90 comprises first rotary cutters 90a and second rotary cutters 90b. Two pairs of the first rotary cutters 90a, 4 pieces in total, are movably provided in the width direction perpendicular to the transporting direction D. Two pairs of the second rotary cutters 90b, 4 pieces in total, are also movably provided in the width direction perpendicular to the transporting direction D.

Thus, the cut sheet S can be cut along the cut lines Cx shown in FIGS. 3A and 3B.

The second cutter 94 shears (i.e., cuts) the cut sheet S in a direction E, and is provided on the downstream side of the first cutter 90 in the transporting direction D.

The second cutter 94 comprises a fixed blade 94a and a movable blade 94b opposed to each other in the vertical direction and separated by the transport path of the cut sheet S. The movable blade 94b is caused to contact and separate from the fixed blade 94a in the vertical direction. As a result, the cut sheet S can be cut along cut lines “Cy” as shown in FIGS. 3A and 3B. The second cutter 94 will be explained later in detail. The movable blade 94b is provided on the side of the image recording surface when the image is recorded on only one side of the sheet.

The scrap collection container (not shown) collects cut waste that is produced by cutting the cut sheet S with the first cutter 90 and the second cutter 94. The scrap collection containers are provided under the first cutter 90 and the second cutter 94.

Also, the first transport roller pair 92 (i.e., transporting means of present invention) transports the cut sheet S transported from the first cuter 90, and is provided between the first cutter 90 and the second cutter 94.

There are no specific limitations to the first transport roller pair 92, provided that it can transport the cut sheet S and control the transportation of the cut sheet S.

The second transport roller pair 96 transports the cut sheet S transported from the second cutter 94, and is provided on the downstream side of the second cutter 94.

The second transport roller pair 96 comprises one pair of transport rollers 96a and 96b. The second transport roller pair 96 comprises a one-way clutch (not shown) that turns freely in a direction that causes the cut sheet S to advance down the stream in the transporting direction D.

In the first embodiment, a transporting speed of the first transport roller pair 92 provided on the upstream side of the second cutter 94 is set to turn faster than that of the second transport roller pair 96 so as to reduce the effect of a tension that may be applied to the cut sheet S caused by the second transport roller pair 96. Moreover, the one-way clutch prevents the cut sheet S from slackening between the first transport roller pair 92 and the second transport roller pair 96 that may be caused by the stiffness of the cut sheet S in the transporting direction. Thus, fluctuations in the cutting position is reduced and the cutting precision can be increased.

The cutting section 14 yields a print P, which is then transported by the transport rollers 20 to the shifter section 16.

Next, the shifter section 16 will be explained.

In the first embodiment, the shifter section 16 functions as an arranging section that arranges a plurality of print sheets, which are supplied in a plurality of lines after being cut into prints with predetermined sizes by the cutting section 14, into a single line.

In an example shown in the drawing, for example, the shifter section 16 first arranges prints P with the first width, which are cut by the cutting section 14 and are supplied in two lines, into a single line. Further, the shifter section 16 may also allow such a print P with a second width larger than the first width to pass as it comes. Also, the shifter section 16 arranges another kind of print having such dimensions generally called “panorama frame” (89 mm×254 mm) into a single line in a similar manner to that for the prints having the first width. The print will be hereinafter referred to as a “panorama print”, the width of which is equal to the first width, and the length of which in the transporting direction is approximately twice as long as that of the print having the first width.

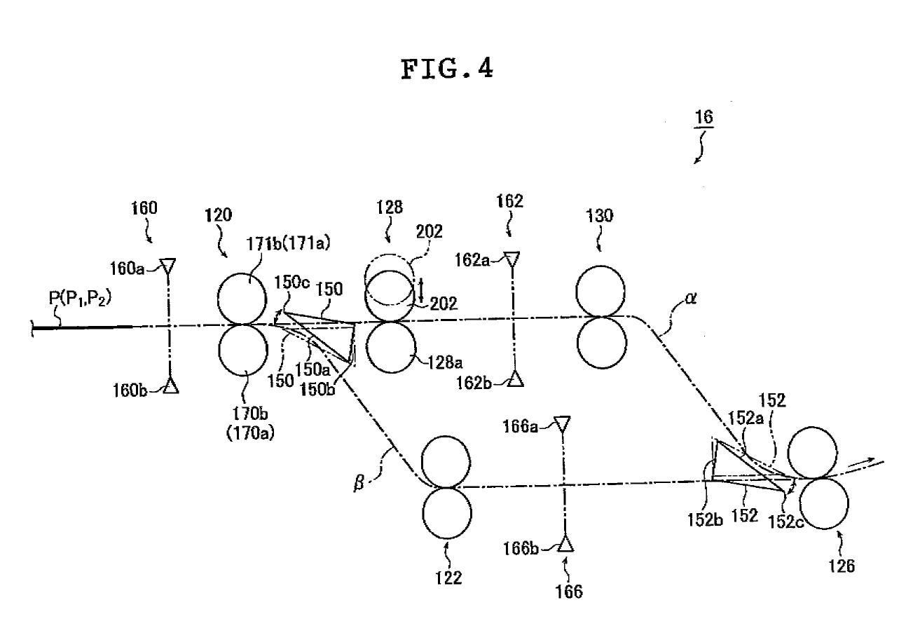

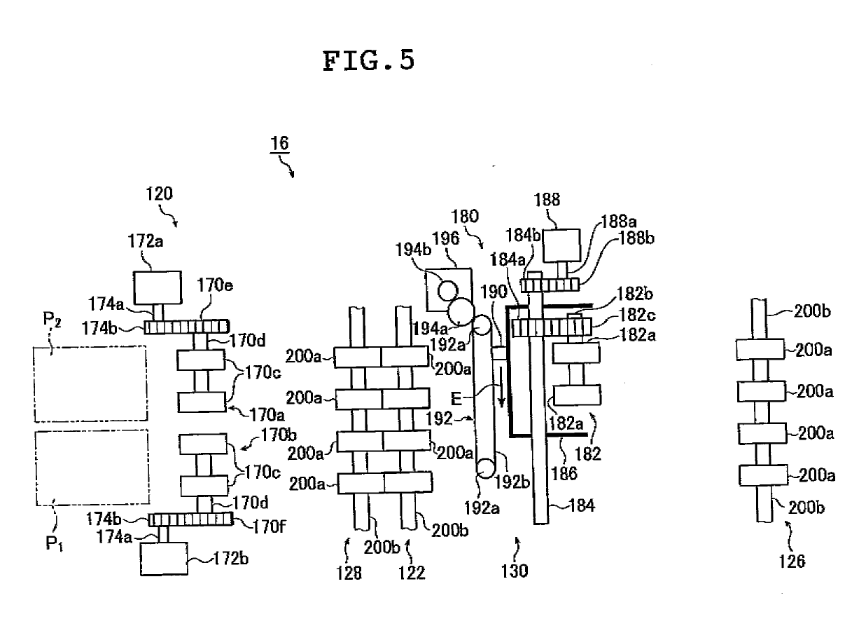

As shown in FIGS. 1 and 4, the shifter section 16 comprises a feeding roller pair 120, transport roller pairs 122 and 128, a discharge roller pair 126, a shift roller pair 130, a first movable guide 150, a second movable guide 152, sensors 160, 162, and 166, and a shifter unit 180 (refer to FIG. 5). This shifter unit 180 moves the shift roller pair 130 in the direction E. A transport path having a substantially rhombic shape (i.e., parallelogram) is formed by the feeding roller pair 120, the transport roller pairs 122 and 128, the discharge roller pair 126, and the shift roller pair 130.

In the shifter section 16 of the first embodiment, the transport roller pair 128 is provided on the downstream side of the feeding roller pair 120a spaced a predetermined distance therefrom in the horizontal direction in the transporting direction D. The shift roller pair 130 is provided on the downstream side of the transport roller pair 128 spaced a predetermined distance therefrom in the transporting direction D. The discharge roller pair 126 is provided on the downstream side of the shift roller pair 130 a predetermined distance therefrom in the transporting direction D. A first transport path “α” comprises the feeding roller pair 120, the transport roller pair 128, and the shift roller pair 130.

Also, the transport roller pair 122 is provided on the downstream side of and below the feeding roller pair 120 spaced a predetermined distance therefrom in the transporting direction D. The discharge roller pair 126 is provided on the downstream side of the transport roller pair 122 spaced a predetermined distance therefrom in the transporting direction D. A second transport path “β” comprises the feeding roller pair 120 and the transport roller pair 122.

The first transport path “α” and the second transport path “β” divide such that the second transport path “β” branches off in the direction perpendicular to the direction in which the prints P are arranged and the transport direction D (namely, vertical direction), and meet at the discharge roller pair 126.

As shown in FIG. 4, the first movable guide 150 is provided at the divide where the first transport path “α” and the second transport path “β” separate on the downstream side of the feeding roller pair 120 in the transporting direction D. Also, the second movable guide 152 is provided at the point where the first transport path “α” and the second transport path “β” meet on the upstream side of the transport roller pair 126 in the transporting direction D.

The first movable guide 150 ensures that the finished print P cut by the cutting section 14 be directed to one of the first transport path “α” and the second transport path “β”.

The second movable guide 152 leads the print P, which is transported from one of the first transport path “α” and the second transport path “β”, to the discharge roller pair 126.

The first movable guide 150 and the second movable guide 152 comprise guide members, the side cross section of which is substantially a right triangle, and rotating means for directing the guide members in a transporting direction D of the print P. The first movable guide 150 is arranged in such a manner that an inclined surface 150a faces downward, a short side 150b faces the transport roller 128, and a vertex 150c faces the feeding roller pair 120.

The second movable guide 152 is arranged in such a manner that an inclined surface 152a faces upward, a short side 152b faces the transport roller 122, and a vertex 152c faces the transport roller pair 126.

The first movable guide 150 and second movable guide 152 are controlled by the control unit 42 such that they rotate in response to a print detection signal generated by the sensors 160, 162, and 166.

In the first embodiment, when directing the print P to the first transport path “α”, the first movable guide 150 is pivoted downwardly. When directing the print P to the second transport path “β”, the first movable guide 150 is pivoted upwardly.

When leading the print P from the transport roller pair 122 to the discharge roller pair 126 (in the case where print p is transported via the second transport path “β”), the second movable guide 152 is pivoted upwardly. Further, when advancing the print P from the shift roller pair 130 on to the discharge roller pair 126 (in the case where print P is fed out through the first transport path “α”), the second movable guide 152 is pivoted downwardly. The first movable guide 150 and the second movable guide 152 ensures that the print P be transported without a jam or backup.

The first movable guide 150 and the second movable guide 152 need not be provided over the entire area in the direction E. For instance, the first and second movable guides 150 and 152 may be provided in accordance with, for instance, a width of prints P that are transported in two lines. In the case where the prints P are transported in two lines, two separate movable guides may be provided for each of the movable guides 150 and 152, each of the two separate movable guides having widths that cover the widths of the respective lines of prints P.

In this embodiment, since the print “P₀” (refer to FIG. 3B) with the second width that is larger than the first width need not be arranged to a single line, the print P₀ is always transported through the second transport path “β”. This is because the shift roller pair 130 (shifter unit 180) is provided in the first transfer path “α”. Thus, a transport path without the shift roller pair 130 can transport the print P₀ having the second width larger than the first width.

As indicated in FIG. 5, the feeding roller pair 120 comprises a first separate roller 170a and a second separate roller 170b, which are independently controlled according to a total number of transport lines. In this embodiment, since the prints P are transported in two lines at most, two rollers, i.e., the first separate roller 170a and the second separate roller 170b, are independently provided.

The first separate roller 170a and the second separate roller 170b of the feeding roller pair 120 may be rotated in synchronism with each other, or may be rotated independently, and further, may be rotated at different speeds. Thus, the prints P that have been transported in two lines by the feeding roller pair 120 are independently transported. Accordingly, the positions of the prints P in which they are transported are shifted in frontward/rearward directions in the transporting direction D, so that the prints P can be transported in a staggered manner.

It should be noted that although not shown in FIG. 5, the first separate roller 170a and the second separate roller 170b each have counterpart separate rollers 171a and 171b, as represented in FIG. 4. In the below-mentioned description, even when rollers constitute a pair, i.e., a “roller pair”, explanation and illustration will be provided only as to the first separate roller 170a and the second separate roller 107b, i.e., driving rollers. However, it is apparent that their respective counterpart separate rollers 171a and 171b are also similarly provided.

Also, in the feeding roller pair 120, the separate rollers 171a and 171b may be moved in the vertical direction by driving means (not shown). In the feeding roller pair 120, the first separate roller 170a and the second separate roller 170b constitute a nip roller pair in combination with the separate rollers 171a and 171b, respectively.

As indicated in FIG. 5, for instance, two roller pieces 170o are provided on rotation shafts 170d at predetermined intervals in each of the first separate roller 170a and the second separate roller 170b. The rotation shafts 170d are provided such that the respective axial lines thereof are in alignment with each other. A gear 170e and another gear 170f are mounted on the respective ends of the rotation shafts 170d. Gears 172d mounted to motors 172a and 172b respectively via rotation shafts 172c are meshed with the respective gears 170e and 170f.

The respective motors 172a and 172b may be rotated in synchronism with each other, or may be independently rotated, and further, may be rotated at different speeds. Also, the first separate roller 170a and the second separate roller 170b may be rotated independently, and further, may be rotated at different speeds by the respective motors 172a and 172b. Thus, the prints P that have been transported in two lines by the transport roller pair 128 are transported independently. Further, the positions of the prints P in which they are transported are shifted by the first separate roller 170a and the second separate roller 170b in frontward/rearward directions in the transporting direction D, so that the prints P can be transported in a staggered manner.

As shown in FIG. 5, the transport roller pair 122 transports the print P, and comprises separate rollers in which 4 roller pieces 200a are provided on a rotation shaft 200b spaced at regular intervals. There is no specific restriction as to the structures of those feeding roller pair 120 and the transport roller pair 122.

The discharge roller pair 126 transports prints P that have been transported in lines (two lines in this embodiment), or in a single line to the sort transporting section 19 provided at a post stage. Similarly, the discharge roller pair 126 also has separate rollers in which 4 roller pieces 200a are provided on a rotation shaft 200b spaced at regular intervals.

It is preferable that the discharge roller pair 126 be arranged such that they are inclined so as to transport the prints P toward an upwardly inclined direction. The prints P are transported toward an upwardly inclined direction to prevent an discharged print P from touching the uppermost print of the accumulated prints and possibly causing the uppermost print to be displaced. Thus, the prints accumulation efficiency may be improved.

The transport roller pair 128 moves the prints P transported from the feeding roller pair 120 to a shift roller pair 130 that is moved by the shifter unit 180 in the direction E.

As indicated in FIG. 4, the transport roller pair 128a comprises a transport roller 128a and a nip roller 202, which constitutes a pair with the transport roller 128a. As represented in FIG. 5, the transport roller 128a comprises separate rollers in which 4 roller pieces 200a are provided on the rotation shaft 200b spaced at regular intervals. The nip roller 202 can be moved in the vertical direction by driving means (not shown).

As explained later, in the case where a panorama print is moved in the direction E by the shifter unit 180 of the shift roller pair 130, the panorama print is transported with the nipping of the transport roller pair 128 released because the panorama print has a length which covers the distance from the shift roller pair 130 to the transport roller pair 128.

The shift roller pair 130 transports the prints P in the transporting direction D, and also moves the prints P in the direction E. The shift roller pair 130 includes a transport roller 182, a counterpart transport roller (not shown), and the shifter unit 180 that moves the transport roller 182 and the counterpart transport roller in the direction E (array direction).

The shifter unit 180 comprises a support shaft 184, a first gear 184a, a second gear 184b, a movable frame 186 including the transport roller 182, a motor 188, a rotation shaft 188a, a gear 188b, and a belt driving apparatus 192.

The transport roller 182 may be, for instance, a separate roller comprising roller pieces 182a, e.g., 2 pieces, provided on a rotation shaft 182b spaced at predetermined intervals. A gear 182c is provided on one end of the rotation shaft 182b of the transport roller 182. It should be noted that the entire length of this transport roller 182 in the direction E covers at least an approximate length (length of first width) of prints P (P₁ and P₂) in the width direction.

As indicated in FIG. 5, the shifter unit 180 of the first embodiment comprises the support shaft 184 extending in the direction E. A movable frame 186 having a substantially U-shape (as viewed in plane view) is provided on the support shaft 184 in such a manner that the movable frame 186 can be moved in the direction E. The movable frame 186 comprises an opening that faces downstream in the transporting direction D.

Also, the second gear 184b is provided on one end of the support shaft 184. Further, the first gear 184a is provided on the support shaft 184 within an area surrounded by the movable frame 186 in such a manner that the first gear 184a can be rotated about the axial line of the support shaft 184 and can be freely moved in the direction E. The transport roller 182 and its counterpart transport roller are arranged inside the opening of the movable frame 186, with the first gear 184a in mesh with the gear 182c of the transport roller 182.

The second gear 184b is meshed with the gear 188b provided to the motor 188 via the rotation shaft 188a. Thus, rotation force of the motor 188 is transferred by way of the first gear 184a to the transport roller 182, rotating the transport roller 182.

The movable frame 186 is connected via a connection member 120 to the belt driving apparatus 192. The belt driving apparatus 192 comprises a belt 192b passed over one pair of rollers 192a. The connection member 120 is connected to this belt 192b.

One of the rollers 192a of the belt driving apparatus 192 is connected to the motor 196 via, for example, two gears 194a and 194b. The movable frame 186 is moved by the motor 196 in the longitudinal direction (namely, direction E perpendicular thereto) of the support shaft 184.

In the shift roller pair 130, the prints P can be transported in the transporting direction D by the transport roller 182, and also can be moved in the direction E by the shifter unit 180.

It is preferable that sensors 162 are arrayed in the direction B so as to calculate a skew amount in the first transport path “α” and, based upon the calculated skew amount, the displacement of a print in the direction E effected by the shifter unit 180 is adjusted. Accordingly, adjusting the displacement of the print in the direction E results in the edges of the prints being aligned in the direction E of the prints that have been arranged into a single line. Thus, the print bundle accumulation efficiency can be improved.

While in the shift roller pair 130 of this embodiment, the removable frame 186 equipped with the transport roller 182 is moved, the present invention is not limited thereto. For example, the gear 184a may be adapted to extend in the longitudinal direction of the support shaft 184 and the gear 182c of the transport roller 182 is moved over such a long gear.

The sensors 160, 162, and 166 may be, for example, optical sensors for sensing the presence of an object with shielding light, and comprise light emitting elements 160a, 162a, and 166a each paired with light receiving elements 160b, 162b, and 166b. Provided that sensors can sense the passage of prints P therethrough, constructions of those sensors are not specifically limited.

In the first embodiment, the light emitting elements 160a, 162a, and 166a, and the light receiving elements 160b, 162b, and 166b are arranged in a direction perpendicular to the transport path of the prints P, and the light emitting elements 160a, 162a, and 166a are provided on the non-recording surface side of the print P when images have been recorded only on one side. In the first embodiment, the sensors 160, 162, and 166 may be, for example, blinking infrared sensors.

Next, the sort transporting section 18 will be described.

In the first embodiment, the sort transporting section 18 accumulates in a single line mode or a plural line mode a plurality of prints P transported from the shifter section 16.

Referring to FIG. 1, the sort transporting section 18 accumulates prints P by order that have been transported by the shifter section 16 after being arranged into a single line. The sort transporting section 18 comprises one pair of idle pulleys 140, and a belt 142 that is passed over those idle pulleys 140. The sort transporting section 18 receives prints P transported from the discharge roller pair 126 and allowed to fall onto the belt 142 and accumulates the received prints P thereon. When the sort transporting section 18 recognizes that the prints P for one order have been accumulated according to the sort information and the like, the sort transporting section 18 moves the belt 142 by a predetermined amount so as to transport the accumulated prints P, and stops the transportation of the accumulated prints P, and subsequently accumulates prints P for a next order.

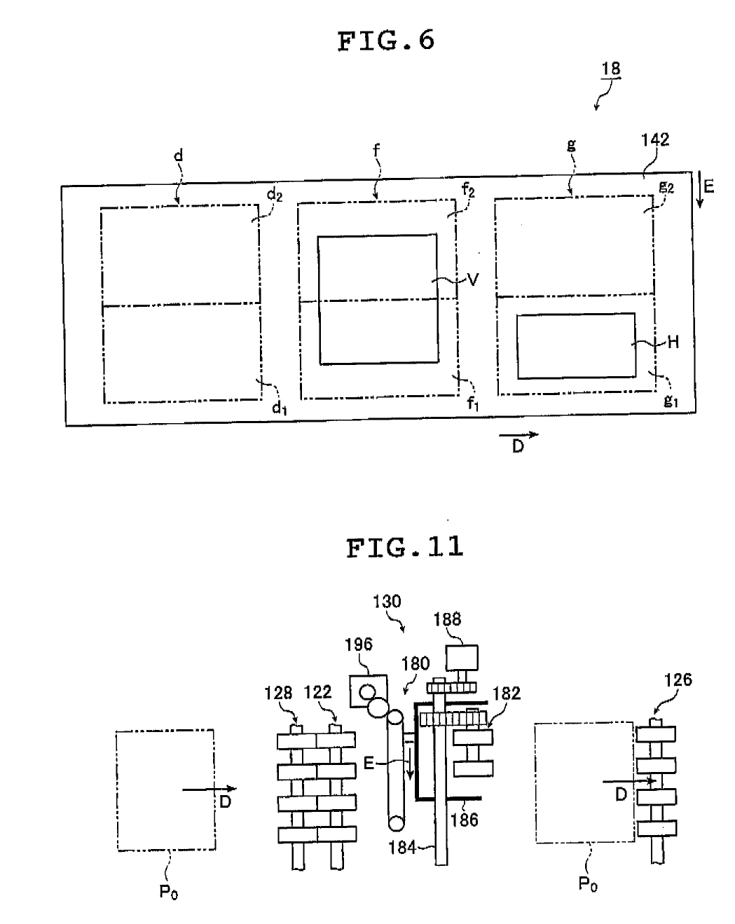

As indicated in FIG. 6, the sort transporting section 18 comprises sort areas “d”, “f”, and “g” where prints P for 3 orders can be arranged in the transporting direction D. In the sort transporting section 18, after a print bundle “V” of P₀ for one order have been accumulated, in the sort area “f”, for instance, the belt 142 is moved by an amount equal to the length of the sort area “f” in the transporting direction D to locate an empty sort area “d” on the uppermost stream side on the belt 142 in the transporting direction D.

The sort transporting section 18 has in the direction E of the belt 142 a width capable of accumulating the print P₀. More specifically, each of the sort areas “d”, “f”, and “g” is capable of accumulating prints P of normal size for 2 orders in the direction E of the belt 142 if the prints P have a normal size. Each of the sort areas “d”, “f”, and “g” has accumulation areas d₁ and d₂; f₁ and f₂; and g₁ and g₂, respectively. Thus, if the prints P have the normal size, then the belt 142 has thereon the accumulation areas d₁, d², f₁, f₂, g₁, and g₂ capable of bearing the prints P for up to 6 orders. In the case where the prints P are transported from the shifter section 16 in two lines, the prints P are accumulated in two lines in the respective accumulation areas d₁, d₂, f₁, f₂, g₁, and g₂.

The sort transporting section 18 is connected to the discharge control unit 42c and the discharge control unit 42c manages the number of orders of prints that are placed on the sort transporting section 18. For instance, when prints have been placed on the sort areas “f” and “g” for 2 orders within the sort areas “d”, “f”, and “g” for 3 orders, namely, when there remains a sort area for only one order, “d” in this case, a warning, for example, is issued by the control unit 42. Also, for instance, in such a case that when there remains a sort area for only one order, “d” for example, prints may be placed on the accumulation areas d₁ and d₂ of the remaining sort area “d”.

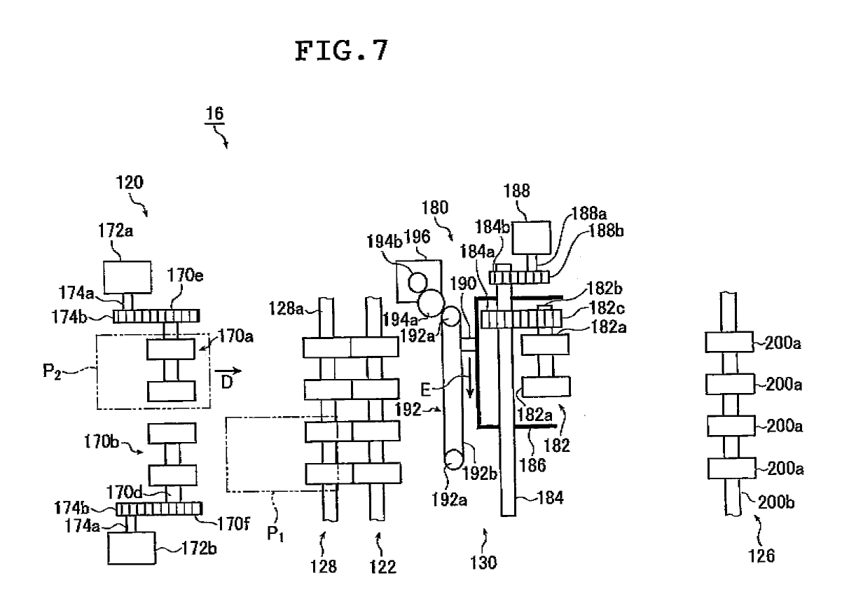

Next, operations of the shifter section 16 will be explained with reference to FIG. 7 to FIG. 10D.

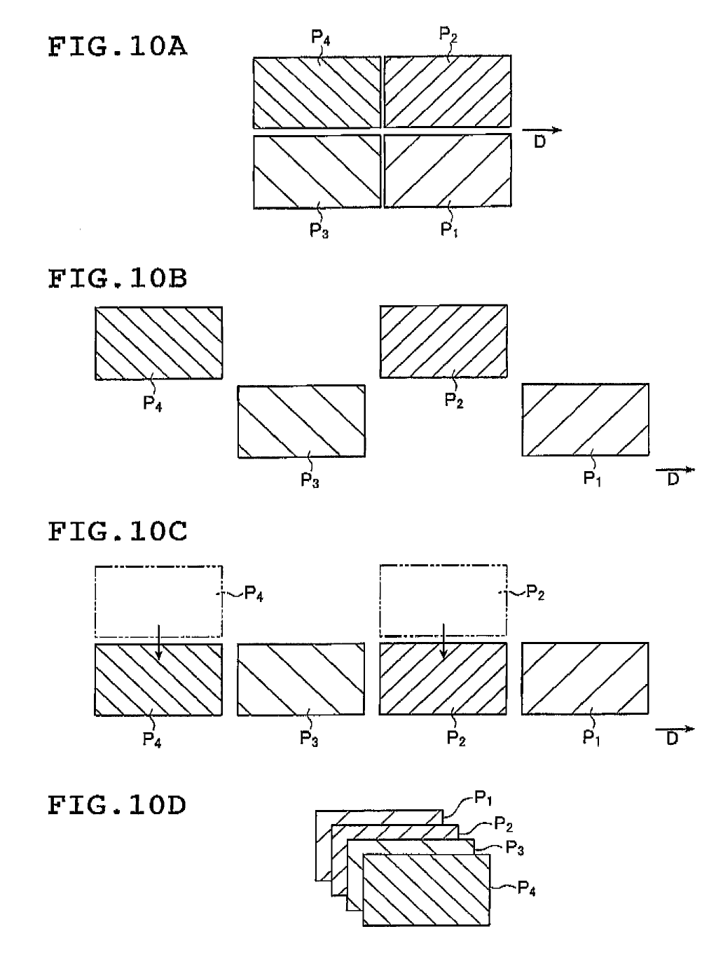

FIG. 7 to FIG. 9 are plan views for schematically indicating one example of print transporting steps by the image recording apparatus of the first embodiment in step sequences. FIGS. 10A to 10D are schematic diagrams for showing print transporting steps of by the image recording apparatus of the first embodiment in step sequences.

In the first embodiment, as shown in FIG. 3A, the cutting section 14 (refer to FIG. 1) cuts the cut sheet S to which 4 images have been allocated, to obtain 4 prints ?P₁ to P₄ (refer to FIG. 10A). Now description will be made of a case where those 4 prints P₁ to P₄ are transported in two lines, and then, 2 sheets of prints P₂ and P₄ that are transported in the same line are moved such that two lines are rearranged into a single line.

In the first embodiment, as shown in FIG. 5, the prints P₁ and P₂ are arrayed side by side as they are carried to the transport roller pair 120, where the print P₂ carried by the first separate roller 170a is moved to the side of the print P₁ carried by the second separate roller 170b, achieving rearrangement into a single line.

In the first embodiment, first, as indicated in FIG. 4 and FIG. 5, the prints P₁ and P₂ are transported side by side in two lines. At this time, the respective prints P₁ and P₂ are transported at the same speed.

Next, as shown in FIG. 7, in the feeding roller pair 120, the transporting speeds by the first separate roller 170a and the second separate roller 170b are adjusted by, for example, increasing the rotation speed of the motor 172b or stopping the rotation of the motor 172a, so that the print P₁ and the print P₂ are transported in staggered positions in the transporting direction D. At this time, the first movable guide 150 is pivoted upwardly to guide the print P₁ to the second transport path “β”.

Then, after a predetermined time has elapsed after the print P₁ is guided to the second transport path “β”, the first movable guide 150 is pivoted downwardly so that the first movable guide 150 is ready to direct the print P₂ to the first transport path “α”. The print P₂ is transported to the transport roller pair 128 by the first separate roller 170a of the feeding roller pair 120.

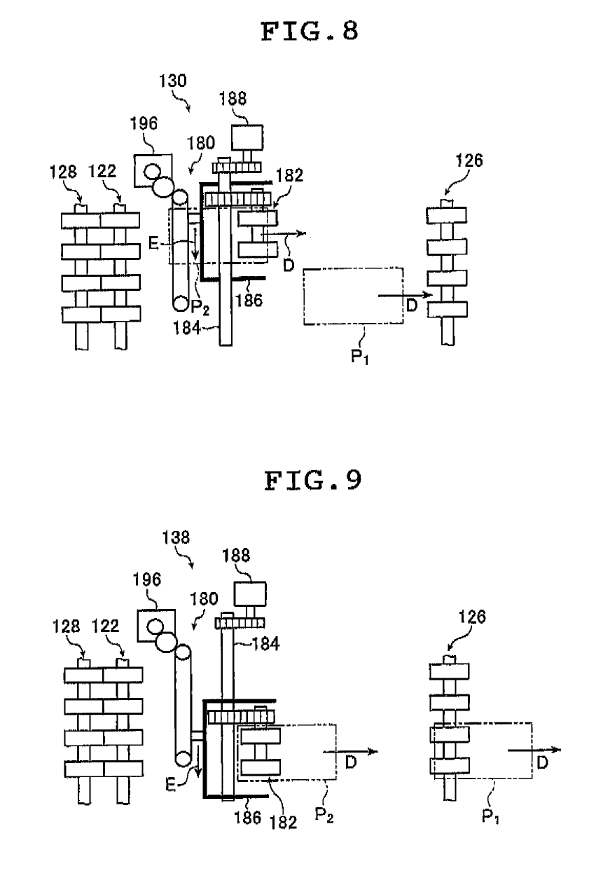

Next, as indicated in FIG. 8, the print P1 carried to the second transport path “β” is transported via the transport roller pair 122 to the discharge roller pair 126. At this time, when the print P₁ is detected by the sensor 166 (refer to FIG. 4) which is provided between the transport roller pair 122 and the discharge roller pair 126, the second movable guide 152 is pivoted upwardly by the control unit 42, so that the print P₁ is transported to the discharge roller pair 126.

In the meantime, the print P₂ is transported to the shift roller pair 130 by the transport roller pair 128.

Next, as shown in FIG. 9, the print P₂ is moved in the direction E (to the side of print P₁) as it is transported by the shift roller pair 130. At this time, the separate roller 182 is rotated by the motor 188, and the movable frame 186 is moved in the direction E by the motor 196.

Then, the second movable guide 152 is pivoted downwardly to direct the print P₂ that is transported via the first transport path “α” to the discharge roller pair 126. Thus, the print P₂ is transported to the discharge roller pair 126.

Thus, as shown in FIG. 9, the print P₁ and P₂ are transported in one line, and then are transported to the sort transporting section 18 (refer to FIG. 1) by the discharge roller pair 126.

When the prints P₃ and P₄ are carried into the feeding roller pair 120, arranged side by side, as in the case of the prints P₁ and P₂, the print P₃ is transported to the second transport path “β”, while the print P₄ is transported to the first transport path “α”, and the print P₄ is moved to the transport side of the print P₃ so that it is arranged behind the print P₃.

Thus, in the case of the prints P₁ to P₄ formed by allocating 4 images to one cut sheet S as indicated in FIG. 10A, the transporting speed of the prints P₁ and P₃ is increased as shown in FIG. 10B. Subsequently, as indicated in FIG. 10C, the print P₂ is moved to the rear of the print P₁, and the print P₄ is moved to the rear of the print P₃, thereby to arrange those prints P₁ to P₄ into a single line. Then, as represented in FIG. 10D, the prints P₁ to P₄ arranged into a single line are stacked on the belt 142 of the sort transporting section 18 successively from the print P₁.

In the case where the width of a print exceeds the first width, for example, as shown in FIG. 3B, such a print P₀ (refer to FIG. 11) having the width obtained by allocating one image to the recording area R₀ is transported in a single line without requiring the rearranging process to be done.

FIG. 11 is a plan view of a shifter unit for schematically showing a method for transporting a large-sized print according to the image recording apparatus of the first embodiment.

When the print P₀ is transported, the first movable guide 150 has been pivoted upwardly to guide the print P₀ to the second transport path “β”. The print P₀ is guided from the feeding roller pair 120 to the transport roller pair 122.

Next, the print P₀ transported by the transport roller pair 122 is transported to the discharge roller pair 126. At this time, the print P₀ is detected by the sensor 166, and the second movable guide 152 is pivoted upwardly, thus guiding the print P₀ from the second transport path “β” to the discharge roller pair 126.

Thus, the print P₀ is transported through the second transport path β, and then is transported from the shifter section 16 to the sort transporting section 18. As indicated in FIG. 6, the print P₀ is stacked on the belt sorter 142 to yield a bundle V of accumulated prints.

In the first embodiment, the single line rearrangement is also done when transporting panorama prints. As compared with the transporting methods of the prints P₁ and P₂, the transporting method for panorama prints is different in that when a panorama print is moved in the direction E as it is transported by the shift roller pair 130, nipping (sandwiching) by the transport roller pair 128 and the feeding roller 120 is released. The transporting method of the panorama prints is otherwise similar to those for prints P₁ and P₂, so the detailed explanations thereof are omitted.

In the first embodiment, out of the prints P₁ and P₂ transported in two lines, the print P₂ is moved along the array direction thereof to achieve rearrangement into a single line. In this case, the print P₁ is transported via the second transport path “β”, whereas the print P₂ is transported via the first transport path “α”. The shift roller pair 130 is provided in the first transport path “α”, so the print P₂ is moved to the side of the print P₁ by the shift roller pair 130 as it is transported. As a result, the 2-line transportation is changed into a 1-line transportation.

The panorama prints can also be arranged into a single line similarly to the prints P₁ and P₂.

Also, in the first embodiment, elongation of the transport path is prevented by arrangement of the first transport path “α” and the second transport path “β” that divide in a vertical direction to the transporting direction D. Further, a compact design of the entire shifter section 16 is achieved by dividing those two paths in the vertical direction perpendicular to the transporting direction D and the print array direction.

Also, the prints can be discharged by using the same discharge roller pair 126 irrespective of widths and lengths of the prints. As a result, different discharge ports need not be provided for prints of different sizes, which were provided in conventional apparatus, so that the structure can be made simpler.

Further, in the first embodiment, since the print P₂ is merely moved to the side of the print P₁, namely, along the array direction of the prints P₁ and P₃, the displacement of the movable frame 186 of the shifter unit 180 can be minimized. Thus, vibrations of the shifter unit 180 caused by moving the movable frame 186 can be decreased.

The first embodiment has been described using an example of the shifter section 16 by which the prints P₁ to P₄ transported in the two lines are arranged into a single line. However, the present invention is not limited only to this example, but may be applied to three or more lines. For instance, when a 3-line transportation is changed into a 1-line transportation, the general arrangement of the apparatus may be made such that a third transport path may be provided at a position symmetrical to the first transport path “α” with respect to the second transport path “β”.

Various rollers used in the first embodiment such as a transport roller, for instance, may be rubber rollers.

Roll paper and cut sheets S as used in the first embodiment may be such paper that is utilized, for example, in an electrophotographic printer.

Next, description will be made of a print forming method executed by the image recording apparatus 10 according to the first embodiment of the present invention.

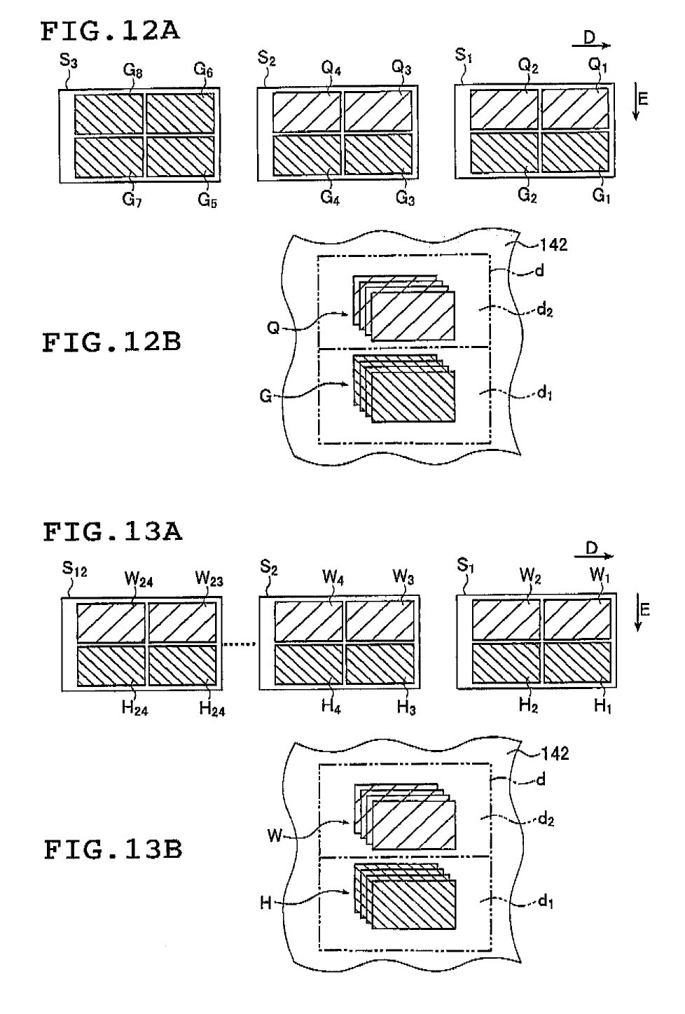

FIG. 12A is a schematic diagram showing a first image recording mode using the image recording apparatus 10 according to the first embodiment. FIG. 12B is a schematic diagram representing a bundle of accumulated prints, i.e., a print stack, obtained by the first image recording mode shown in FIG. 12A.

In the first embodiment, an example will be explained as a typical example wherein a print processing of allocating 4 images to a cut sheet is carried out, allowing prints to be accumulated in the sort area “d” of the sort transporting section 18.

According to the image recording apparatus 10 of the first embodiment, in such a case where 8 images “G₁” to “G₈” are initially meant to be allocated to cut sheets S in the normal print processing, and that another 4 pieces of urgent data are inputted, 12 images in total as indicated in FIG. 12A are stored in the image data temporary storage unit 42d, and are allocated to 3 cut sheets S₁ to S₃ by the image allocating unit 42e. In this case, the allocating operations of images “Q₁” to “Q₄” performed by the image allocating unit 42e are adjusted by the entire control unit 42b in such a manner that each of the images Q₁ to Q₄ based upon the urgent data, and each of the images G₁ to G₄ for the normal print process operation are arrayed side by side on 2 cut sheets S₁ and S₂ in the direction E of the cut sheets S₁ and S₂, and the images Q₁ to Q₄ based upon the urgent data are located on the side of the first separate roller 170a, As to the third cut sheet S₃, 4 images G₅ to G₈ of the normal print processing operation are allocated by the image allocating unit 42e. Further, the entire control unit 42b outputs such control information to the shift unit 16 that the cut sheets S₁ and S₂ pass through the second transport path “β”, and the third cut sheet S₃ be arranged into a single line.

As represented in FIG. 12A, in such a case where 12 images in total containing the urgent data are allocated, 2 cut sheets S₁ and S₂, after being cut into prints, are allowed to pass through the second transport path “β” without being arranged into a single line before being transported to the sort transporting section 18. The third cut sheet S₃ is cut into prints, and the prints of the images G₆ and G₇ are transported via the first transport path “α”, where those prints are arranged into a single line in the sequence of G₅ to G₈, and the arranged prints before being further transported to the sort transporting section 18.

Thus, as shown in FIG. 12B, a bundle “G” of accumulated prints in which the prints of the images G₁ to G₈ have been stacked is formed in the accumulation area “d₁”, whereas another accumulated print bundle “Q” in which the prints of the images Q₁ to Q₄ of the urgent data have been stacked is formed in the accumulation area “d₂”. Thus, the prints obtained by the normal print processing operation and the urgent prints obtained by the urgent print processing operation can be separately accumulated on the belt 142. Accordingly, the prints can be quickly obtained without erroneously handling normal prints and urgent prints. Further, in this case, since the normal prints and the urgent prints can be processed in a parallel manner, lowering of productivity can be prevented.

Next, description will be made of an allocating operation in the first embodiment whereby images for 2 orders are allocated. In this case, prints of 24 images are produced for each of two orders.

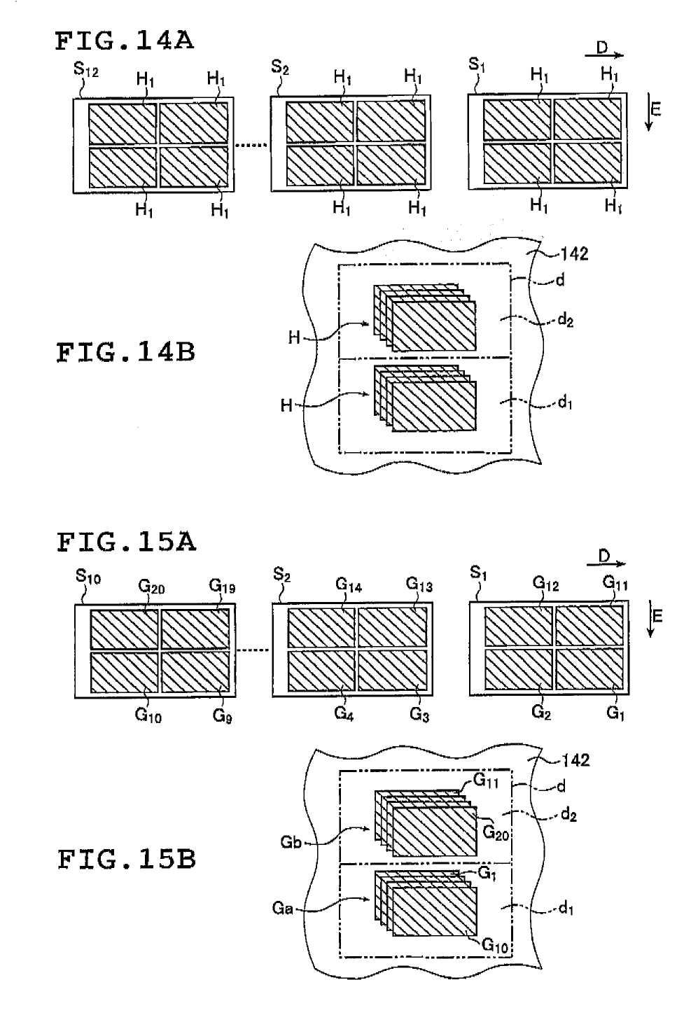

FIG. 13A is a schematic diagram showing a second image recording mode using the image recording apparatus 10 according to the first embodiment. FIG. 13B is a schematic diagram representing a bundle of accumulated prints obtained by the second image recording mode shown in FIG. 13A.

First, 48 images in total of 2 orders are stored in the image data temporary storage unit 42d. Then, as shown in FIG. 13A, the image allocating unit 42e allocates those 48 images in such a manner that each of images “H₁” to “H₂₄” of the first order and each of images “W₁” to “W₂₄” of the second order are arrayed side by side in the direction E of the cut sheets S₁ to S₁₂. At this time, the entire control unit 42b outputs control information to the shifter section 16 that 12 sheets of the cut sheets S₁ to S₁₂ be allowed to pass through the second transport path “β”, and that they not be rearranged into a single line.

Subsequently, the cut sheets S₁ to S₁₂ are cut into prints of the images H₁ to H₂₄ of the first order (hereinafter referred to as “prints of first order”) and images W₁ to W₂₄ of the second order (hereinafter referred to as “prints of second orders”).

Next, both prints of the first order and the prints of the second order are allowed to pass through the second transport path “β” and transported to the sort transporting section 18 without being arranged into a single line.

Thus, as indicated in FIG. 13B, a bundle H of accumulated prints in which the prints of the first order have been stacked is accumulated in the accumulation area “d₁”, whereas a bundle W of accumulated prints in which the prints of the second order have been stacked is accumulated in the accumulation area “d₂”. Thus, with the image data for the 2 orders supplied from the entire control unit 42b being stored in the image data temporary storage unit 42d, the entire control unit 42d adjusts the image allocation executed by the image allocating unit 42d such that the prints are separately accumulated without having to be arranged into a single line and thus, the first order and the prints of the second order can be obtained. Also in this case, since the accumulation area can be defined for each order, mistaking prints for one another can be prevented.

Also, as explained later, even when the shifter unit 180 of the arranging section 16 has malfunction, the image allocation is adjusted so as to accumulate prints in the accumulation areas in different lines according to orders, so that the prints can be properly accumulated.

Next, description will be made of image allocation in the first embodiment whereby more than one sheet of prints is produced of the same image H₁. In this case, 48 sheets of prints of the same image H₁ are produced.

FIG. 14A is a schematic diagram showing a third image recording mode using the image recording apparatus 10 according to the first embodiment. FIG. 14B is a schematic diagram representing a bundle of accumulated prints obtained by the third image recording mode shown in FIG. 14A.

As indicated in FIG. 14A, first, 48 images of the image H₁ are allocated by the image allocating unit 42e to 12 cut sheets S₁ to S₁₂, 4 images per sheet. At this time, the entire control unit 42b outputs control information to the shifter section 16 that 12 cut sheets S₁ to S₁₂ be allowed to pass through the second transport path “β”, and not be rearranged into a single line.

Subsequently, the cut sheets S₁ to S₁₂ are cut into prints of the image H₁. After that, the prints are allowed to pass through the second transport path “β”, and then transported to the sort transporting section 18 without being rearranged into a single line.

Thus, as indicated in FIG. 14B, bundles “H” of accumulated prints in which the prints of the same image H₁ have been stacked are yielded in both the accumulation area “d₁” and the accumulation area “d₂”. Thus, a large amount of prints of the same image H₁ can be separately accumulated without being arranged into a single line, so that a large amount of such prints of the same image H₁ can be obtained.

It should be noted that when prints for one order are separately accumulated, prints are, for instance, divided into quantities each equal to or smaller than a total number in which prints may be accumulated on the belt 142 of the sort transporting section 18.

In the first embodiment, since the control unit 42 knows the states of the respective devices, in such a case where the shifter unit 180 (refer to FIG. 5) of the shifter section 16 has a malfunction state, the shifter unit 180 outputs a failure signal to the discharge control unit 42c in response to a command signal issued from the discharge control unit 42c. Then, the discharge control unit 42c outputs failure information to the entire control unit 42b. In this case, the entire control unit 42b adjusts the image allocation by the image allocating unit 42e such that prints may be accumulated in the sort transporting section 18 without employing the shifter section 16.

FIG. 15A is a schematic diagram showing a fourth image recording mode using the image recording apparatus 10 according to the first embodiment. FIG. 15B is a schematic diagram representing a bundle of accumulated prints obtained by the fourth image recording mode shown in FIG. 15B.

When the shifter unit 180 has a malfunction, for example, in the case where prints of 20 images G₁ to G₂₀ are to be produced, as indicated in FIG. 15A, the entire control unit 42b controls the image allocating unit 42e in such a manner that each of images G₁ to G₁₀ and each of images G₁₁ to G₂₀ are arranged side by side in the direction E of the cut sheets S₁ to S₁₀, allocating 4 images per sheet.

In this case, images are arranged in a sequence of G₁ to G₁₀ in one line, and G₁₁ to G₂₀ in the other line.

The entire control unit 42b outputs control information to the shifter section 16 that 10 cut sheets S₁₀ to S₁₀ pass through the second transport path “β”, and not be rearranged into a single line.

The cut sheets S₁ to S₁₂ are cut into prints, and thereafter, those prints are allowed to pass through the second transport path “β” and transported to the sort transporting section 18 without being rearranged into a single line.

As a result, as represented in FIG. 15B, a bundle Ga of accumulated prints in which the prints of the images G₁ to G₁₀ have been stacked is yielded in the accumulation area “d₁”. Also, a bundle Gb of accumulated prints in which the prints of the images G₁ to G₂₀ have been stacked is yielded in the accumulation area “d₂”.

Thus, in the case where the discharge control unit 42c acquires information on abnormal state of the shifter section 16 (shifter unit 180), the entire control unit 42b adjusts the image allocation by the image allocating unit 42e to ensure that prints for the same order are divided and that the prints are arranged in a sequence of G₁ to G₂₀ and discharged to the sort transporting section 18 in two lines, whereby the prints are accumulated in different accumulation areas to obtain bundles Ga and Gb of accumulated prints. By placing the accumulated print bundle Ga on the accumulated print bundle Gb, a print bundle is obtained comprising prints of images G1 to G₂₀ in this sequence. Thus, prints of images stacked in a sequence of G₁ to G₂₀ can be readily obtained by placing the accumulated print bundle Ga on the accumulated print bundle Gb. In this case, since the entire system of the image recording apparatus 10 is not stopped, lowering of productivity can be prevented.

It should be noted that when prints for the same order are separately accumulated, for instance, those prints are divided in such quantities each equal to or smaller than a total number in which the prints may be accumulated on the belt 142 of the sort transporting section 18.

Further, in the case where the discharge control unit 42c acquires accumulation information that a total number of print orders which may be accumulated on the sort transporting section 18 is small, and a total number of prints to be produced for the following one order is larger than a total number of prints which can be accumulated in one accumulation area, prints for the same order is divided, and then, the prints are accumulated in different accumulation areas of the sort transporting section 16 in two lines to obtain bundles of accumulated prints. In this case, based upon the accumulation information of the sort transporting section 18 acquired by the discharge control unit 42c, the entire control unit 42b adjusts the image allocation by the image allocating unit 42e in such a manner that images are allocated in the sequence of the image data for one order, while the discharge control unit 42c controls the operation of the shifter section 16.

Also, in the case of an abnormality such as malfunction in the image recording section, the cutting section, the shifter section, and the sort transporting section, the states of which are managed by the control unit 42, the entire control unit 42b adjusts the image allocation by the image allocating unit 42e according to the states of the those devices with an abnormality in order to optimize the image allocation. Thus, printing can be achieved even with only those devices of the image recording apparatus that are in usable states.

As described above, the image recording apparatus of the present invention can be properly operated even for such orders as urgent prints with different appointed delivery dates from the others without lowering the productivity. In addition, even in case of failure in some device of the apparatus, the image recording apparatus can be properly operated.

The essential structure and configuration of the image recording apparatus 10 according to the first mode of the present invention has been described above.

Referring now to FIGS. 3, 4, 6, and 16 to 36, a description is made of an image recording apparatus according to the second aspect of the present invention.

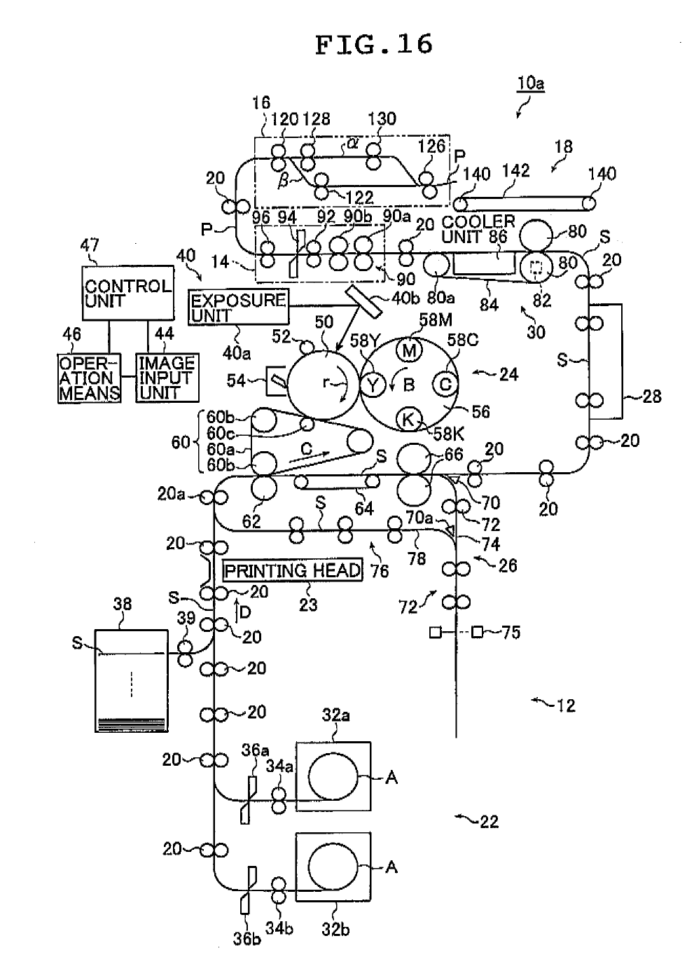

FIG. 16 is a schematic diagram for indicating one embodiment (hereinafter referred to as “second embodiment”) of the image recording apparatus according to the second aspect of the present invention.

It should be noted that because an image recording apparatus 10a of the second embodiment shown in FIG. 16 has a similar arrangement to the above-mentioned image recording apparatus 10 of the first embodiment shown in FIG. 1 except for the following different technical points, the same reference numerals of the image recording apparatus 10 will be employed as those for denoting the same structural elements, and detailed descriptions thereof are omitted. Therefore, different points will be mainly explained. That is, instead of the control unit 42, a control unit 47 is employed, and accordingly, control operations as to the shifter section 16 and the sort transporting section 18 are different, and as a result, functions and operations thereof are different from those of the image recording apparatus 10 of the first embodiment.

As indicated in FIG. 16, the image recording apparatus 10a of the second embodiment comprises an image recording section 12, a cutting section 14, a shifter section 16 which functions as an accumulation position selecting section, a sort transporting section 18, and transporting means including transporting rollers 20, and the like.

It should be noted that the respective structural elements of the image recording section 12, the cutting section 14, the shifter section 16, and the sort transporting section 18 are connected to each other by the transporting means including the transporting roller 20, and the like.

The image recording section 12 of the second embodiment comprises a supplying subsection 22, a back printing subsection 23, an image forming subsection 24, a reverse transporting subsection 26, a position adjusting subsection 28, a surface gloss processing subsection 30, an exposure subsection 40, a control unit 47, and transporting means (including transporting rollers 20, and registration rollers 20a).

Also, in the image recording section 12, both an image input unit 44 and operation means 46 are connected to the control unit 47.

The image recording section 12 of the second embodiment has similar arrangements and similar functions to those of the above-mentioned image recording section 12 of the first embodiment except for the points to be mentioned below. As a result, explanations thereof except for the control unit 47 are omitted. That is, the image recording section 12 of the second embodiment includes the control unit 47 instead of the control unit 42 as described above. As a result, an exposure unit 40a of the exposure subsection 40 radiates an outgoing beam (i.e., optical beam) modulated in response to printing image data entered by the control unit 47 (to be specific, image allocating unit 47e thereof). Also, a tension roller 60b which moves an intermediate transfer belt 6a of an intermediate transferring unit 60 of the image firming subsection 24 is controlled by the control unit 47 in such a manner that toner images having respective colors YMCK which are sequentially transferred to the intermediate transfer belt 60a are correctly overlapped with each other.

It should be noted that similarly to the control unit 42 of the image recording section 12 of the first embodiment, the control unit 47 stores therein image data (i.e., order data) as to ordered images to be printed out, and manages a process sequence of the order data, namely, a printing process sequence to be executed in the image recording apparatus 10a. Also, the control unit 48 controls operations of respective devices provided in the image recording apparatus 10a, and also, manages state of the respective devices.

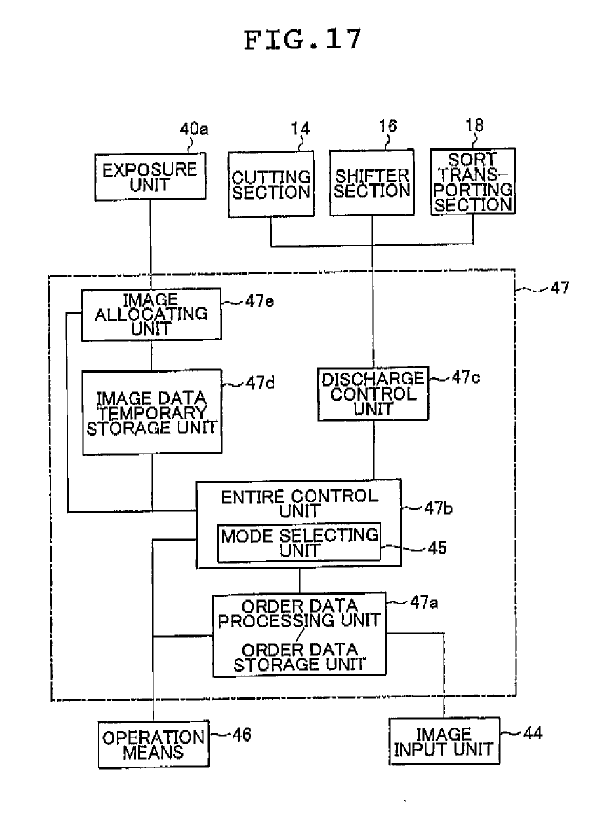

FIG. 17 is a block diagram for schematically indicating one example of the control unit of the image recording apparatus of the second embodiment.

The control unit 47 shown in the figure includes an order data processing unit/order data storage unit 47a, an entire control unit 47b, a discharge control unit 47c, an image data temporary storage unit 47d, and the image allocating unit 47e. The order data processing unit/order data storage unit 47a is connected to an image input unit 44. Also, the order data processing unit/order data storage unit 47a and the entire control unit 47b are connected to the operation means 46.

The entire control unit 47 comprises a mode selecting unit 45, and controls the order data processing unit/order data storage unit 47a, the discharge control unit 47c, the image data temporary storage unit 47d, the image allocating unit 47e, and the mode selecting unit 45. Also, the entire control unit 47b controls operations of respective devices in the image recording apparatus 10a other than the order data processing unit/order data storage unit 47a, the discharge control unit 47c, the image data temporary storage unit 47d, and the image allocating unit 47e, and also manages state of those other devices.

Similarly to the order data processing unit/order data storage unit 47a of the first embodiment shown in FIG. 2, the order data processing unit/order data storage unit 47a stores therein order data, and manages a processing sequence of order data, namely, a print processing sequence executed in the image recording apparatus 10a.

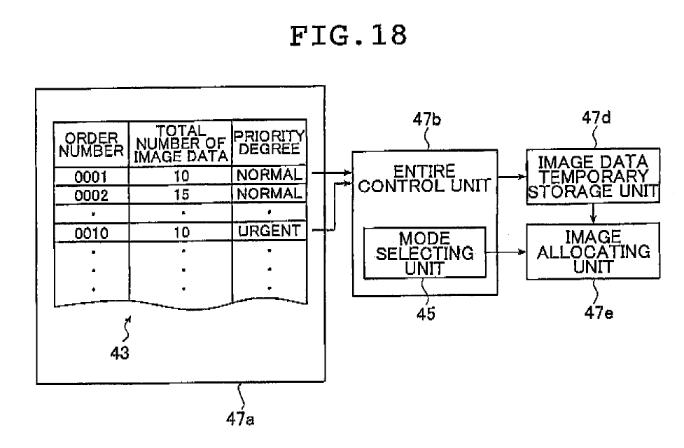

Also, the order data processing unit/order data storage unit 47a contains, as shown in FIG. 18, an order table 43. This order table 43 has previously stored therein the respective order data to which order numbers have been applied in an input sequence. The order data contain at least image data and information related to the total number of image data and priorities.

The order data processing unit/order data storage unit 47a is controlled by the entire control unit 47b in such a manner that order data is outputted to the entire control unit 47b for every order. Also, the order data processing unit/order data storage unit 47a is controlled by the entire control unit 47b in such a manner that if order data have normal priorities, then the stored order data are sequentially outputted to the entire control unit 47b in the order number sequence (i.e., input sequence). On the other hand, in such a case that an order (an order number “0010”) of an urgent print processing operation having a higher priority than that of the normal order is present among the plural orders stored in the order table 43, the order data processing unit/order data storage unit 47a is controlled by the entire control unit 47b in such a manner that a print forming sequence is moved up so as to output the order number 0010 following another order number 0001 to the entire control unit 47b.

The discharge control unit 47c controls operations of at least the cutting section 14 and the shifter section 16 functioning as the accumulation position selecting section, and further, controls operations of the sort transporting section 18 similarly to the discharge control unit 42c shown in FIG. 2. Similarly to the discharge control unit 42c, the discharge control unit 47c acquires respective state information as to the cutting section 14, the shifter section 16, and the sort transporting section 18, and manages the state as to the cutting section 14, the shifter section 16, and the sort transporting section 18.

Similarly to the entire control unit 42b shown in FIG. 2, the entire control unit 47b acquires state information as to the respective devices in the image recording apparatus 10a other than the cutting section 14, the shift section 16, and the sort transporting section 18.

Similarly to the image data temporary storage unit 42d shown in FIG. 2, the image data temporary storage unit 47d temporarily stores therein order data which is outputted from the order data processing unit/order data storage unit 47a to the entire control unit 47b. As indicated in FIG. 18, in such a case that an order whose priority is urgent (the order number 0010) is present among the plural orders stored in the order table 43, the print forming sequence thereof is moved up so as to output the order whose priority is urgent following the order whose priority is normal (the order number 0001). Then, the urgent order is stored immediately after the normal order in the image data temporary storage unit 47d. The order data are outputted from the image data temporary storage unit 47d to the image allocating unit 47e.

The image allocating unit 47e allocates images to be recorded on 1 cut sheet S in correspondence with dimensions of the images to be recorded, and priorities of the prints based upon the order data (i.e., image data) inputted from the image input unit 44, and forms printing image data which is to be outputted to the exposure unit 40a. As a result, it is possible to record images while the images being allocated to 1 cut sheet S based upon the image data. It should be noted that in the image allocating unit 42e shown in FIG. 2, a similar image allocating operation is carried out. However, there is such a difference that the image allocating unit 42e allocates images in correspondence with the dimensions of the images to be recorded, the state of the devices, and the appointed delivery dates of the prints.

As previously explained, the entire control unit 47b controls image allocating operation performed by the image allocating unit 47e, forms control information, and then outputs the formed control information via the discharge control unit 47c to the shifter section 16. The above-mentioned control information contains information as to a selection of a transport path of prints P acquired based upon the image allocating operation by the image allocating unit 47e, or information as to whether or not an operation of the shifter section 16 is performed. The entire control unit 47b controls the image allocating operations performed by the image allocating unit 47e and operation of the shifter section 16 by the discharge control unit 47c.

Similarly to the above-mentioned first embodiment, as allocation modes of images to the cut sheets S by the image recording section 12 in the second embodiment, for example, as represented in FIG. 3A, such a four-image allocation in which 4 image recording regions “R₁” to “R₄” are formed on 1 cut sheet S may be realized. Also, as represented in FIG. 3B, a one-image cut sheet S may be realized.

It should be noted that an allocation of images in the second embodiment is not limited only to the above-mentioned image allocations, but may be preferably determined in a proper manner based upon an appointed delivery dates of an order (or priorities), and the like in such a manner that waste part of a cut sheet S becomes minimum by the control unit 47 (to be specific, entire control unit 47b thereof).

As previously explained, similarly to the image allocating unit 42e shown in FIG. 2, the image allocating unit 47e normally allocates the images of the order data (i.e., image data) with which prints should be formed, namely, print processing operation should be carried out, to the cut sheets S for every order.

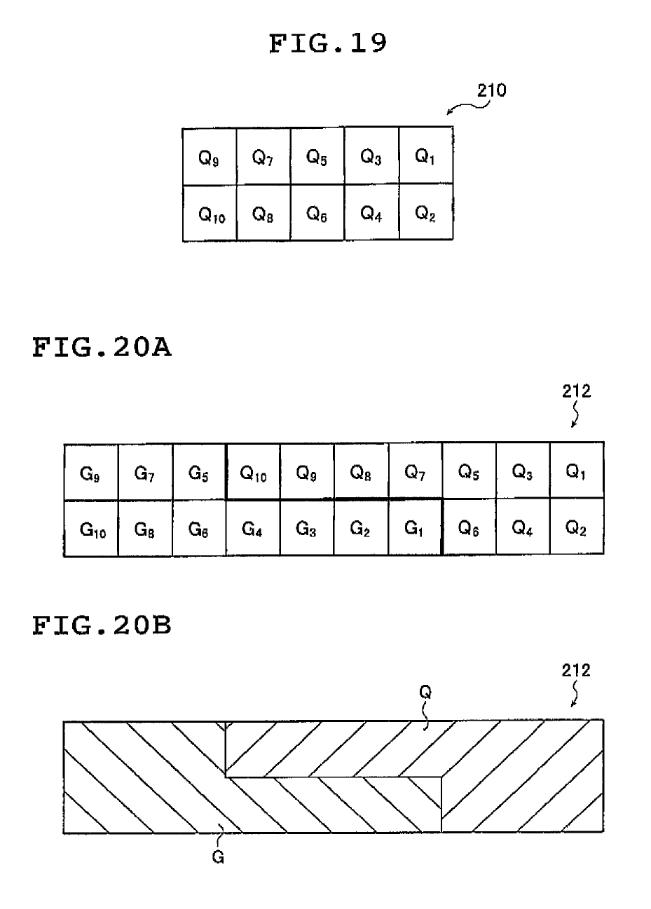

As indicated in FIG. 19, in the case where the image allocating unit 47e allocates image data Q₁ to Q₁₀ to the cut sheet S in two lines, the image allocating unit 47e produces printing image data 210 which is outputted to the exposure unit 40a in such an allocation sequence that the odd-numbered images are allocated to one line from the image Q₁, and the even-numbered images are allocated to the other line from the image Q₂.

However, in such a case that as the order data, for example, image data (i.e., urgent data) whose priority is urgent, namely, whose prints are formed at a top priority by the operation means 46, for instance, the order data (refer to FIG. 18) of the order number 0010, is inputted from the image input unit 44, the print processing sequence of the urgent data is moved up by the entire control unit 47b, whereby the urgent data is inserted behind the order data (i.e., image data) of the order number 0001. Further, the entire control unit 47b adjusts the image allocating operation by the image allocating unit 47e in such a manner that the urgent data can be processed to form prints therefrom at the earliest time.

The image allocating unit 47e of this embodiment has two sorts of image allocation modes, namely, a mode 1 (i.e., first mode) and a mode 2 (i.e., second mode).

As indicated in FIG. 20A, in the case where order data “G” of an urgent print processing operation (hereinafter referred to as “urgent processing operation”) in which a priority for forming prints of the images G₁ to G₁₀ is high interrupts order data “Q” of a print processing operation in which a priority for forming prints of the images Q₁ to Q₁₀ is normal (hereinafter referred to also as “normal processing operation”), the image “G₁” is inserted to a position of the image Q₈ in the printing image data 210 shown in FIG. 19 so as to produce printing image data 212.

As represented in FIG. 20B, the printing image data 212 is made by allocating images in such a manner that some images of the order data Q and the order data G are mixed in some cut sheets. In this embodiment, such an image allocation mode that is schematically represented in FIG. 20B will be referred to as the “mode 1” hereinafter. In the mode 1, such an operation that all of prints (hereinafter referred to as “normal prints”) of the order data Q of the normal process operation are outputted completes earlier than such an operation that all of prints (hereinafter referred to as “urgent prints”) of the order data G of the urgent processing operation are outputted.

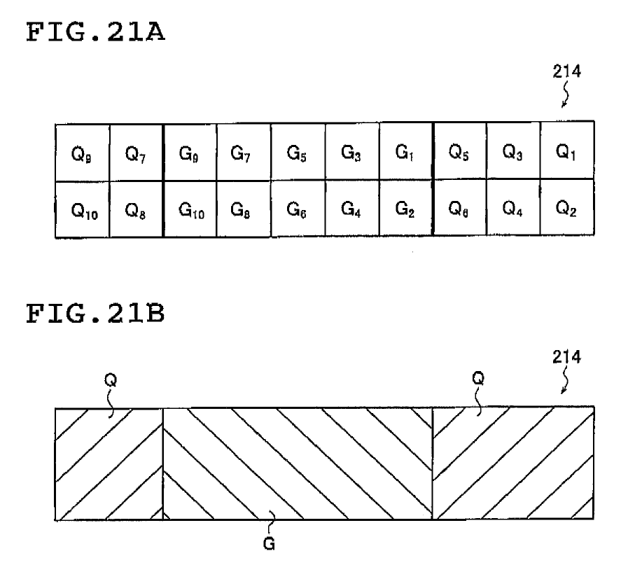

As indicated in FIG. 21A, in the case where the order data “G” of the urgent print processing operation for forming the prints of the images G₁ to G₁₀ interrupts the order data “Q” of the normal processing operation for forming the prints of the images Q₁ to Q₁₀, such a printing image data 214 is formed in which the images of the order data G has been inserted between the images Q₅ and Q₆ and the images Q₇ and Q₈ of the order data Q. As represented in FIG. 21B, the printing image data 214 is made by allocating images in such a manner that all images of the order data G are inserted between the images of the order data Q. In this embodiment, such an image allocation mode that is schematically represented in FIG. 21B will be referred to as the “mode 2” hereinafter. In the mode 2, before all of the normal prints of the order data Q are outputted, all of the urgent prints of the order data G are outputted.

It should be noted that in this embodiment, a selection for employing any one of the mode 1 and the mode 2 during the image allocation operation may be carried out by the mode selecting unit 45 of the entire control unit 47b. As the selection criterion for selecting the mode 1 or the mode 2, for example, a total number of images of the order data Q, or a processing capability of a printer may be employed. A detailed content of this mode selection will be explained later. Alternatively, the selection for the mode 1 and the mode 2 may be carried out by receiving an input made by an operator from the operation means 46.

As will be explained later, the urgent prints and the normal prints are transported to the sort transporting section 18 in a separate manner, and then, are accumulated in different accumulation areas in the sort transporting section 18. As a result, a control operation is adjusted by the discharge control unit 47c in correspondence with allocation data of images.

It should be noted that when the operation means 46 is operated by an operator, the control unit 47 causes the image recording apparatus 10a to set or display various sorts of information in response to the content of this operation. Alternatively, the control unit 47 may control the scanner (not shown) and the media drive of the image input unit 44.

Next, a description is made of the cutting section 14 of the second embodiment.

Similarly to the cutting section 14 of the first embodiment shown in FIG. 1, the cutting section 14 of the second embodiment shown in FIG. 16 cuts margins of the peripheries of the recording regions R₁ to R₄ and R₀ on which the images have been recorded by the image recording section 12, thereby forming respective prints P₁ to P₄ and P₀ (refer to FIGS. 3A and 3B).

As indicated in FIG. 16, this cutting section 14 includes the first cutter 90, the second cutter 94, a scrap collection container (not shown), the first transport roller pairs 92, 96, and a movable guide (not shown).

The second cutter 94, the first transport roller pairs 92, 96, and the movable guide are connected to the control unit 47, and thus, respective operations thereof are controlled by this control unit 47.

Next, a description is made of the shifter section 16 of the second embodiment.

The shifter section 16 of the second embodiment shown in FIG. 16 has a similar structure of the shifter section 16 of the first embodiment shown in FIG. 1. However, the shifter section 16 of the second embodiment has a slightly different function. That is, this shifter section 16 of the second embodiment functions as an accumulation position selecting unit which accumulates a plurality of prints P to a plurality of different accumulation areas of the sort transporting section 18 with respect to each of orders. The shifter section 16 of the second embodiment, for example, arranges prints having a first width which have been cut by the cutting section 14 and transported in two lines into a single line, or moves the prints P having the first width which have been cut by the cutting section 14 and transported in two lines to the other line. Further, the shifter section 16 of the second embodiment transports such a print having a second width larger than the first width without such the arrangement operations. Also, the shifter section 16 of the second embodiment may rearrange prints having such a dimension generally called as a “panorama size” (of 89 mm×254 mm) in a similar manner to that of the print having the first width. The “panorama print” has the width equal to the first width, and the length in the transporting direction of approximately twice as long as that of the print having the first width. The shifter section 16 of the second embodiment arranges prints having the panorama size into a single line, or moves the prints P having the panorama size which have been transported in two lines to the other line.

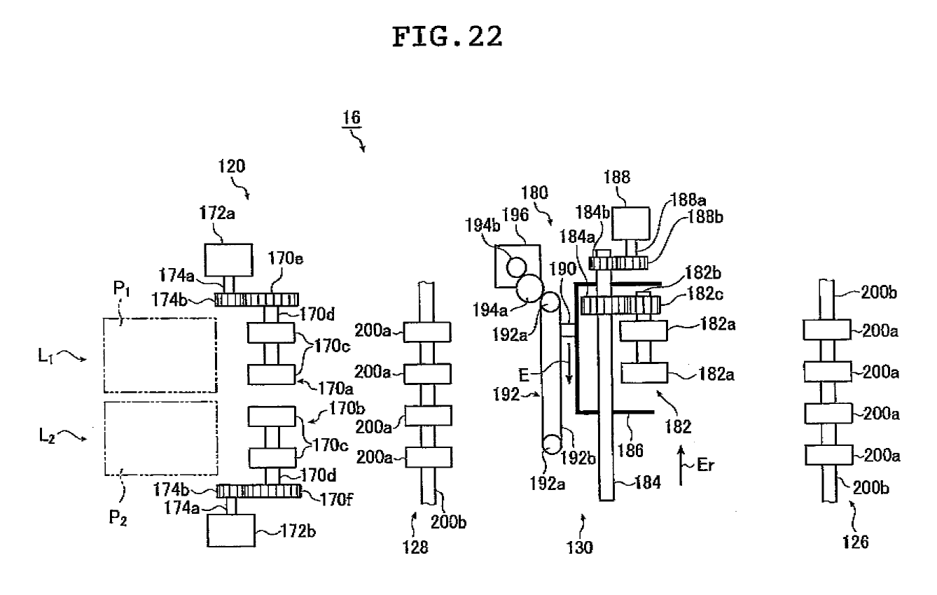

Similarly to the shifter section 16 of the first embodiment, as indicated in FIG. 41 the shifter section 16 of the second embodiment also comprises the feeding roller pair 120, the transport roller pairs 122 and 128, the discharge roller pair 126, the shift roller pair 130, the first movable guide 150, the second removable guide 152, the sensors 160, 162, and 166, and the shifter unit 180 (refer to FIG. 22). The shifter unit 180 moves the shift roller pair 130 in either the direction E or a direction Er. A transport path having a substantially rhomboid shape (i.e., parallelogram) is formed by the feeding roller pair 120, the transport roller pairs 122 and 128, the discharge roller pair 126, and the shift roller pair 130.

In the shifter section 16 of the first embodiment, as shown in FIG. 5, the shifter unit 180 moves the shift roller pair 130 in the direction E. In contrast, the shifter section 16 of the second embodiment has a similar structure to that of the first embodiment except for the following point. That is, as shown in FIG. 22, in this shifter section 16, the shifter unit 180 moves the shift roller pair 130 in either the direction E or the direction Er. Accordingly, detailed explanations of the structure are omitted, and a different point will be described below.

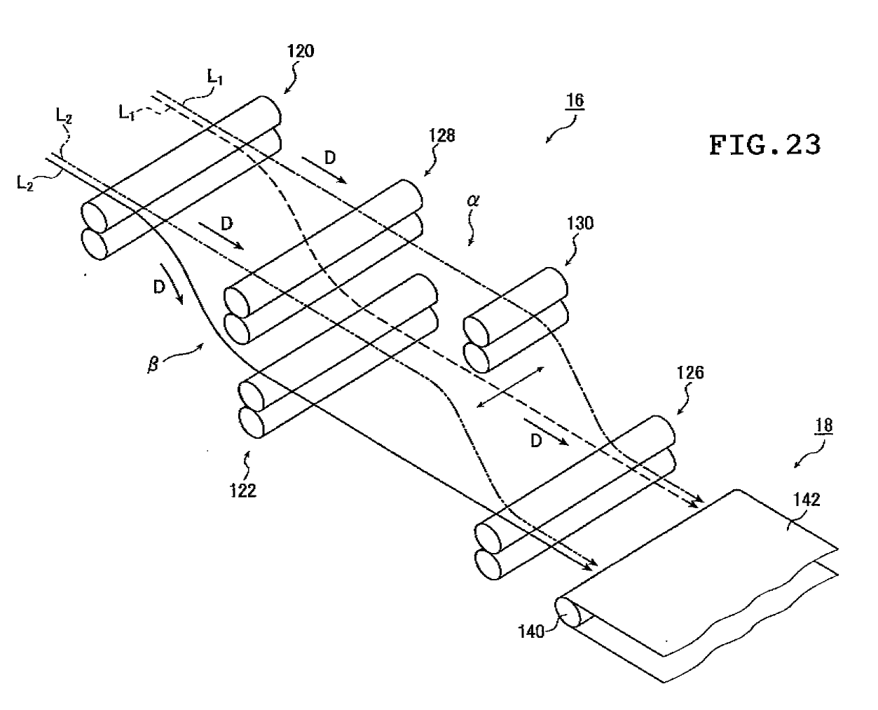

As previously explained, as shown in FIGS. 4 and 23, the transport path is branched into the first transport path “α” and the second transport path “β”, in which the second transport path “β” extends in a direction that is perpendicular to the array direction of the prints P and the transporting direction D (namely, vertical direction) Then, the both transport paths are merged with each other at the discharge roller pair 126.

As shown in FIG. 23, the first transport path “α” and the second transport path “β” have two lanes made of a first lane “L₁” and a second lane “L₂”, respectively.

As previously explained, in the first embodiment, the transport roller pair 128 has the function of moving the prints P transported from the feeding roller pair 120 to the shift roller pair 130 which is moved in the direction E by the shifter unit 180. In the second embodiment, the transport roller pair 128 has a function of moving the prints P transported from the feeding roller pair 120 to the shift roller pair 130 which is moved in either the direction E or the direction Er by the shifter unit 180.

In the second embodiment, in the shift roller pair 130, the prints P can be transported in the transporting direction D by the transport roller 182, and further, the prints P can be moved by the shifter unit 180 in the direction E, or the direction Er that is opposite to the direction E.

The operation of moving the shift roller pair 130 in either the direction E or the direction Er is controlled by the entire control unit 47b via the discharge control unit 47c, while the image allocating unit 47e refers to the printing image data.

Next, a description is made of the sort transporting section 18 of the second embodiment.

The sort transporting section 18 of the second embodiment shown in FIG. 16 has a similar structure to that of the sort transporting section 18 of the first embodiment indicated in FIG. 1. That is, the sort transporting section 18 of the second embodiment has at least two accumulation areas, that is, two accumulation areas in the example shown in FIG. 6, into each of which the prints P obtained from the cutting section 14 are accumulated for every order. Accordingly, detailed explanations thereof are omitted, but the sort transporting section 18 accumulates prints F which are arranged into a single line and transported by the shifter section 16 for every order. The sort transporting section is includes one pair of idle pulleys 140, and a belt 142 which is stretched around those idle pulleys 140. The sort transporting section 16 receives a print P transported from the discharge roller pair 126 and dropped onto the belt 142 and accumulates the received prints P. When the sort transporting section 18 judges that accumulation of the prints P for 1 order has completed based upon the control information and the like, the sort transporting section 18 moves the belt 142 only by a predetermined amount set in accordance with a dimension or the like of the accumulated prints, stops the transportation of the accumulated member of the prints P, and subsequently, accumulates prints P for a next order.

As indicated in FIG. 6, in the sort transporting section 18, in the case where the prints P are transported from the shifter section 16 in two lines for every order, the prints P are accumulated in two lines in the respective accumulation areas d₁, d₂, f₁, f₂, g₁, and g₂.

Also, while the sort transporting section 18 is connected to the discharge control unit 47c, the discharge control unit 47c manages that prints for how many orders have been mounted on the sort transporting section 18. For instance, in such a case that prints have been mounted on the sort areas “f” and “g” for 2 orders among the sort areas “d”, “f”, and “g” for 3 orders, namely, in the case where only the sort area “d” for 1 order is left, for example, the control unit 47 issues warnings. Also, for instance, in such a case that only the sort area “d” for 1 order is left, prints may be mounted on the accumulation areas d₁ and d₂ of the remaining sort area “d”.

Next, operations of the shifter section 16 of the second embodiment will be explained with reference to FIG. 22 and FIGS. 24 to 27D.

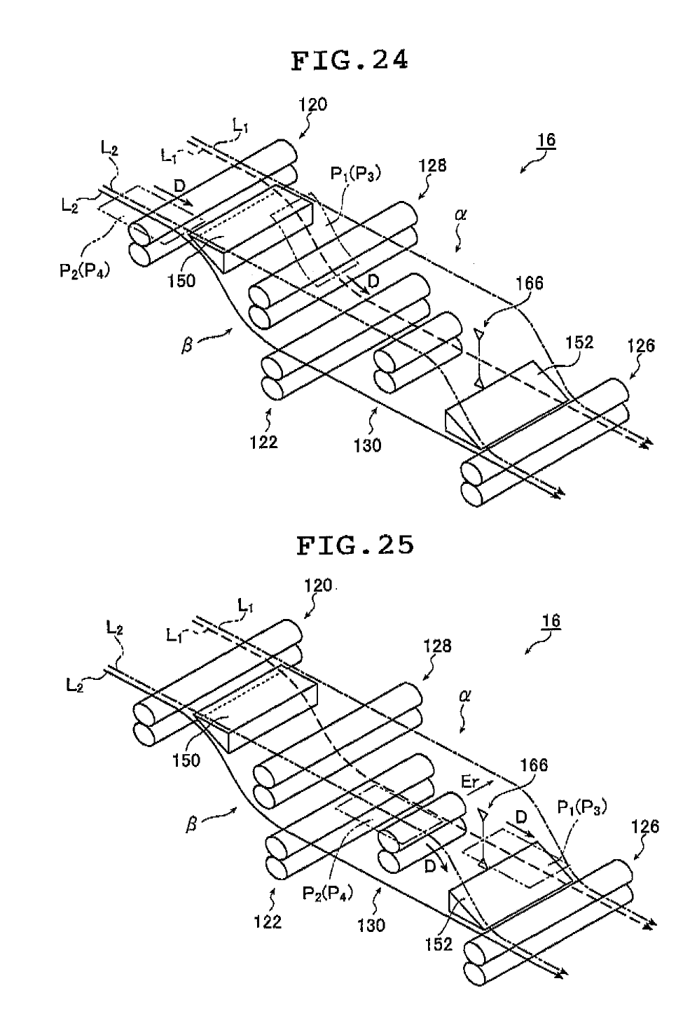

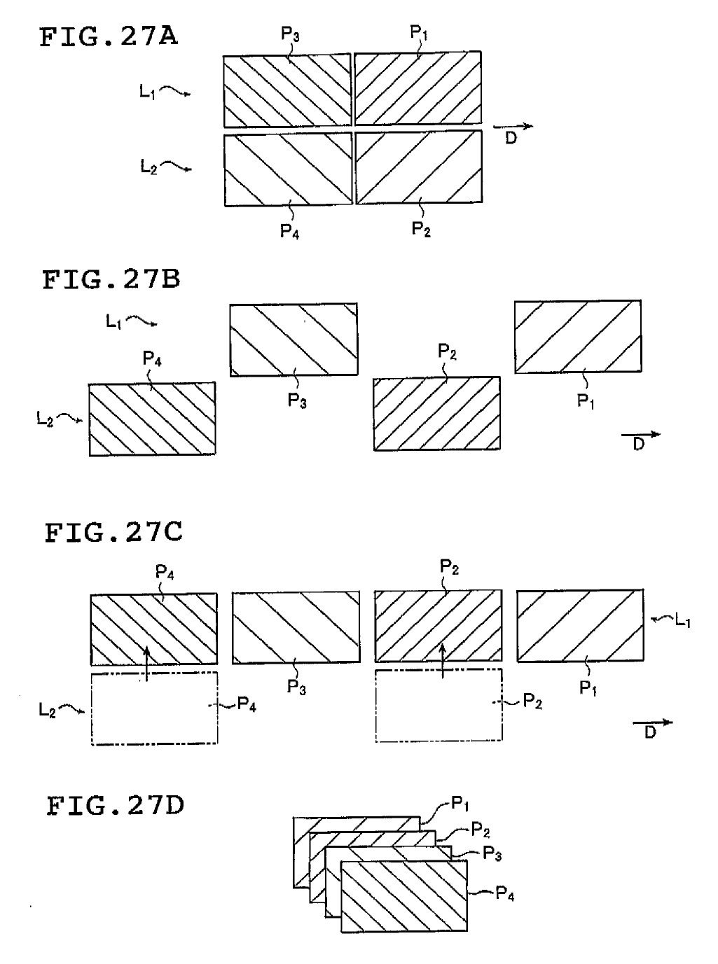

FIGS. 24 to 26 are plan views for schematically indicating one example of transporting steps of prints in step sequences by the image recording apparatus of the second embodiment. FIGS. 27A to 27D are schematic diagrams for showing transporting steps of prints in step sequences by the image recording apparatus of the second embodiment.

In this embodiment, as shown in FIG. 3A, as to the cut sheet S to which 4 images have been allocated, the cutting section 14 (refer to FIG. 16) cuts the cut sheet S to obtain 4 sheets of prints P₁ to P₄ (refer to FIG. 27A). A description is made of the following operations. That is, the 4 prints P₁ to P₄ are transported in two lines (namely, first lane L₁ and second lane L₂), and then 2 sheets of prints P₂ and P₄ which are transported through the second line L₂ are moved to the first lane L₁ so as to arrange the prints into a single line.

In this embodiment, as shown in FIG. 22, the prints P₁ and P₂ are arrayed side by side to be fed into the transport roller pair 120, and the print P₂ fad into the second separate roller 170b is moved to the side (i.e., first lane L₁ side) of the print P₁ fed into the first separate roller 170a so as to be arranged into a single line.

In the second embodiment, firsts as indicated in FIG. 22, the prints P₁ and P₂ arranged parallel to each other in two lines are transported. At this time, the respective prints P₁ and P₂ are transported at the same speed. The print P₁ is transported through the first lane L₁, and the print P₂ is transported through the second line L₂.

Next, in order that both the print P₁ and the print P₂ are transported in a staggered arrangement manner by changing transport positions thereof in the transporting direction D, in the feeding roller pair 120, either the rotation speed of the motor 172a is increased or the rotation of the motor 172b is stopped to adjust the transporting speeds by the first separate roller 170a and the second separate roller 170b.

Next, as indicated in FIG. 24, the print P₁ is guided to the second transport path “β” by the first movable guide 150.

Next, after a predetermined time has elapsed since the print P₁ was guided to the second transport path “β”, the print P₂ is transported to the transport roller pair 128 by being guided by the first movable guide 150.

Next, as indicated in FIG. 25, the print P₁ fed into the second transport path “β” is transported via the transport roller pair 122 to the discharge roller pair 126. At this time, when the print P₁ is detected by the sensor 166 which is provided between the transport roller pair 122 and the discharge roller pair 126, the second movable guide 152 is pivotally rotated upwardly by the control unit 47, thereby transporting the print P₁ to the transport roller pair 126.

On the other hand, the print P₂ is transported to the shift roller pair 130 by the transport roller pair 128.

Next, while the print P₂ is transported by the shift roller pair 130, the print P₂ is moved in the direction Er (i.e., on the side of print P₁).

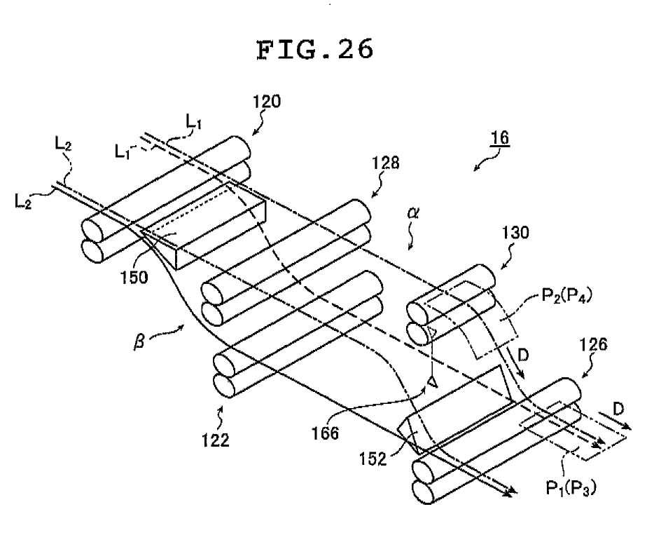

Then, as shown in FIG. 26, while being guided by the second movable guide 152, the print P₂ is transported to the discharge roller pair 126.

As a result, as shown in FIG. 26, the prints P₁ and P₂ are transported in one line in the first lane L₁, and then are transported to the sort transporting section 18 (refer to FIG; 16) by the discharge roller pair 126.

In such a case that the prints P₃ and P₄ are fed into the feeding roller pair 120 while being arranged side by side, as indicated in FIGS. 24 to 26, similarly to the prints P₁ and P₂, the print P₃ is transported to the second transport path “β”, the print P₄ is transported to the first transport path “α”, and the print P₄ is moved to the side on which the print P₃ is transported (i.e., first lane L₁ side) so as to be arranged at the back of the print P₃.

As explained above, as indicated in FIG. 27A, as to the prints P₁ to P₄ formed by allocating 4 images to one cut sheet S, as shown in FIG. 27B, the transporting speed of the prints P₁ and P₃ is increased so as to arrange the prints in a staggered arrangement. Subsequently, as indicated in FIG. 27C, the print P₂ is moved to the first lane L₁ side so as to be arranged at the back of the print P₁, and the print P₄ is moved to the first lane L₁ side so as to be arranged at the back of the print P₃, thereby arranging the prints P₁ to P₄ into a single line. Then, as represented in FIG. 27D, the prints P₁ to P₄ arranged into the single line on the side of the first lane L₁ are successively stacked from the print P₁ on the belt 142 (refer to FIG. 6) of the sort transporting section 18.

On the other hand, in this embodiment, the prints P₁ and P₃ may be alternatively moved to the second lane L₂ side so as to be transported in one line. In this case, the transporting speed of the print P₁ and P₃ is increased so that the prints are transported in the staggered arrangement. Subsequently, the print P₁ is moved to the side of the print P₂ (i.e., second lane L₂ side), and the print P₃ is moved to the side of the print P₄ (i.e., second lane L₂ side) so as to be arranged into one line in the second lane L₂.

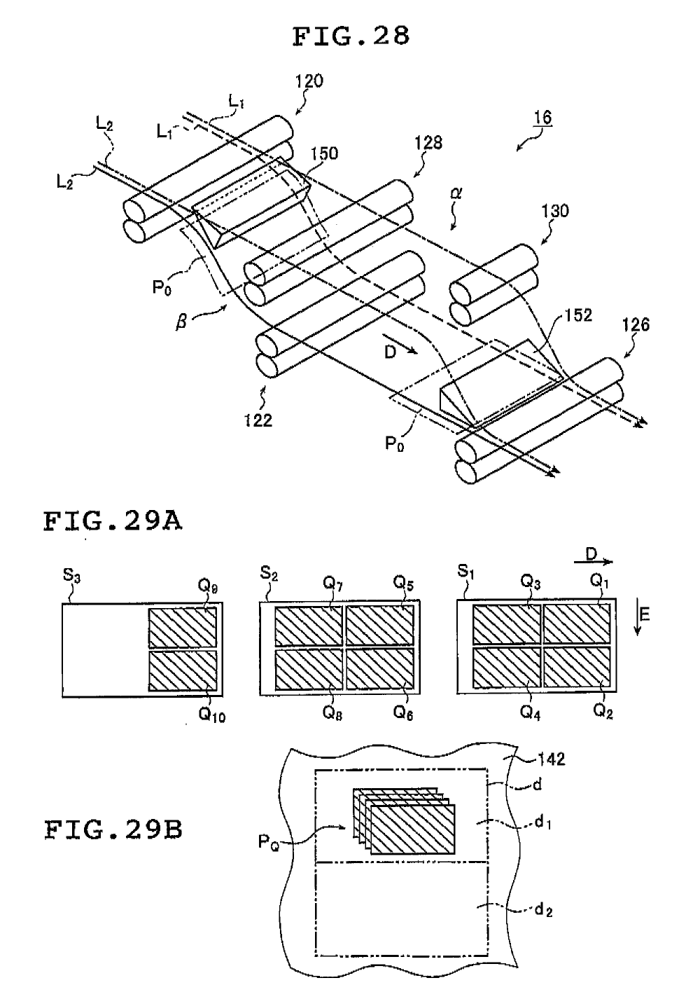

As shown in FIG. 28, in the shifter section 16 of the second embodiment, a print P₀ having a width obtained by allocating one image on one cut sheet need not be arranged into a single line, and thus, the print P₀ is transported through the second transport path “β” as it is in a single line to be discharged from the discharge roller pair 126.

It should be noted that the print P₀ is obtained by such a method that one image recording area R₀ is formed in one out sheet S as represented in FIG. 3B.

FIG. 28 is a plan view for schematically explaining a method for transporting a print having a large size by the image recording apparatus of the second embodiment of the present invention.

When the print P₀ is transported, the first movable guide 150 is pivotally rotated upwardly, thereby guiding the print P₀ to the second transport path “β”. The print P₀ is guided from the feeding roller pair 120 to the transport roller pair 122.

Next, the print P₀ transported by the transport roller pair 122 is guided by the second movable guide 152, and transported to the discharge roller pair 126 from the second transport path “β”.

As previously explained, the print P₀ is transported through the second transport path “β”, and then is transported from the shifter section 16 to the sort transporting section 18. As indicated in FIG. 6, the print P₀ is stacked on the belt sorter 142 to become a bundle V of accumulated prints.

Also, in this embodiment, among the prints P₁ and P₂ which are transported in the two lines, the print P₂ is moved along the array direction thereof so as to be arranged into the single line. In this case, the print P₁ is transported via the second transport path “β”, whereas the print P₂ is transported via the first transport path “α”. Since the shift roller pair 130 is provided in the first transport path “α”, the print P₂ is moved to the side (namely, direction Er) of the print P₁ (i.e., first lane L₁) by the shift roller pair 130 while being transported. As a result, the 2 lines of prints transported are arranged into one line on the side of the first lane L₁. As a result, the prints can be accumulated either in the first lane L₁ or the second lane L₂ for every order.

Moreover, even when the panorama prints are transported in the two lines, the panorama prints are arranged into a single line similarly to the prints P₁ and P₂.

Also, in the second embodiment, similarly to the first embodiment, the entire shifter section 16 can be made compact. As a result, the construction of the image recording apparatus can be made simpler. Further, similarly to the first embodiment, the structure of the shifter section 16 of the second embodiment is not limited only to the example shown in the drawing.

In addition, in this embodiment, since the print P of either the first lane L₁ or the second lane L₂ is merely moved to the other lane side (i.e., either the direction E side or the direction Er side), the movement of the movable frame 186 of the shifter unit 180 can be reduced. As a result, vibrations of the shifter unit 180 caused by moving the movable frame 186 can be decreased.

Next, a description is made of a print forming method executed by the image recording apparatus 10a according to the second embodiment of the present invention.

First, a description is made of print forming method of the normal process operation.

FIG. 29A is a schematic diagram representing an image recording mode by the normal print processing operation executed by the image recording apparatus according to the second embodiment. FIG. 29B is a schematic diagram representing a bundle of accumulated prints obtained by the normal print processing operation shown in FIG. 29A.

In this embodiment, the following method will be explained as a typical example. That is, 4 images are allocated to 1 cut sheet to form prints, and then, the formed prints are accumulated in the accumulation area “d₁” or the accumulation area “d₂” of the sort transporting section 18.

In this embodiment, such a case is exemplified that one sheet of print is formed for each of the images Q₁ to Q₁₀, namely, 10 sheets of prints are formed in total.

In the image recording apparatus 10a of the second embodiment, when 10 images “Q₁” to “Q₁₀” are allocated to a cut sheet S in the normal print processing operation, order data is outputted to the image data temporary storage unit 47d, and printing image data 210 (refer to FIG. 19) is formed by the image allocating unit 47e. Next, as indicated in FIG. 29A, the images Q₁ to Q₁₀ are allocated to the 3 cut sheets S₁ to S₃ based on the printing image data 210. In this case, the entire control unit 47b adjusts the allocating operations of the images Q₁ to Q₄ by the image allocating unit 47e in such a manner that the images Q₁ to Q₁₀ of the normal print processing operation are arrayed in the direction E of the respective cut sheets S₁ to S₃. It should be noted that as to the third cut sheet S3, since two images Q₉ and Q₁₀ of the normal print processing operation are allocated by the image allocating unit 47e, a margin is produced.

Moreover, in the entire control unit 47b, as to the cut sheets S₁ to S₃, control information for arranging prints into one line on the first lane L₁ side is created. The information is outputted as the control information to the discharge control unit 47c by the entire control unit 47b. As a result, the image allocating operation is carried out, the control information based upon the image allocating operation is created, and the operation of the shifter section 16 is adjusted.

As shown in FIG. 29A, in the case where 10 images in total obtained in the normal process operation are allocated, the 3 cut sheets S₁ to S₃ are cut into prints. After that, prints of odd-numbered images on the first lane L₁ side are transported to the second transport path “β” (refer to FIG. 23), and prints of even-numbered images on the second lane L₂ side are transported to the first transport path “α” (refer to FIG. 23), and then, the prints of the even-numbered images are moved to the first lane L₁ side in such a manner that the prints of the even-numbered images and the prints of the odd-numbered images are located alternately. Those prints are arranged into a single line so as to constitute a sequence of the images Q₁ to Q₁₀, and then, the processed prints are transported to the sort transporting section 18.

As a result, as indicated in FIG. 29B, a bundle “P_{Q}” of accumulated prints where the prints of the images Q₁ to Q₁₀ are stacked is accumulated in the accumulation area “d₁”. As previously explained, the prints formed by the normal print processing operation can be accumulated on the belt 142.

Next, a description is made of a second image recording mode (i.e. mode 1) of the second embodiment. In the mode 1, an order “G” of such an urgent processing operation that 10 sheets of prints in total are formed for the images G₁ to G₁₀ is inserted at the back of the order “Q” of such a normal processing operation that 10 sheets of prints in total are formed for the images Q₁ to Q₁₀.

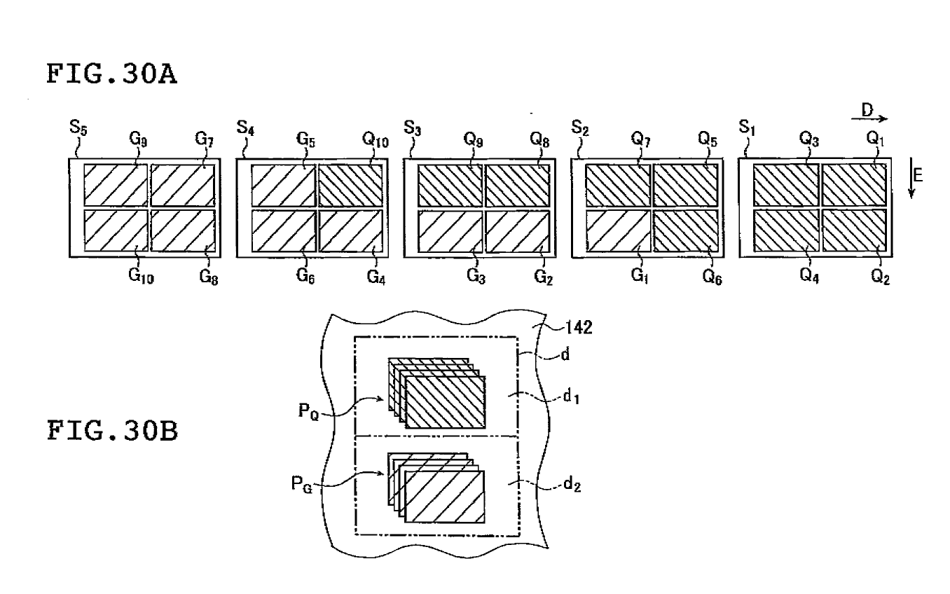

FIG. 30A is a schematic diagram for indicating a second image recording mode by the image recording apparatus according to the second embodiment. FIG. 30B is a schematic diagram representing a bundle of accumulated prints obtained by the second image recording mode shown in FIG. 30A.

In the mode 1, when the 10 images Q₁ to Q₁₀ of the order Q corresponding to the normal print processing operation are allocated, and also, the 10 images G₁ to G₁₀ of the order G corresponding to the urgent processing operation are allocated to the cut sheets S₁ to S₅, 20 images in total of the orders Q and G are stored in the image data temporary storage unit 47d, and the printing image data 212 (refer to FIG. 20A) is formed by the image allocating unit 47e. Next, as indicated in FIG. 30A, the images are allocated to the 5 cut sheets S₁ to S₅ based upon the printing image data 212.

In this case, the images Q₁ to Q₄ are allocated to the cut sheet S₁, the images Q₇ to G₁₀ of the normal print processing operation are allocated to the cut sheets S₂ to S₄ on the side of the first lane L₁, and the images G₁ to G₄ of the urgent print processing operation are allocated on the side of the second lane L₂.

Also, based upon the information supplied from the entire control unit 47b, such information that the prints of the images Q₁ to G₆ in the cut sheets S₁ and S₂ are arranged into a single line on the first lane L₁ side is outputted as the control information from the discharge control unit 47c. Also, such information that the prints of the images G₅ to G₁₀ in the cut sheets S₄ and S₅ are arranged into a single line on the second lane L₂ side is outputted as the control information from the discharge control unit 47c.

In addition, such information that the prints of the images Q₇ to G₁₀ and the prints of the images G₁ to G₄ in the cut sheets S₂ to S₄ are not arranged into a single line is outputted as the control information from the discharge control unit 47c.

As represented in FIG. 30A, in the case where 20 images in total including the urgent data are allocated to the cut sheets S₁ to S₅, both the cut sheets S₁ and S₂, and the cut sheets S₄ and S₅ are cut into prints and then arranged into a single line based upon the control information produced based upon the printing image data 212. The prints formed from the cut sheet S₃ are not arranged into the single line, but are directly transported to the sort transporting section 18.

As a result, as shown in FIG. 30B, the prints of the images G₁ to G₁₀ of the order Q are accumulated in the accumulation area “d₁”, so that a bundle “P_{Q}” of accumulated prints is obtained. The prints of the images Q₁ to Q₁₀ of the order G are accumulated in the accumulation area “d₂”, so that a bundle “P_{G}” of accumulated prints is obtained. As previously explained, the normal prints obtained by the normal print processing operation and the urgent prints obtained by the urgent print processing operation can be separately accumulated in the accumulation areas “d₁” and “d₂” on the belt 142. Accordingly, the prints can be quickly obtained without mistaking the normal print for the urgent print or vise versa.

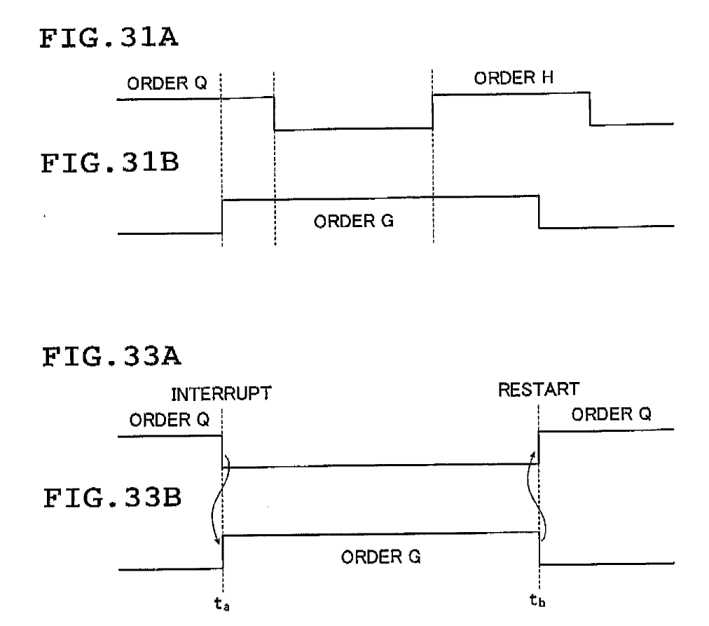

Also, in the mode 1, as shown in FIGS. 31A and 31B, while the prints of the normal processing operation (i.e., order Q) are accumulated in the accumulation area “d₁”, the prints of the urgent processing operation (i.e., order G) can be accumulated in the accumulation area “d₂”, and further, the normal processing operation and the urgent processing operation can be carried out in parallel with each other. As a result, lowering of the productivity can be prevented.

As previously explained, in the mode 1, since the prints of the urgent processing operation (i.e., order G) are accumulated in the accumulation area “d₂”, the accumulation of the prints of the normal processing operation (i.e., order Q) is not disturbed. As indicated in FIGS. 31A and 31B, it the normal processing operation is accomplished, then prints of an extra urgent processing operation (i.e., order H) having a higher priority can be accumulated in the accumulation area “d₁” for the normal processing operation even when the urgent processing operation is being carried out.

Next, a description is made of a third image recording mode (i.e., mode 2) of the second embodiment. In the mode 2, an order “G” of such an urgent processing operation that 10 sheets of prints are formed for the images G₁ to G₁₀ is inserted at the back of the order “Q” of such a normal processing operation that 10 sheets of prints are formed for the images Q₁ to Q₁₀.

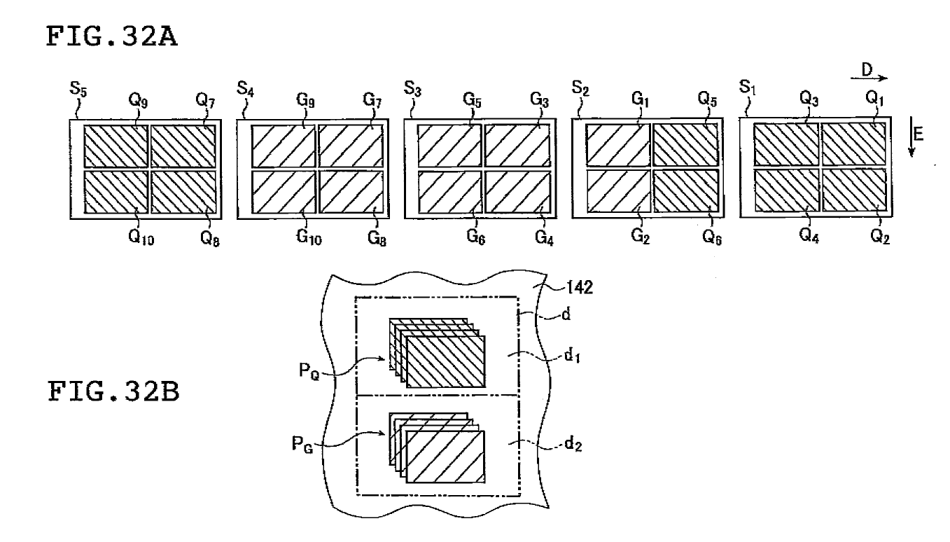

FIG. 32A is a schematic diagram for indicating the third image recording mode by the image recording apparatus according to the second embodiment of the present invention. FIG. 32B is a schematic diagram representing a bundle of accumulated prints obtained by the third image recording mode shown in FIG. 32A.

In the mode 2, 20 images in total including both the images Q₁ to Q₁₀ of the normal processing operation and the images G₁ to G₁₀ of the urgent processing operation are stored in the image data temporary storage unit 47d, and are allocated to the 5 cut sheets S₁ to S₅ by the image allocating unit 47e. In this case, such a printing image data 214 as shown in FIG. 21A is formed. Based upon the printing image data 214, as shown in FIG. 32A, the images Q₁ to Q₆ are allocated to the cut sheets S₁ and S₂, and further, the images Q₁ and Q₂ are allocated to the cut sheet S₂, Also, the images G₃ to G₁₀ of the urgent print processing operation are allocated to the cut sheets S₃ and S₄. The images Q₇ to G₁₀ of the normal print processing operation are allocated to the cut sheet S₅.

Also, the entire control unit 47b creates such information as control information that the prints of the images Q₁ to Q₁₀ of the order Q are arranged into a single line on the side of the first lane L₁, and then outputs the control information to the discharge control unit 47c. Also, the entire control unit 47b creates such information as control information that the prints of the images G₁ to G₁₀ of the order G are arranged into a single line on the side of the second lane L₂, and then outputs the control information to the discharge control unit 47c.

As represented in FIG. 32A, in the case where 20 images in total including the urgent data are allocated to the cut sheets S₁ to S₅, the cut sheets S₁ to S₅ are cut into prints and then arranged into a single line based upon the control information produced based upon the printing image data 214. The order Q (i.e., images Q₁ to Q₁₀) is transported via the first lane L₁, and the order G (i.e., images G₁ to G₁₀) is transported via the second line L₂, and then are transported to the sort transporting section 18.

As a result, as indicated in FIG. 32B, the prints of the images Q₁ to Q₁₀ of the order Q are accumulated in the accumulation area “d₁”, so that a bundle “P_{Q}” of accumulated prints is obtained. The prints of the images G₁ to G₁₀ of the order G are accumulated in the accumulation area “d₂”, so that a bundle “P_{G}” of accumulated prints is obtained As explained above, the normal prints and the urgent prints are separately accumulated in the accumulation area “d₁” and the accumulation area “d₂” on the belt 142. As a result, the prints can be quickly obtained without mistaking the normal prints for the urgent prints or vise versa.

In the mode 2, as indicated in FIG. 33A, up to a time “ta” at which the accumulation of the prints of the order G is started, namely, up to the time “ta” when the normal print processing operation is interrupted, the prints of the images Q₁ to Q₆ are accumulated in the accumulation area “d₁”. Also, as shown in FIG. 33B, in a time period between times “ta” and “tb”, the prints of the images G₁ to G₁₀, namely, all of the prints of the order G are accumulated in the accumulation area “d₂”. From the time “tb” when the urgent processing operation has been accomplished, accumulation of the prints of the images Q₇ to Q₁₀ to the accumulation area “d₁” is restarted, and all of the prints of the order Q are accumulated in the accumulation area “d₁”.

It should be noted that in the mode 2, as shown in FIGS. 33A and 33B, since the normal print processing operation (i.e., order Q) is temporarily interrupted so as to execute the urgent processing operation (i.e., order G), the prints of the urgent processing operation can be formed within a short time, as compared with that of the mode 1.

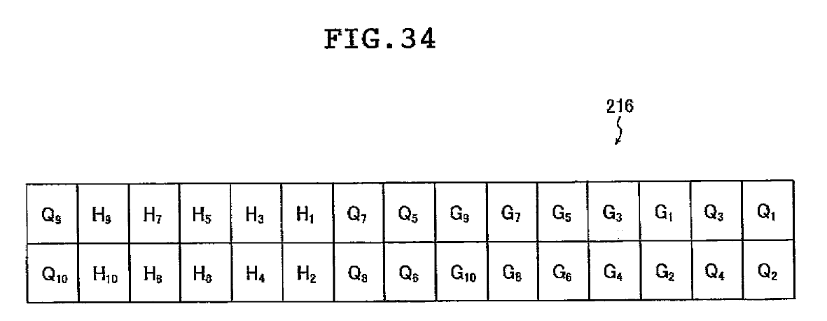

Also, in the mode 2, in such a case that two orders “G” and “H” of the urgent processing operations are continuously inputted after the order “Q” of the normal print processing operation, as indicated in FIG. 34, such a printing image data 216 is produced by the image allocating unit 47e in which the prints of the two orders of G and H are inserted between the prints of the order “Q” of the normal print processing operation. Images are formed on the cut sheet S based upon the printing image data 216 shown in FIG. 34.

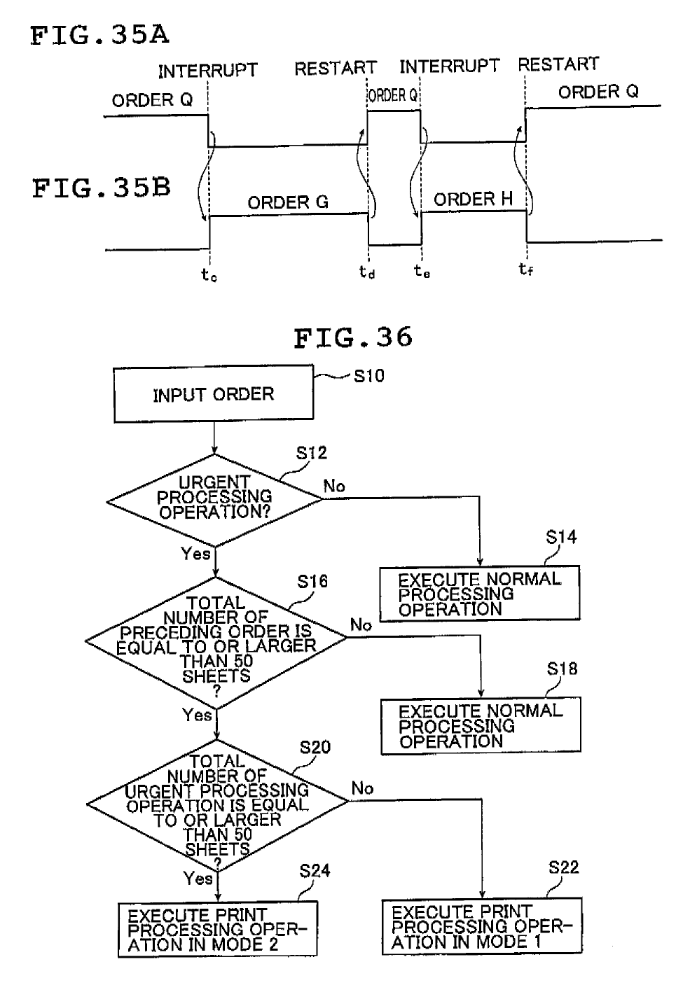

In this case, in the mode 2, as indicated in FIG. 35A, up to a time “tc” when the normal print processing operation is interrupted, the prints of the images Q₁ to Q₄ of the order “Q” are accumulated in the accumulation area “d₁”. Also, as shown in FIG. 35B, in a time period between times “tc” and “td”, the prints of the images G₁ to G₁₀ of the order G are accumulated in the accumulation area “d₂”. From the time “td” when the urgent processing operation has been accomplished, accumulation of the prints of the images Q₅ to Q₈ of the order Q in the accumulation area “d₁” is restarted. However, the order Q is again interrupted. As indicated in FIG. 35B, during a time period between a time “te” and a time “tf”, the prints of images H₁ to H₁₀ of the order H are accumulated in the accumulation area “d₂”. From the time “tf” when the order H has been accomplished, accumulation of the prints of the images Q₉ to Q₁₀ of the order Q in the accumulation area “d₁” are restarted. As a result, the prints for the 3 orders Q, G, and H are formed.

In the case where an order is inputted in the image recording apparatus 10a of this embodiment, if the order corresponds to the urgent processing operation, any one of the mode 1 and the mode 2 is selected by the mode selecting unit 45. A description is made of selecting steps for the mode 1 and the mode 2. It should be noted that the selection between the mode 1 and the mode 2 is carried out by the mode selecting unit 45 of the entire control unit 47a.

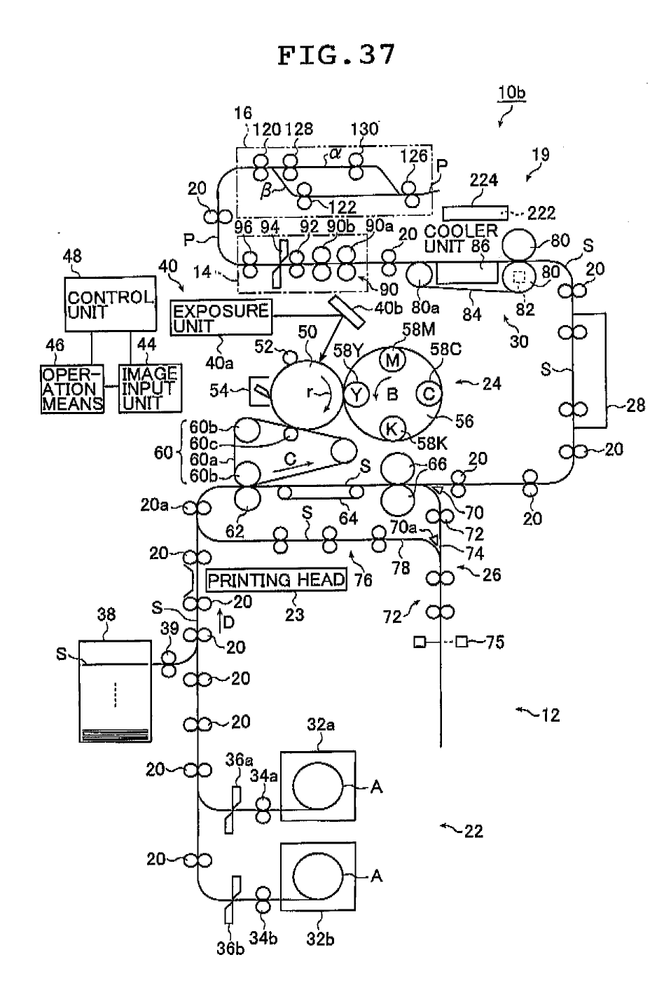

FIG. 36 is a flow chart for explaining selecting steps for either the mode 1 or the mode 2 in the case where a priority of an inputted order is high.

First, an order is inputted (Step S10).

Next, it is checked as to whether or not a priority of the inputted order is an urgent processing operation (Step S12).

In Stop S12, when the inputted order does not correspond to the urgent processing operation, image data are sequentially processed in the sequence of the orders stored in the order storage unit 47a (Step S14).

On the other hand, in Step S12, when the inputted order corresponds to the urgent data, the image data is moved up by skipping the order sequence stored in the order data storage unit, is outputted to the entire control unit, and further is outputted to the image data temporary storage unit.

At this time, a confirmation is made as to whether or not a total number of prints of the previous order is equal to or larger than 50 (Step S16).

In Step S16, in the case where the total number of prints of the previous order is smaller than 50, a print processing operation is carried out after the print processing operation for the previous order has been accomplished (Step S18).

On the other hand, in Step S16, in the case where the total number of prints of the previous order is equal to or larger than 50, a judgment is made as to whether or not the total number of prints of the urgent processing operation is equal to or larger than 50 sheets (Step S20).

In Step S20, when the total number of prints of the urgent processing operation is smaller than 50, a print processing operation of the mode 1 is carried out (Step S22).

On the other hand, in Step S20, when the total number of prints of the urgent processing operation is equal to or larger than 50, a print processing operation of the mode 2 is carried out (Step S22).

As previously explained, in the case of the urgent processing operation, either the mode 1 or the mode 2 is determined based upon the order inputted immediately before the order of the urgent processing operation and the total number of prints. When an order corresponds to the urgent processing operation, either the mode 1 or the mode 2 can be properly selected, and the print processing operation can be carried out in correspondence with the priority.

As previously explained, the image recording apparatus of the present invention can properly perform the image recording operation without lowering the productivity thereof even with respect to such an order having a different priority as an urgent print.

The image recording apparatus according to the second aspect of the present invention is basically constituted in the above-mentioned manner.

Next referring to FIGS. 3, 4, 6, 22, and 37 to 48, a description is made of an image recording apparatus according to the third aspect of the present invention.

FIG. 37 is a schematic diagram for indicating one embodiment (hereinafter referred to as “third embodiment”) of the image recording apparatus according to the third aspect of the present invention.

It should be noted that the image recording apparatus 10b of the third embodiment shown in FIG. 37 has a similar structure to the above-mentioned image recording apparatus 10a of the second embodiment shown in FIG. 16 except for the following points. The same reference symbols of the image recording apparatus 10a will be employed as those for denoting the same structural elements of the image recording apparatus 10b, and detailed descriptions thereof are omitted. Therefore, different points will be mainly explained. That is, instead of the control unit 47 and the sort transporting section 18, a control unit 48 and a sort transporting section 19 are employed.

As indicated in FIG. 37, the image recording apparatus 10b of the third embodiment comprises the image recording section 12, the cutting section 14, the shifter section 16 which functions as an accumulation position selecting unit, the sort transporting section 19, and transporting means including transporting rollers 20 and the like.

It should be noted that the respective structural elements of the image recording section 12, the cutting section 14, the shifter section 16, and the sort transporting section 19 are each connected to the transporting means including the transporting roller 20 and the like.

The image recording section 12 of the third embodiment includes the supplying subsection 22, the back printing subsection 23, the image forming subsection 24, the reverse transporting subsection 26, the position adjusting subsection 28, the surface gloss processing subsection 30, the exposure subsection 40, the control unit 48, and transporting means (i.e., transporting rollers 20 and registration rollers 20a).

In the image recording section 12, both the image input unit 44 and the operation means 46 are connected to the control unit 48.

The image recording section 12 of the third embodiment has a similar structure and similar functions to those of the above-mentioned image recording section 12 of the second embodiment except that the image recording section 12 of the third embodiment includes the control unit 48 instead of the control unit 47. As a result, explanations thereof except for the control unit 48 are omitted.

It should be noted that similarly to the control unit 47 of the second embodiment, the control unit 48 of the third embodiment stores therein image data (hereinafter referred to also as “order data”) as to images to be printed which hate been ordered, and manages a process sequence of the order data, namely, a printing process sequence executed in the image recording apparatus 10b. Also, the control unit 48 controls operations of respective devices provided in the image recording apparatus 10b, and manages state of the respective devices.

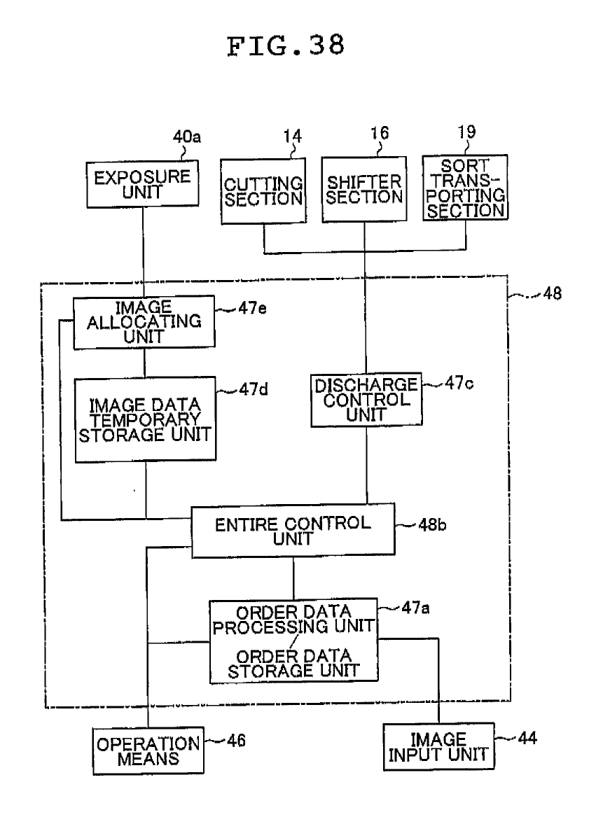

FIG. 38 is a block diagram for schematically indicating one example of the control unit of the image recording apparatus of the third embodiment.

The control unit 48 includes the order data processing unit/order data storage unit 47a, an entire control unit 48b, the discharge control unit 47c, the image data temporary storage unit 47d, and the image allocating unit 47e. The order data processing unit/order data storage unit 47a is connected to an image input unit 44. Also, the order data processing unit/order data storage unit 47a and the entire control unit 48b are each connected to the operation means 46.

It should be noted that the control unit 48 of the third embodiment shown in FIG. 38 has a similar structure, operations, and functions to those of the control unit 47 of the second embodiment shown in FIG. 17 except that the control unit 48b does not include the mode selecting unit 45 unlike the entire control unit 47b including the mode selecting unit 45. Therefore, the detailed descriptions of the structural elements of the control unit 48 denoted by the same reference symbols of the control unit 47 are omitted. However, the structure, operations, and functions of the control unit 48 may be understood by replacing the control unit 47, the entire control unit 47b, and the sort transporting section 18 with the control unit 48, the entire control unit 48b, and the sort transporting section 19, in the explanation of the control unit 47 of the above-mentioned second embodiment, if necessary.

The entire control unit 48b performs a similar control operation to that of the above-mentioned entire control unit 47b except for the control, operation, and function related to the mode selecting unit 45. The entire control unit 48b controls the order data processing unit/order data storage unit 47a, the discharge control unit 47c, the image data temporary storage unit 47d, and the image allocating unit 47e. Also, the entire control unit 40b controls operations of respective devices provided in the image recording apparatus 10 other than the order data processing unit/order data storage unit 47a, the discharge control unit 47c, the image data temporary storage unit 47d, and the image allocating unit 47e, and manages state of the respective devices.

In other words, when a priority order for forming prints at a top priority is contained in a plurality of orders, the entire control unit 48b of the third embodiment makes a print forming sequence of this priority order moved up to cause the image allocating unit 47e to perform such an image allocation that all images of the priority order are inserted between images of an order immediately before the priority order, and adjusts operations of the shifter section 16 (i.e., accumulation position selecting unit) by the discharge control unit 47c in such a manner that both the prints of the priority order and prints except for the priority order are discharged to different accumulation areas of the sort transporting section 19 to be explained later.

As previously explained, the order data processing unit/order data storage unit 47a stores therein order data, manages a processing sequence of order data, namely, a print processing sequence executed in the image recording apparatus 10, and is controlled by the entire control unit 48b.

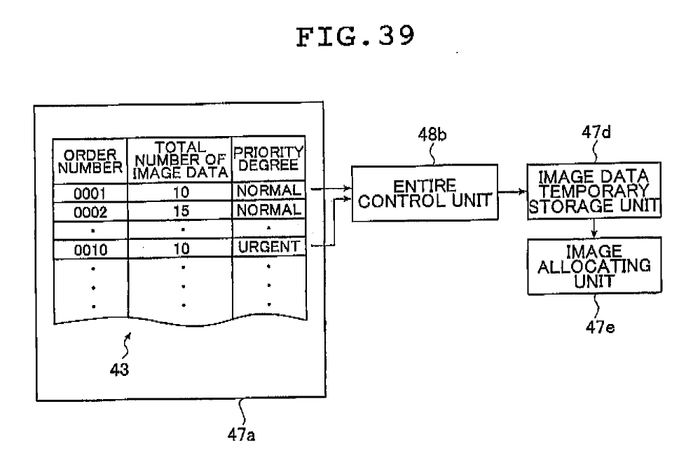

Also, the order data processing unit/order data storage unit 47a includes the order table 43 as shown in FIG. 39, and is controlled by the entire control unit 48b as explained above.

The discharge control unit 47c controls operations of the cutting section 14, the shifter section 16, and the sort transporting section 19, and performs a similar control operation except that the discharge control unit 47c controls operations of the sort transporting section 19 of the image recording apparatus 10b instead of the sort transporting section 18 of the image recording apparatus 10a.

As explained later, in the sort transporting section 19, the number of orders for prints P capable of accumulating has been determined. As a result, the discharge control unit 47c manages the number of orders for prints mounted on the sort transporting section 19 as accumulation information by counting the number of orders, for example, based on a discharge amount of prints in the shifter section 16 and a displacement of the belt 142. For example, in the case where the number of orders accumulated is small, a warning may be issued.

As previously explained, the image data temporary storage unit 47d temporarily stores therein order data which was outputted from the order data processing unit/order data storage unit 47a to the entire control unit 48b. As indicated in FIG. 39, in such a case that an order (order number 0010) whose priority is urgent is present among the plural orders stored in the order table 43, the print forming sequence is moved up so as to output the order whose priority is urgent behind the order (order number 0001) whose priority is normal. Then, the urgent order is stored immediately after the normal order in the image data temporary storage unit 47d. The order data is outputted from the image data temporary storage unit 47d to the image allocating unit 47e in the above-mentioned order.

The image allocating unit 47e allocates images to be recorded on 1 cut sheet S in correspondence with dimensions of the images to be recorded, and priorities of the prints based upon order data (i.e., image data) inputted from the image input unit 44, and creates printing image data which is to be outputted to the exposure unit 40a. As a result, it is possible to record images while the images being allocated to 1 cut sheet S based upon the image data.

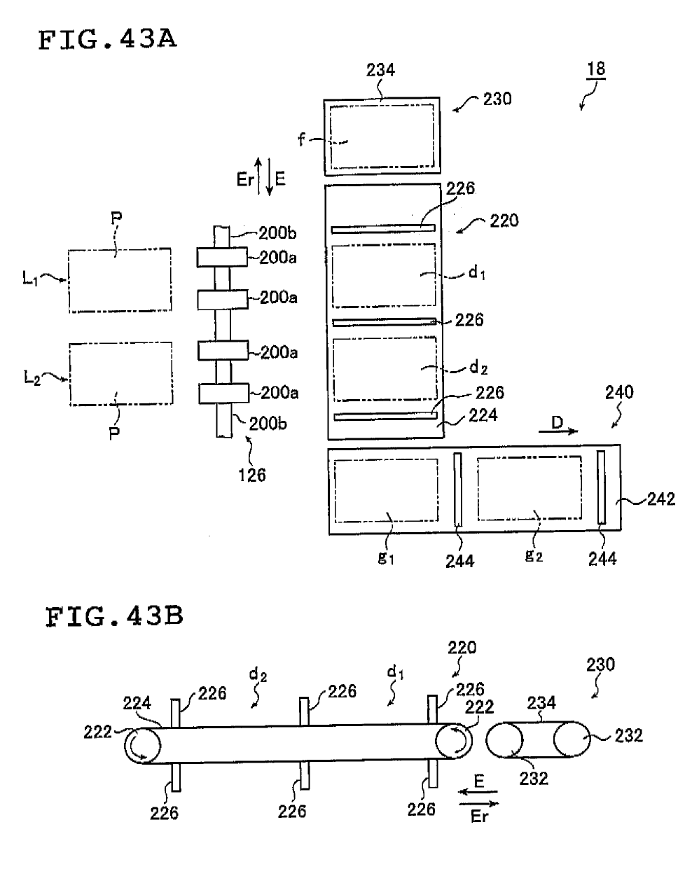

Also, as previously explained, the entire control unit 48b controls image allocating operation by the image allocating unit 47e, and creates control information. The above-mentioned control information contains information as to a selection of a transport path of prints P acquired based upon the image allocating operation by the image allocating unit 47e, or information as to whether or not an operation of the shifter section 16 is present. In other words, the entire control unit 48b produces a control parameter based upon the printing image data 210 created by the image allocating unit 47e. The control parameter indicates a transport path of the print P, and controls the operation of the shifter section 16. For instance, line arranging information is set for each of the cut sheets S, and as will be described later, prints are accumulated in either the first accumulation area “d₁” or the second accumulation area “d₂” (refer to FIG. 43A) of the sort transporting section 19.

It should be noted that as the control parameters, for example, there are three sorts of control parameters “PL1” “PL2”, and “PTH (i.e., through)”. In the control parameter “PL1”, the print P is accumulated in the first accumulation area “d₁”, in the control parameter “PL2”, the print P is accumulated in the first accumulation area “d₁”, and, in the control parameter “PTH (through)”, while the shifter section 16 is not operated, the print P is allowed to pass therethrough and is merely transported.

In the entire control unit 48b, the control information is outputted via the discharge control unit 47c to the shifter section 16. As a result, the entire control unit 48b controls the image allocating operations performed by the image allocating unit 47e and the operation of the shifter section 16 by the discharge control unit 47c.

Similarly to the above-mentioned first embodiment and second embodiment, as allocation modes of images to cut sheets S by the image recording section 12 in the third embodiment, for example, as represented in FIG. 3A, a 4-image allocation may be realized in which 4 image recording regions “R₁” to “R₄” are formed on 1 cut sheet S. Also, as represented in FIG. 3B, a 1-image allocation may be realized in which one image recording area R₀ is formed on 1 cut sheet S.

It should be noted that an allocation of images in the third embodiment is also not specifically limited, but is preferably determined in a proper manner based upon an appointed delivery date of an order (i.e., priority) and the like in such a manner that a waste part of a cut sheet S becomes minimum by the control unit 48 (i.e., entire control unit 48b).

As previously explained, the image allocating unit 47e normally allocates the images of the order data (i.e., image data) with which prints should be formed, namely, print processing operation should be carried out to the cut sheets S for every order.

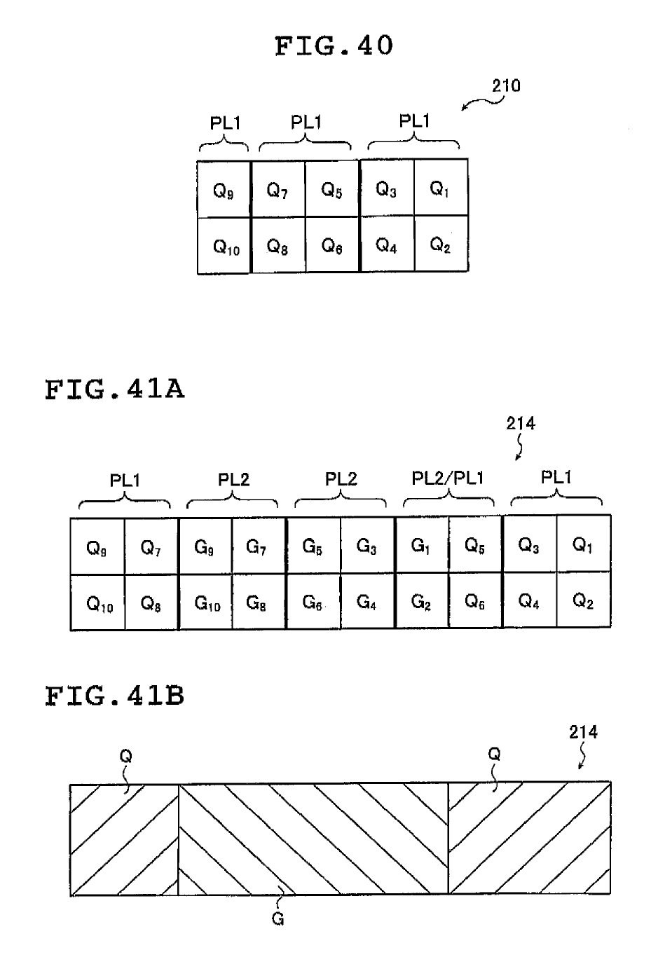

As indicated in FIG. 40, in the case where the image allocating unit 47e allocates images Q₁ to Q₁₀ to the cut sheet S in two lines, the image allocating unit 47e produces the printing image data 210 which is outputted to the exposure unit 40a in such an allocation sequence that the odd-numbered images are allocated to one line from the image Q₁, and the even-numbered images are allocated to the other line from the image Q₂.

The entire control unit 48b produces the control parameters based upon the printing image data 210. In this case, the images Q₁ to Q₁₀ correspond to the prints of the same order, so those prints are accumulated in, for instance, the first accumulation area “d₁”. At this time, assuming that 4 images are allocated to one cut sheet S, as to the control parameter under this condition, the control parameter is defined as “PL1” in all of the cut sheets S. It should be noted that “PL1” shown in FIG. 40 represents the control parameter.

However, in such a case that as the order data, for examples image data (hereinafter referred to as “urgent data”) whose priority is urgent, namely, whose prints are formed at a top priority by the operation means 46, for instance, the order data (refer to FIG. 39) of the order number 0010, is inputted from the image input unit 44, the print processing sequence is moved up by the entire control unit 48b so as to insert the urgent data behind the order data (i.e., image data) of the order number 0001. Further, the entire control unit 48b adjusts the image allocating operation by the image allocating unit 47e in such a manner that the urgent data can be processed to form prints therefrom at the earliest time.

As indicated in FIG. 41A, in the case where the order data “G” of the urgent print processing operation for forming the prints of the images G₁ to G₁₀ interrupts the order data “Q” of the normal process operation for forming the prints of the images Q₁ to Q₁₀, as represented in FIG. 41A, such printing image data 214 is created by inserting the images of the order data G between the images Q₅ and Q₆ and the images Q₇ and Q₈ of the order data Q. Also, as represented in FIG. 41B, the printing image data 214 is used to allocate images in such a manner that the images of the order data G are inserted between the images of the order data Q. In this case, before all of the normal prints obtained by the order data Q are outputted, all of the urgent prints obtained by the order data G are outputted.

As explained later, in order that the urgent prints and the normal prints are transported to the sort transporting section 19 in a separate manner, and then are accumulated in different accumulation areas in the sort transporting section 19, a control parameter is produced based upon the printing image data 214. In this case, there are prints of two orders as to the images Q₁ to Q₁₀ of the normal processing operation and the images G₁ to G₁₀ of the urgent processing operation. As a result, the prints of the images Q₁ to Q₁₀ of the normal processing operation are accumulated in, for instance, the first accumulation area “d₁”, whereas the prints of the images G₁ to G₁₀ of the urgent processing operation are accumulated in, for instance, the second accumulation area “d₁”. At this time, assuming that 4 images are allocated within 1 cut sheet, as indicated in FIG. 41B, the images of the two orders are mixed with each other within 1 cut sheet. As a result, 2 control parameters are also required. The control parameter for the front half of the sheet is “PL1”, and the control parameter for the back half thereof is “PL2”, It should be noted that reference symbol “PL1” indicated in FIG. 41B represents the control parameter.

It should be noted that when the operation means 46 is operated by an operator, the control unit 48 causes the image recording apparatus 10b to set or display various sorts of information in accordance with the content of the operation.

Next, a description is made of the cutting section 14 of the third embodiment.

Similarly to the cutting section 14 of the second embodiment shown in FIG. 16, the cutting section 14 of the third embodiment shown in FIG. 37 cuts margins of peripheries of the recording regions R₁ to R₄ and R₀ (refer to FIGS. 3A and 3B) on which the images have been recorded by the image recording section 12, thereby forming respective prints P₁ to P₄ and P₀.

As indicated in FIG. 37, this cutting section 14 includes the first cutter 90, the second cutter 94, a scrap collection container (not shown), the first transport roller pairs 92 and 96, and a movable guide (not shown).

The second cutter 94, the first transport roller pairs 92 and 96, and the movable guide are each connected to the control unit 48, and thus, respective operations thereof are controlled by the control unit 48.

Next, a description is made of the shifter section 16 of the third embodiment.

The shifter section 16 of the third embodiment shown in FIG. 37 has similar structure, operation, and function of the shifter section 16 of the second embodiment shown in FIG. 16. The shifter section 16, for example, arranges prints having a first width which have been cut by the cutting section 14 and transported in two lines into a single line, or moves the prints P having the first width which have been cut by the cutting section 14 and transported in two lines to the other line. Also, the shifter section 16 may shift a so-called panorama print having such a dimension generally called as a “panorama size” (89 mm×254 mm) in a similar manner to that of the print P having the first width.

As indicated in FIGS. 4 and 22, the shifter section 16 of the third embodiment shown in FIG. 37 also comprises the feeding roller pair 120, the transport roller pairs 122 and 128, the discharge roller pair 126, the shift roller pair 130, the first movable guide 150, the second movable guide 152, the sensors 160, 162, and 166, and the shifter unit 180 (refer to FIG. 22). This shifter unit 180 moves the shift roller pair 130 in either the direction E or the direction Er. Also, in the shifter section 16 of the third embodiment, a transport path having a substantially rhomboid shape (i.e., parallelogram) is formed by the feeding roller pair 120, the transport roller pairs 122 and 128, the discharge roller pair 126, and the shift roller pair 130.

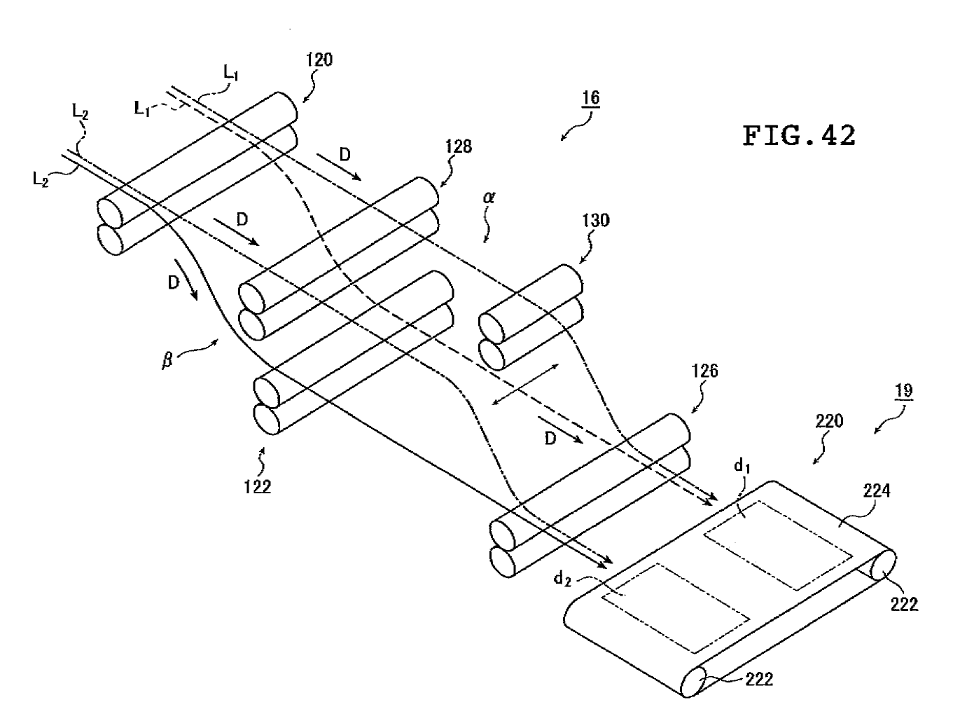

It should be noted that the shifter section 16 of the third embodiment shown in FIG. 37, and the shifter section 16 of the second embodiment indicated in FIG. 16 are different in the following points. That is, as indicated in FIGS. 4, 22, and 23, or FIG. 42, a transporting unit at the downstream side to which the transported prints P are discharged by the discharge roller pair 126 is either the sort transporting section 18 or the sort transporting section 19. Also, a control operation as to the operations of the shift roller pair 130 is carried out by either the entire control unit 47b or the entire control unit 48b. Since the shifter section 16 of the third embodiment has the completely similar structure, operation, and function to those of the first embodiment, detailed explanations thereof are omitted. Therefore, different points are mainly explained.

Also, in the shifter section 16 of this embodiment, as shown in FIG. 42, the first transport path “α” includes the feeding roller pair 120, the transport roller pair 128, and the shift roller pair 130 whereas the second transport path “β” includes the feeding roller pair 120 and the transport roller pair 122. The transport path is branched into the first transport path “α” and the second transport path “β”, in which the second transport path “β” extends in a direction that is perpendicular to the array direction of the prints P and the transporting direction D (namely, vertical direction). Then, the both transport paths are merged with each other at the discharge roller pair 126.

As shown in FIG. 42, the first transport path “α” and the second transport path “β” have two lanes made of the first lane “L₁” and the second lane “L₂”, respectively.

In this case, as represented in FIGS. 37 and 42, the discharge roller pair 126 of the shifter section 16 of this embodiment is employed so as to transport prints P which are transported in plural lines, that is, two lines in this embodiment, or in a single line to the sort transporting section 19 provided at the post stage. The discharge roller pair 126 includes such a split roller that 4 roller pieces 200a are provided to a rotation shaft 200b at regular intervals.

The operation of the shift roller pair 130 of the shifter section 16 of this embodiment in either the direction E or the direction Er is controlled by the entire control unit 48b via the discharge control unit 47c by referring to the image allocation data by the image allocating unit 47e.

Next, a description is made of the sort transporting section 19 of the third embodiment.

The sort transporting section 19 as shown in FIG. 37 and FIG. 42 accumulates prints P which are transported and are arranged into the single line by the shifter section 16 for every order.

As indicated in FIG. 43A, the sort transporting section 19 includes an accumulating subsection 220, a standby subsection 230, and a transporting subsection 240. The standby subsection 230 is provided at an edge portion of the accumulating subsection 220 in the direction Er, and the transporting subsection 240 is provided at an edge portion of the accumulating subsection 220 in the direction E.

The accumulating subsection 220 accumulates prints P transported via either the first lane L₁ or the second lane L₂ for every order. Also, the accumulating subsection 220 transports a bundle of accumulated prints in which the accumulation of the prints for 1 order has been completed to the transporting subsection 240, and also transports a bundle of accumulated prints in which the accumulation of the prints has not yet been accomplished to the standby subsection 230.

As indicated in FIG. 43B, the accumulating subsection 220 includes two rollers 222 arranged opposite to each other in the direction E, a belt 224 which is elongated in the direction E to be stretched around those rollers 222, and a plurality of partition plates 226 which are provided on the surface of the belt 224 in a flexible manner. Those partition plates 226 are provided in the direction E by spacing a predetermined interval. The belt 224 is partitioned by those partition plates 226, so that the first accumulation area “d₁” and the second accumulation area “d₂” are formed.

The first accumulation area “d₁” corresponds to an area where the prints P transported via the first lane L₁ are accumulated. Also, the second accumulation area “d₂” corresponds to an area where the prints P transported via the second lane L₂ are accumulated.

It should be noted that as shown in FIG. 43B, while the plurality of partition plates 226 are provided on the surface of the belt 224, when the belt 224 is moved by a predetermined amount, among such areas which are partitioned by a newly produced partition plate 226, an area where the prints P transported via the first lane L₁ are accumulated becomes the first accumulation area “d₁”. Also, an area where the prints P transported via the second lane L₂ are accumulated becomes the second accumulation area “d₂”.

The standby subsection 230 has a standby area “f” which once makes a bundle of accumulated prints in which the prints P for 1 order has not yet been accumulated on standby among the prints P accumulated in the accumulating subsection 220, depending upon print processing conditions of the image forming apparatus 10.

Similarly to the accumulating subsection 220, as shown in FIG. 43B, this standby subsection 230 includes two rollers 232 arranged opposite to each other in the direction E, and a belt 234 stretched around those rollers 232. This standby subsection 230 is to transport a bundle of accumulated prints in which the accumulation of prints P transported from the accumulating subsection 220 has not yet been completed to the accumulating subsection 220 in accordance with such a condition as an order for a print processing operation.

The transporting subsection 240 includes one pair of rollers (not shown) arranged opposite to each other in the direction D, a belt 242 stretched around those rollers, and a plurality of partition plates 244 which are provided on the belt 242 by spacing a predetermined interval in the direction D. The belt 242 is partitioned by those partition plates 244, thereby forming two mounting areas “g₁” and “g₂”. In the transporting subsection 240, the accumulated prints can be transported in the direction D by rotating the rollers.

For instance, the prints for 1 order are transported by the transporting subsection 240 to a packing machine for packing prints.

In the accumulating subsection 220 of this embodiment, prints P transported from the discharge roller pair 126 via either the first lane L₁ or the second lane L₂ are accumulated in either the first accumulation area “d₁” or the second accumulation area “d₂” provided on the belt 224.

In the case where the accumulating subsection 220 once interrupts the accumulation of the prints P before completion of the accumulation of the prints P for 1 order and accumulates prints of another order based upon the control information and the like, the roller 222 is rotated so as to move a bundle of accumulated prints in the direction Er. As a result, the bundle of accumulated prints accumulated in either the first accumulation area “d₁” or the second accumulation area “d₂” is transported to the standby subsection 230.

Also, assuming that the accumulation of the print P for 1 order has been accomplished based upon the control information and the like, the accumulating subsection 220 rotates the roller 222 so as to move the bundle of accumulated prints in the direction E. As a result, the bundle of accumulated prints accumulated in either the first accumulation area “d₁” or the second accumulation area “d₂” is transported to the transporting subsection 240.

Therefore, the belt 224 is brought into the condition in which prints P can be accumulated, so that prints P for the next order can be accumulated.

The operations of the shifter section 16 of the third embodiment are carried out in accordance with the transporting steps of the prints, as indicated in FIGS. 24 to 27, by the shifter section 16 with the structure shown in FIG. 22. AS a result, since the operations of the shifter section 16 are basically similar to those of the shifter section 16 of the second embodiment except for the following operations, explanations thereof are omitted. That is, the control operation of the shifter section 16, for example, the control operation of the second movable guide 152 shown in FIG. 22 is carried out by the control unit 48 instead of the control unit 47, the prints P₁ and P₂ arranged into one line as shown in FIG. 26 are transported via the first lane L₁ in one line, and then are transported to the sort transporting section 19 by the discharge roller pair 126 instead of the sort transporting section 18. As a result, the prints P₁ to P₄ arranged into one line on the first lane L₁ side shown in FIG. 27D are, for example, sequentially stacked from the print P₁ on the first accumulation area “d₁” (refer to FIG. 43A) of the accumulating subsection 220 of the sort transporting section 19 instead of the accumulation area of the sort transporting section 18.

Next, a description is made of a print forming method executed by the image recording apparatus 10b according to the third embodiment shown in FIG. 37.

First, a description is made of a print forming method of the normal process operation.

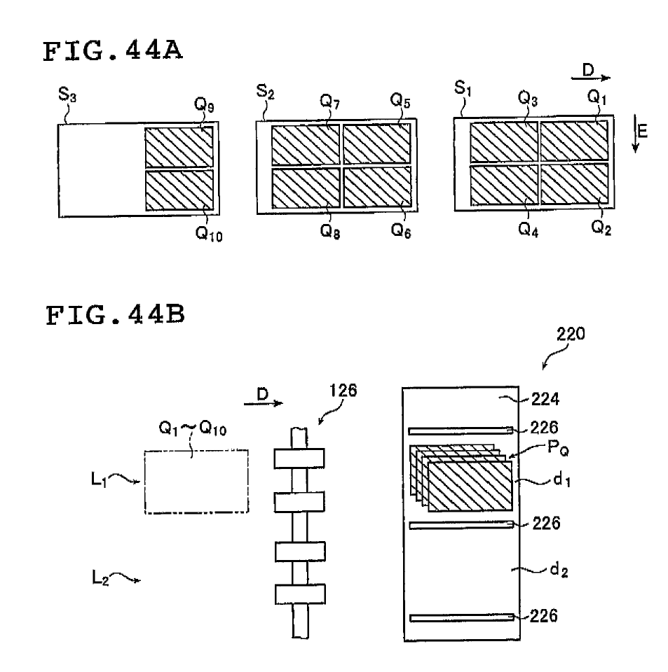

FIG. 44A is a schematic diagram representing an image recording mode by the normal print processing operation executed by the image recording apparatus according to the third embodiment. FIG. 44B is a schematic diagram representing a bundle of accumulated prints obtained by the normal print processing operation shown in FIG. 44A.

In this embodiment, the following method will be explained as a typical example. That is, a print processing operation is carried out by allocating 4 images to 1 cut sheet to form prints P, and then, the formed prints P are accumulated in the accumulation area “d₁” or the accumulation area “d₂” of the sort transporting section 19.

In this embodiment, exemplified is a case of receiving an order in which one sheet of print is formed for each of the images Q₁ to Q₁₀, namely, 10 sheets of prints are formed in total.

In the image recording apparatus 10b of this embodiment, when 10 images “Q₁” to “Q₁₀” are allocated to the cut sheets S in the normal print processing operation, order data is outputted to the image data temporary storage unit 47d, and the printing image data 210 (refer to FIG. 40) is created by the image allocating unit 47e. Next, as indicated in FIG. 44A, the images Q₁ to Q₁₀ are allocated to the 3 cut sheets S₁ to S₃ based upon the printing image data 210. In this case, the entire control unit 48b adjusts the allocating operations of the images Q₁ to Q₄ by the image allocating unit 47e in such a manner that the images Q₁ to Q₁₀ of the normal print processing operation are arrayed in the direction E of the respective cut sheets S₁ to S₃. It should also be understood that as to the third cut sheet S₃, since two images Q₉ and Q₁₀ of the normal print processing operation are allocated by the image allocating unit 47e, a margin is produced.

Moreover, in the entire control unit 48b, as to the cut sheets S₁ to S₃, control information for arranging prints into a single line on the first lane L₁ side is created. The information is outputted as the control information to the discharge control unit 47c by the entire control unit 48b. As a result, the image allocating operation is carried out and the control information based upon the image allocating operation is created, thereby adjusting the operations of the shifter section 16 and the sort transporting section 19.

As shown in FIG. 44A, in the case where 10 images in total obtained in the normal process operation are allocated, the 3 cut sheets S₁ to S₃ are cut into prints. After that, prints of odd-numbered images on the first lane L₁ side are transported to the second transport path “β” (refer to FIG. 42), prints of even-numbered images on the second lane L₂ side are transported to the first transport path “α” (refer to FIG. 42), and then the prints of the even-numbered images are moved to the first lane L₁ side in such a manner that the prints of the even-numbered images and the prints of the odd-numbered images are located alternately. Thus, the prints are arranged into a single line so as to constitute a sequence of the images Q₁ to Q₁₀ to transport the processed prints to the sort transporting section 19.

As a result, as shown in FIG. 44B, the prints of the images Q₁ to Q₁₀ are accumulated in the first accumulation area “d₁” on the belt 224 of the accumulating subsection 220, whereby a bundle “P_{Q}” of accumulated prints is obtained. As previously explained, the prints formed by the normal print processing operation can be accumulated on the belt 224 of the accumulating subsection 220.

Subsequently, in the sort transporting section 19, the bundle P₀ of accumulated prints of the images of the order Q is transported from the accumulating subsection 220 to the transporting subsection 240 based upon the control information.

Next, a description is made of such an image recording mode according to this embodiment which includes a print processing operation having a high priority. In this image recording mode, an order “G” of such an urgent processing operation that 10 sheets of prints are formed for the images G₁ to G₁₀ is inserted at the back of the order “Q” of such a normal processing operation that 10 sheets of prints are formed for the images Q₁ to Q₁₀.

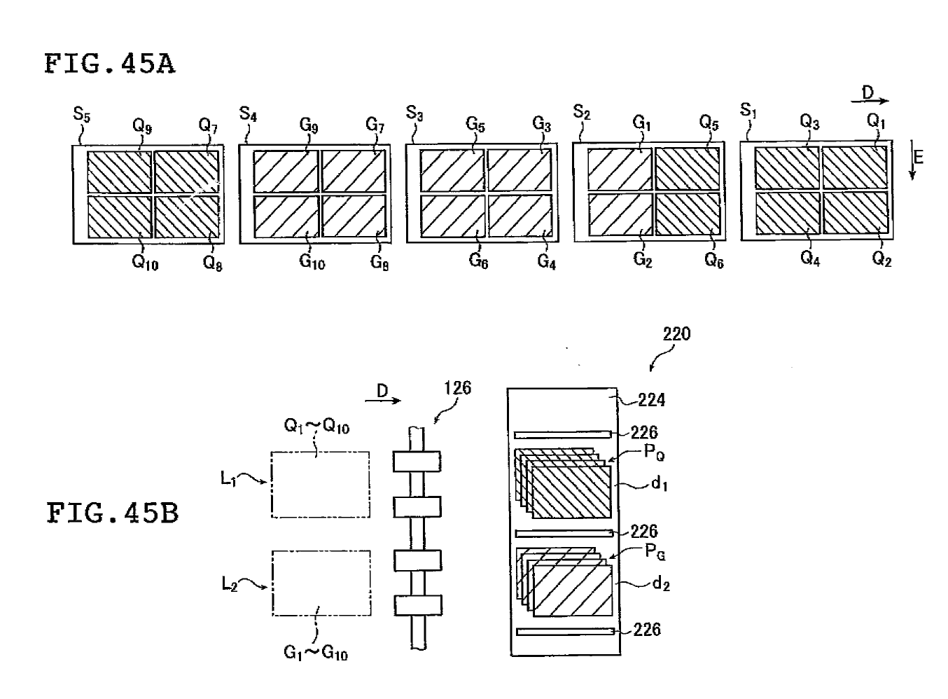

FIG. 45A is a schematic diagram for indicating an image recording mode including the print processing operation having the high priority by the image recording apparatus according to the this embodiment of the present invention. FIG. 45B is a schematic diagram representing a bundle of accumulated prints obtained in the image recording mode including the print processing operation having the high priority shown in FIG. 45A.

In the image recording mode including the print processing operation having the high priority, 20 images in total including the images Q₁ to Q₁₀ of the normal processing operation and the images G₁ to G₁₀ of the urgent processing operation are stored in the image data temporary storage unit 47d, and are allocated to the 5 cut sheets S₁ to S₅ by the image allocating unit 47e. In this case, such printing image data 214 as shown in FIG. 41A is created. Based upon the printing image data 214, as shown in FIG. 45A, the images Q₁ to Q₆ are allocated to the cut sheets S₁ to S₂, and further, the images G₁ and G₂ are allocated to the cut sheet S₂. Also, the images G₃ to G₁₀ of the urgent print processing operation are allocated to the cut sheets S₃ and S₄. The images Q₇ to G₁₀ of the normal print processing operation are allocated to the cut sheet S₅.

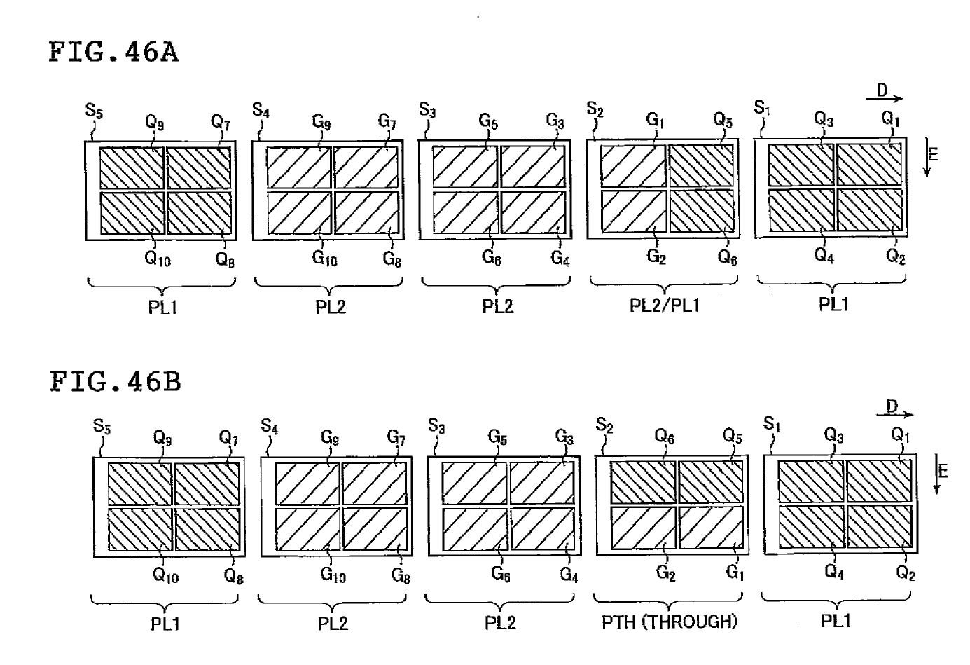

In this connection, FIG. 46A indicates a relationship between control parameters and the cut sheets S₁ to S₅ to which 20 images constituted of the images Q₁ to Q₁₀ of the normal processing operation and the images G₁ to G₁₀ of the urgent processing operation are allocated. As indicated in FIG. 45A, in each of the cut sheets S₁, S₃, S₄, and S₅, the images allocated thereto are included in a single order, and the control parameter is also a single control parameter. For instance, since the cut sheets S₁ and S₅ are apportioned to the first lane L₁, the control parameter of the cut sheets S₁ and S₅ has a value of “PL1”. Also, since the cut sheets S₃ and S₄ are apportioned to the second lane L₂, the control parameter of the cut sheets S₃ and S₄ has a value of “PL2”.

On the other hand, images of two kinds of orders are allocated to the cut sheet S₂. As a result, the cut sheet S₂ has two control parameters. That is, in this case, a front half of the cut sheet S₂ is given “PL1”, and a back half thereof is given “PL2”.

As previously explained, the entire control unit 48b creates such information as control information (i.e., control parameter) that the prints of the images Q₁ to Q₁₀ of the normal processing operation are arranged into a single line on the side of the first lane L₁, and then outputs the control information to the discharge control unit 47c. Also, the entire control unit 48b creates such information as control information (i.e., control parameter) that the prints of the images G₁ to G₁₀ of the order G are arranged into a single line on the side of the second lane L₂, and then outputs the control information to the discharge control unit 47c.

Also, based upon the image allocation data 214, the entire control unit 48b produces the control parameter which is the control information including the operation of the sort transporting section 19, and then the control parameter is outputted to the discharge control unit 47c.

Moreover, as indicated in FIG. 46B, in the case where 20 images in total including the images Q₁ to Q₁₀ of the normal processing operation and the images G₁ to G₁₀ of the urgent processing operation are allocated to the cut sheets S₁ to S₅, in the cut sheet S₂, the orders may be alternatively subdivided into the first lane L₁ side and the second lane L₂ side and allocate those images. In other words, the images of the normal processing operation (i.e., present order) may be allocated to a side on which the prints of the cut sheet S₁ are shifted, and the images of the urgent processing operation (i.e., next order) may be allocated to the other side. As a result, the operation of the shifter section 19 on the downstream side is no longer required, and it is sufficient that, after the cut sheet S₁ is cut, the prints are caused to pass through the shifter section 19 to be merely discharged. In this case, as the control parameter of the cut sheet S₂, “through” is set.

As represented in FIG. 45A, in the case where 20 images in total including the urgent data are allocated to the cut sheets S₁ to S₅, the cut sheets S₁ to S₅ are cut so as to form prints based upon the control information produced based upon the printing image data 214, and thereafter, the formed prints are arranged into a single line. The order Q (i.e., images Q₁ to Q₁₀) is transported via the first lane L₁, and the order G (i.e., images G₁ to G₁₀) is transported via the second line L₂, and then are transported to the sort transporting section 19.

As a result, as indicated in FIG. 45B, a bundle “P_{Q}” of accumulated prints in which the prints of the images Q₁ to Q₁₀ of the order Q are stacked is accumulated in the first accumulation area “d₁” on the belt 224 of the accumulating subsection 220, whereas a bundle “P_{G}” of accumulated prints in which the prints of the images G₁ to G₁₀ of the order G are stacked is accumulated in the second accumulation area “d₂” on the belt 224 of the accumulating subsection 220. As explained above, the normal prints and the urgent prints can be separately accumulated in the first accumulation area “d₁” and the second accumulation area “d₂” on the belt 224 of the accumulating subsection 220. As a result, the prints can be quickly obtained without mistaking the normal prints for the urgent prints or vise versa.

In the image recording mode including the print processing operation having the high priority, also in the third embodiment, similarly to the above-mentioned second embodiment, as shown in FIG. 33A, up to a time “ta” at which the accumulation of the prints of the order G is started, namely, up to the time “ta” when the normal print processing operation is interrupted, the prints of the images Q₁ to Q₆ are accumulated in the first accumulation area “d₁”. Also, as shown in FIG. 33B, in a time period between times “ta” and “tb”, the prints of the images G₁ to G₁₀, namely, all of the prints of the order G are accumulated in the second accumulation area “d₂”. From the time “tb” when the urgent processing operation has been accomplished, the accumulation of the prints of the images Q₇ to Q₁₀ in the first accumulation area “d₁” is restarted, and all of the prints of the order Q are accumulated in the first accumulation area “d₁”.

It should also be understood that in the image recording mode including the print processing operation having the high priority order, also in this embodiment as represented in FIGS. 33A and 33B, since the normal print processing operation (i.e., order Q) is temporarily interrupted so as to execute the urgent processing operation (i.e., order G), the prints of the urgent processing operation can be formed earlier than the prints of the normal processing operation.

Next, a description is made of a print forming method in the case where two orders G and H of the urgent processing operations are continuously entered after the order Q of the normal processing operation.

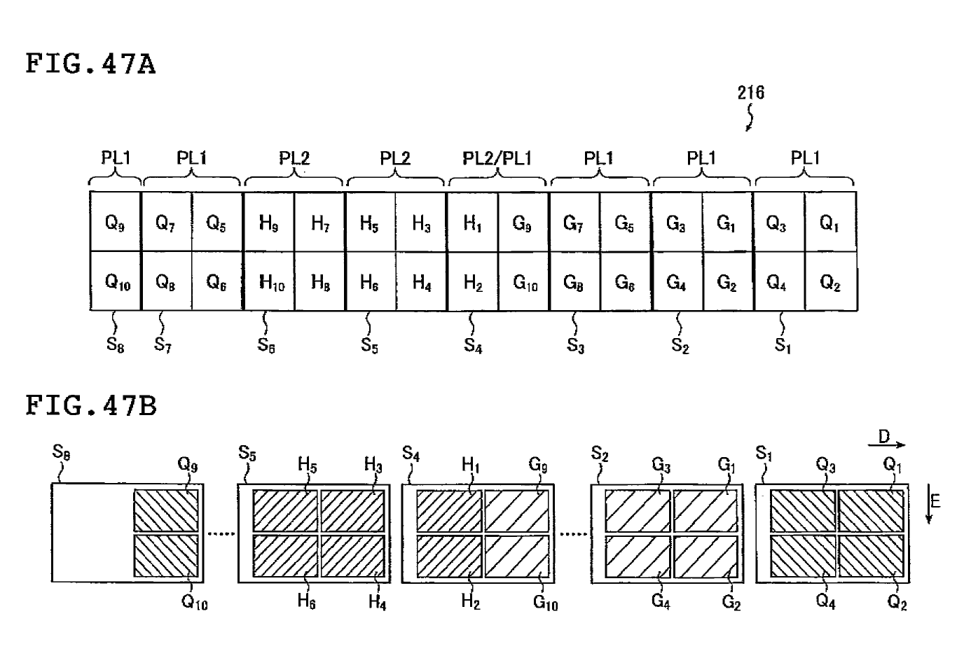

First, as shown in FIG. 47A, the image allocating unit 47e produces such printing image data 216 that the images of the two orders G and H have been inserted between the images of the order “Q” of the normal processing operation. As indicated in FIG. 47B, the images Q₁ to Q₄ are formed on the cut sheet S₁ based upon the printing image data 216 shown in FIG. 47A. The images G₁ to G₁₀ and the images H₁ to H₁₀ are formed on the cut sheets S₂ to S₆, and the images Q₅ to Q₁₀ are formed on the cut sheets S₇ and S₈.

At this time, in the entire control unit 48b, control parameters are set based upon the printing image data 216.

As shown in FIG. 47A, in each of the cut sheets S₁ to S₃ and S₅ to S₈, the allocated images are included in a single order, and only one control parameter is given. For example, since the cut sheets S₁ to S₁, S₇, and S₈ are apportioned to the first lane L₁, the control parameters of the cut sheets S₁ to S₃, S₇, and S₈ have such a value “PL1”. Also, since the cut sheets S₅ and S₆ are apportioned to the second lane L₂, the control parameters of the cut sheets S₅ and S₆ have a value “PL2”.

On the other hand, the images of two kinds of orders are allocated to the cut sheet S₄. As a result, the cut sheet S₄ has two control parameters. That is, in this case, a front half of the cut sheet S₄ is given “PL1”, and a back half thereof is given “PL2”.

In addition, the two orders G and H of the urgent processing operations are present behind the order Q of the normal processing operation in the third embodiment, but only two accumulating units are provided. Accordingly, after the prints of the images Q₁ to Q₄ allocated to the cut sheet S₁ are accumulated in the first accumulation area d₁ it is necessary to move a bundle W of accumulated prints once to the standby area “f” of the standby subsection 230. As a result, such information that after the prints of the images Q₁ to Q₄ are transported, the prints of the images Q₁ to Q₄ are moved from the accumulating subsection 220 to the standby area “f” of the standby subsection 230 is created as the control information (i.e., control parameter), and then, the control parameter is outputted to the discharge control unit 47c. Moreover, such information that after all of the prints of both the order G and the order H are accumulated, the prints of the images Q₁ to Q₄ are moved to the first accumulation area “d₁” and the prints of the remaining images Q₅ to Q₁₀ are accumulated in the first accumulation area d₁ is created as the control information (i.e., control parameter), and then, the control parameter is outputted to the discharge control unit 47c.

As to the prints of the images G₁ to G₁₀ of the order G, such information that those prints are arranged into a single line on the first lane L₁ side is created as the control information (i.e., control parameter), and then, the control parameter is outputted to the discharge control unit 47c. Further, as to the prints of the images G₁ to G₁₀ of the order H, such information that those prints are arranged into a single line on the second lane L₂ side is created as the control information (i.e., control parameter), and then, the control parameter is outputted to the discharge control unit 47c.

Next, the cut sheets S₁ to S₈ are cut to obtain the prints on which the respective images Q₁ to Q₁₀, images G₁ to G₁₀, and images H₁ to H₁₀ have been formed. Then, those prints are transported to the sort transporting section 19.

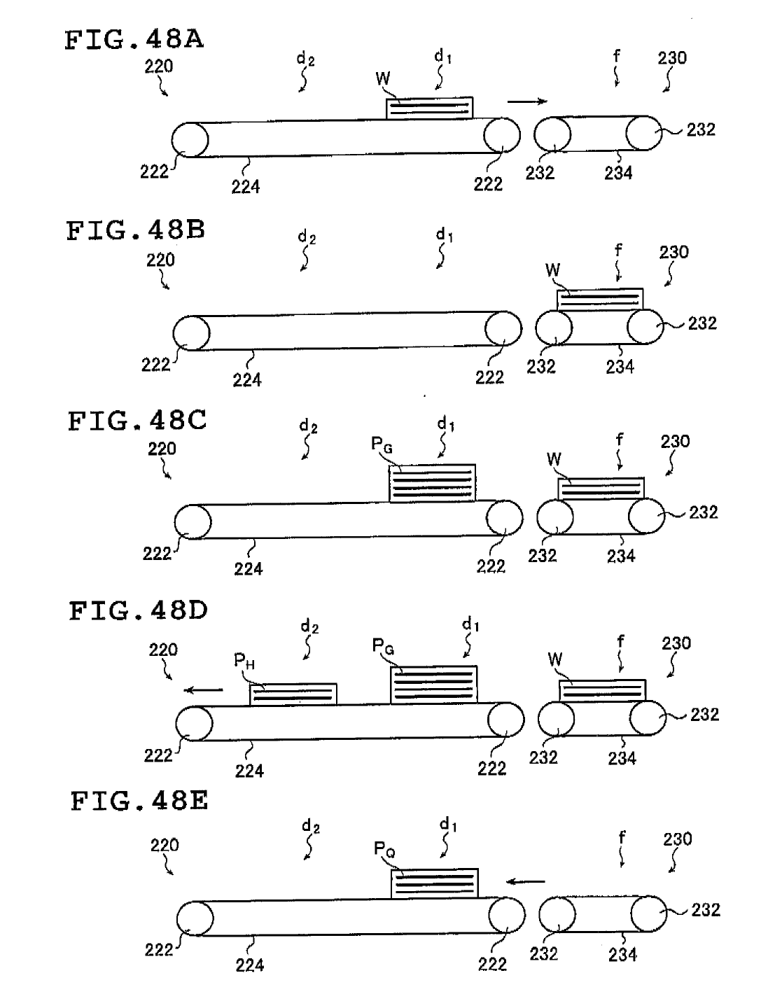

In this case, as indicated in FIG. 48A, first, the prints of the images Q₁ to Q₄ of the order Q of the normal processing operation are accumulated in the first accumulation area “d₁” of the accumulating subsection 220, and thus, the accumulated prints constitute the bundle W of accumulated prints. Next, the prints of the images G₁ to G₄ of the order G of the urgent processing operation are transported, so the roller 222 of the accumulating subsection 220 is rotated in order to move the bundle W of accumulated prints to the standby area “f” of the standby subsection 230 as shown in FIG. 48B. As a result, each of the first accumulation area “d₁” and the second accumulation area “d₂” becomes an empty area with no print accumulated. As shown in FIG. 48C, the prints of the images G₁ to G₁₀ of the order G are accumulated in the first accumulation area “d₁”, so that the bundle P_{G} of accumulated prints is obtained.

In addition, as indicated in FIG. 48D, the prints of the images H₁ to H₁₀ of the order H are accumulated in the second accumulation area “d₂”, so that the bundle P_{H} of accumulated prints is obtained.

As explained above, the bundle P_{G} Of accumulated prints of the order G can be obtained in the first accumulation area “d₁”, and the bundle P_{H} of accumulated prints of the order H can be obtained in the second accumulation area “d₂”. Then, the roller 222 of the accumulating subsection 220 is rotated, the bundles P_{G} and P_{H} are transported to the transporting subsection 240, and the bundles P_{G} and P_{H} are mounted on the mounting areas “g₁” and “g₂” of the transporting subsection 240. As a result, each of the first accumulation area “d₁” and the second accumulation area “d₂” become an empty area with no print accumulated and prints of other orders can be accumulated.

Also, the transporting subsection 240 transports the bundles P_{G} and P_{H} to, for example, a print packing machine.

Next, as shown in FIG. 48B, the roller 232 of the standby subsection 230 is rotated, the bundle W of accumulated prints is moved to the first accumulation area “d₁”, and the prints of the remaining images Q₅ to Q₁₀ are accumulated, thereby obtaining the bundle P_{Q} of accumulated prints, Next, the bundle P_{Q} of accumulated prints is transported from the accumulating subsection 220 to the transporting subsection 240. Thus, the prints of the three orders are formed in the above-mentioned manner.

It should also be understood that in this embodiment, the prints of the normal processing operation are discharged to the first accumulation area “d₁”, and the prints of the urgent processing operation are discharged to the second accumulation area “d₂”. As a result, the bundle of accumulated prints in the second accumulation area “d₂” can be transported to and received from the transporting subsection 240 without considering the first accumulation area “d₁”. Also the bundle of accumulated prints in the first accumulation area “d₁” can be transported to and received from the standby subsection 230.

As previously explained, the image recording apparatus of the present invention can handle even such orders having the different priorities such as urgent prints, while the productivity thereof is not lowered.

The image recording apparatus according to the third aspect of the present invention is basically arranged in the above-mentioned manner.

While the image recording apparatus according to each of the first aspect to the third aspect of the present invention is described in detail by exemplifying various embodiments, the present invention is not limited only to the above-mentioned respective embodiments, but may be modified or changed without departing from the gist of the present invention.

For instance, in the above-mentioned respective embodiments of the present invention, the image recording unit corresponds to the electrophotographic printer for forming images on cut sheets. However, the present invention is not limited only to such an electrophotographic printer, but may be achieved by an image recording unit corresponding to a silver halide photographic printer such as a digital photoprinter, an ink jet recording printer, a thermal recording type printer, or the like.

What is claimed is:

1. An image recording apparatus capable of producing prints from at least one sheet of recording medium having images recorded per one sheet thereof, comprising:
an image allocating section which allocates the images to be recorded on each sheet of the recording medium based upon image data in accordance with a predetermined image forming sequence;
an image recording section which records the images on said each sheet of the recording medium based upon the image data as to the images allocated by the image allocating section;
a cutting section which cuts the one sheet of the recording medium on which the images are recorded by the image recording section into prints each bearing their respective images to obtain prints;
an arranging section which arranges the obtained prints into a single line;
a sort transporting section which accumulates the prints in a single line or a plurality of lines;
a discharge control section which acquires at least state information of the arranging section, and controls operations of the cutting section, the arranging section, and the sort transporting section; and
an entire control section which performs adjustment of allocating operations of the images to the one sheet of the recording medium by the image allocating section, or controls the operation of the arranging section by the discharge control section, based upon at least one of an appointed delivery date of the prints formed based on the image data and the state information of the arranging section acquired by the discharge control section.

2. The image recording apparatus according to claim 1, wherein, in case that the images are allocated based upon the image data by the image allocating section, when a priority print which is to be formed with a high priority is contained in the image data, the entire control section performs at least one of the adjustment of allocating operations of the images based upon the image data by the image allocating section and an adjustment of the operation of the arranging section by the discharge control section, in such a way that the priority print and other prints are discharged to different lines by the sort transporting section.

3. The image recording apparatus according to claim 1, wherein, in ease that the discharge control section acquires state information indicating that the shifter section is abnormal, the entire control section causes the image allocating section to allocate images based upon image data of images for one order, in such a way that prints for the one order are divided so as to be discharged to different lines by the sort transporting section, and the prints for the one order discharged to the different lines are arranged in a sequence of the image data of the images for the one order.

4. The image recording apparatus according to claim 1, wherein
the discharge control section further acquires accumulation information as to the number of accumulated orders in the sort transporting section and, in case that the number of an accumulable orders in the sort transporting section is small based upon the accumulation information, the entire control section causes the image allocating section to allocate the images based upon image data of images for the one order, in such a way that the prints for the one order are divided to be discharged to different lines by the sort transporting section, and the prints discharged to the different lines are arranged in a sequence of the image data of the images for the one order.

5. An image recording apparatus capable of producing prints from at least one sheet of recording medium having images recorded per one sheet thereof, comprising:
an image allocating section which allocates the images to be recorded on each sheet of the recording medium based upon image data in accordance with a predetermined image forming sequence;
an image recording section which records the images on each sheet of recording medium based upon the image data as to the images allocated by the image allocating section:
a cutting section which cuts the one sheet of the recording medium on which the images are recorded by the image recording section into prints each bearing their respective images to obtain the plural prints;
a sort transporting section which has at least two accumulation areas and accumulates for each order the prints obtained by the cutting section;
an accumulation position selecting section which accumulates the prints in respective accumulation areas for each order;
a discharge control section which controls operations of the cutting section and the accumulation position selecting section; and
an entire control section which performs both adjustment of allocating operations of the images based upon the image data by the image allocating section and adjustment of the operation of the accumulation position selecting section by the discharge control section, in such a way that, when a priority order to be printed with a priority higher than the remainder of the orders is contained in the orders, a print forming sequence of the priority order is moved up and one or more prints of the priority order and other prints are discharged to the different accumulation areas.

6. The image recording apparatus according to claim 5, wherein:
the entire control section includes a first mode in which, when the priority order is present, the image allocating section allocates one or more images of the priority order in such a way that one or more images of an order immediately before the priority order and the one or more images of the priority order are partially mixed with each other, and a second mode in which the image allocating section allocates all of the one or more images of the priority order in such a way that all of the one or more images of the priority order are inserted between the one or more images of the order immediately before the priority order, and
the entire control section further includes a mode selecting section for selecting one of the first mode and the second mode.

7. The image recording apparatus according to claim 5, wherein:
the sort transporting section comprises a standby area where a print stack in which accumulation of the prints for the one order is not yet accomplished stands by, in addition to the at least two accumulation areas where the prints obtained by the cutting section are accumulated for each order, and further includes a moving unit which moves the print stack between the accumulation area and the standby area; and
when the priority order is contained in the orders the entire control section causes the image allocating section to allocate the one or more images of the priority order in such a way that the print forming sequence of the priority order is moved up, and all of the one or more images of the priority order are inserted between images of an order immediately before the priority order, and adjusts the operation of the accumulation position selecting section by the discharge control section in such a way that the one or more prints of the priority order and one or more prints of other orders are discharged to the different accumulation areas.
